(19) United States
(12) Patent Application Publication
(10) Pub. No.: US 2026/0350294 A1
(43) Pub. Date: Nov. 5, 2026

(54) SYSTEMS, METHODS, AND APPARATUSES FOR IDENTIFYING BLOCKING RESOURCES OF CONTENT-RECTANGLE-BASED WEBPAGE EVENTS AND TUNING WEB BROWSER HINTS

(71) Applicant: Snappi, Inc., Carlsbad, CA (US)

(72) Inventors: Peter J. Lepeska, Boston, MA (US); C. Jethro Lam, Clarksburg, MD (US); Eric Rosenthal, Boston, MA (US)

(21) Appl. No.: 19/376,150

(22) Filed: Oct. 31, 2025

Related U.S. Application Data
(63) Continuation of application No. PCT/US2025/027270, filed on May 1, 2025.

(51) Int. Cl. G06F 40/143; G06F 16/957

(52) U.S. Cl. CPC G06F 40/143; G06F 16/957

(57) ABSTRACT

Webpage performance is optimized with techniques that identify essential resources needed for rendering significant events and optimizing hints for the essential resources.

### CROSS-REFERENCE TO RELATED APPLICATIONS

This application claims priority to and is a bypass continuation of International Patent Application No. PCT/US2025/027270, filed May 1, 2025, and entitled “SYSTEMS, METHODS, AND APPARATUSES FOR IDENTIFYING BLOCKING RESOURCES OF CONTENT-RECTANGLE-BASED WEBPAGE EVENTS AND TUNING WEB BROWSER HINTS” (VS2620-WO-1).

The foregoing applications is incorporated herein by reference in its entirety for all purposes.

### BACKGROUND

Webpages are made up of numerous resources, including images, scripts, stylesheets, fonts, and other media files, which browsers must fetch to render content fully. These resources vary widely in their importance and impact on the user experience. While some resources are essential for displaying the primary content (e.g., above-the-fold content, such as key images, main text, and layout styling), other elements are less critical. For example, images located further down the page, background scripts, or secondary styling may be non-essential for immediate functionality and visual presentation when the page first loads.

Fetching every resource simultaneously, regardless of its relevance to the initial display, can lead to inefficient use of bandwidth and increase load times. When non-essential resources compete for network bandwidth and processing power with high-priority elements, they create unnecessary delays in displaying primary content, causing the page to feel slower and less responsive. This can lead to a frustrating user experience, particularly on slower networks or devices with limited processing power, where every additional resource can further slow the loading process.

By selectively prioritizing only the resources essential for the initial render, such as main text and visible images, developers can minimize the amount of data the browser needs to process immediately, reducing the time it takes for users to see and interact with the content. Resources that don't impact the first visible area or immediate functionality, like images lower down the page, can be deferred or loaded asynchronously, ensuring that they don't consume valuable bandwidth or CPU resources during the critical first moments.

Hinting is a technique in web performance optimization and allows prioritizing resources that are needed for rendering events. Hints indicate which resources should be preloaded, prefetched, or prioritized based on their impact on the user experience and they help browsers make decisions about loading sequences, especially for resources that are essential for initial display and interactivity. Without hinting, browsers may load resources in a default, less optimal order, fetching non-essential elements that delay the rendering of visible content. Through hints, key resources can be loaded promptly, reducing perceived wait times and enhancing page responsiveness.

### SUMMARY

In some aspects, the techniques described herein relate to an apparatus including: at least one processor and at least one memory device. The at least one memory device stores computer-readable instructions, e.g., an application, that, when loaded into the at least one processor, causes the at least one processor to: obtain a set of resources; select a first subset of resources from the set of resources; and transmit the set of resources to an application. In such embodiments, the first subset of resources is transmitted to the application after a first delay; and the computer-readable instructions further cause the at least one processor to: monitor a first execution of the application that uses the set of resources, and determine a first timing of an event during the first execution. The computer-readable instructions further cause the at least one processor to determine, based at least in part on the first timing and the first delay, one or more blocking resources, in the set of resources, for the event; and transmit a message including an indicator that identifies the one or more blocking resources.

In some aspects, the techniques described herein relate to a method including: interpreting a set of resources; selecting a first subset of resources from the set of resources; transmitting the set of resources to an application, wherein the first subset of resources is transmitted to the application after a first delay; monitoring a first execution of the application that uses the set of resources; determining a first timing of an event during the first execution; determining, based at least in part on the first timing and the first delay, one or more blocking resources, in the set of resources, for the event; and transmitting a message including an indicator that identifies the one or more blocking resources.

In some aspects, the techniques described herein relate to a non-transitory computer-readable medium storing instructions that, when loaded into at least one processor, cause the at least one processor to: interpret a set of resources; select a first subset of resources from the set of resources; transmit the set of resources to an application, wherein the first subset of resources is transmitted to the application after a first delay; monitor a first execution of the application that uses the set of resources; determine a first timing of an event during the first execution; determine, based at least in part on the first timing and the first delay, one or more blocking resources, in the set of resources, for the event; and transmit a message including an indicator that identifies the one or more blocking resources.

In some aspects, the techniques described herein relate to an apparatus including at least one processor and at least one memory device. The at least one memory device stores computer-readable instructions that, when loaded into the at least one processor, causes the at least one processor to: load a first set of resources for consumption by a first application; provide the first set of resources for the first application; monitor a first execution of the first application with the first set of resources; and determine a first timing of an event during the first execution. In such embodiments, the computer-readable instructions further cause the at least one processor: to load a second set of resources and a third set of resources for consumption by the first application, wherein the second set of resources is a subset of the first set of resources, and the third set of resources is a different subset of the first set of resources. The computer-readable instructions further cause the at least one processor to provide, at a first time, the second set of resources for the first application; monitor a second execution of the first application with the second set of resources; provide, at a second time, the third set of resources for the first application; monitor a third execution of the first application with the third set of resources; and determine a second timing of the event during the second execution and the third execution. In such embodiments, the computer-readable instructions further cause the at least one processor to determine, from the second timing, that the third set of resources includes resources that are required for the event; and transmit a message including an indication that identifies the third set of resources as including the resources as being required for the event.

In some aspects, the techniques described herein relate to a method including: loading a first set of resources for consumption by a first application; providing the first set of resources for the first application; monitoring a first execution of the first application with the first set of resources; determining a first timing of an event during the first execution; loading a second set of resources and a third set of resources for consumption by the first application, wherein the second set of resources is a subset of the first set of resources, the third set of resources is a different subset of the first set of resources; providing, at a first time, the second set of resources for the first application; monitoring a second execution of the first application with the second set of resources; providing, at a second time, the third set of resources for the first application; monitoring a third execution of the first application with the third set of resources; determining a second timing of the event during the second execution and the third execution; and determining, from the second timing, that the third set of resources includes resources that are required for the event.

In some aspects, the techniques described herein relate to an apparatus including: at least one processor and at least one memory device. The at least one memory device stores computer-readable instructions that, when loaded into the at least one processor, causes the at least one processor to: load a first set of resources; select, from the first set of resources, a second set of resources and a third set of resources. In such embodiments, the second set of resources is a subset of the first set of resources, and the third set of resources is a different subset of the first set of resources. The computer-readable instructions further cause the at least one processor to: provide, at a first time, the second set of resources for a first application; and monitor a first execution of the first application with the second set of resources. In such embodiments, the computer-readable instructions further cause the at least one processor to: provide, at a second time, the third set of resources for the first application. In such embodiments, the computer-readable instructions further cause the at least one processor to monitor a second execution of the first application with the third set of resources; determine a timing of an event during the first execution and the second execution; and determine, based on the first time, the second time, and the timing, that the third set of resources includes resources that are required for the event.

In some aspects, the techniques described herein relate to a method including: loading a first set of resources; selecting, from the first set of resources, a second set of resources and a third set of resources, wherein the second set of resources is a subset of the first set of resources, the third set of resources is a different subset of the first set of resources; providing, at a first time, the second set of resources for a first application; monitoring a first execution of the first application with the second set of resources; providing, at a second time, the third set of resources for the first application; monitoring a second execution of the first application with the third set of resources; determining a timing of an event during the first execution and the second execution; and determining, based on the first time, the second time, and the timing, that the third set of resources includes resources that are required for the event.

In some aspects, the techniques described herein relate to an apparatus including: at least one processor, and at least one memory device. The at least one memory device stores computer-readable instructions that, when loaded into at least one processor, causes the at least one processor to: interpret a set of resources; select, from the set of resources, a first subset of resources; and transmit the set of resources to an application. In such embodiments, the first subset of resources are transmitted after a first delay; and the computer-readable instructions further cause the at least one processor to: monitor a first execution of the application; monitor one or more paint events for one or more areas of a page; determine a timeline of the one or more paint events; determine, based on the timeline and the first delay, that the first subset of resources includes one or more blocking resources for the event; and transmit a message including an indicator that identifies the one or more blocking resources.

In some aspects, the techniques described herein relate to a method including: interpreting a set of resources; selecting, from the set of resources, a first subset of resources; and transmitting the set of resources to an application. In such embodiments, the first subset of resources are transmitted after a first delay; and the method further includes monitoring a first execution of the application; monitoring one or more paint events for one or more areas of a page; determining a timeline of the one or more paint events; and determining, based on the timeline and the first delay, that the first subset of resources includes one or more blocking resources for the event. The method further includes transmitting a message including an indicator that identifies the one or more blocking resources.

In some aspects, the techniques described herein relate to an apparatus including at least one processor and at least one memory device. The at least one memory device stores computer-readable instructions that, when loaded into the at least one processor, causes the at least one processor to: interpret hint data defining a plurality of hints structured to facilitate loading of a webpage; generate a plurality of hint combinations from the plurality of hints; load, for each of the plurality of hint combinations, the webpage using the hint combination; determine, for each loading of the webpage, a timing for an event associated with the loading for the webpage; generate, based at least in part on the timings, performance data for the plurality of hint combinations; and transmit the performance data.

In some aspects, the techniques described herein relate to a method including: interpreting hint data defining a plurality of hints structured to facilitate loading of a webpage; generating a plurality of hint combinations from the plurality of hints; loading, for each of the plurality of hint combinations, the webpage using the hint combination; determining, for each loading of the webpage, a timing for an event associated with the loading for the webpage; generating, based at least in part on the timings, performance data for the plurality of hint combinations; and transmitting the performance data.

In some aspects, the techniques described herein relate to a non-transitory computer-readable medium storing instructions that, when loaded into at least one processor, cause the at least one processor to: interpret hint data defining a plurality of hints structured to facilitate loading of a webpage; generate a plurality of hint combinations from the plurality of hints; load, for each of the plurality of hint combinations, the webpage using the hint combination; determine, for each loading of the webpage, a timing for an event associated with the loading for the webpage; generate, based at least in part on the timings, performance data for the plurality of hint combinations; and transmit the performance data.

In some aspects, the techniques described herein relate to an apparatus including: at least one processor and at least one memory device. The at least one memory device stores an application that, when loaded into the at least one processor, causes the at least one processor to: interpret hint data defining a plurality of hints structured to facilitate loading of a webpage; generate a plurality of hint combinations from the plurality of hints; load, for each of the plurality of hint combinations, the webpage using the hint combination; determine, for each loading of the webpage, a timing for an event associated with the loading for the webpage; and select a hint combination from the plurality of hint combinations based at least in part on the timings. The computer-readable instructions further cause the at least one processor to transmit the selected hint combination.

In some aspects, the techniques described herein relate to a method including: interpreting hint data defining a plurality of hints structured to facilitate loading of a webpage; generating a plurality of hint combinations from the plurality of hints; loading, for each of the plurality of hint combinations, the webpage using the hint combination; determining, for each loading of the webpage, a timing for an event associated with the loading for the webpage; selecting a hint combination from the plurality of hint combinations based at least in part on the timings; and transmitting the selected hint combination.

In some aspects, the techniques described herein relate to a non-transitory computer-readable medium storing instructions that, when loaded into at least one processors, cause the at least one processor to: interpret hint data defining a plurality of hints structured to facilitate loading of a webpage; generate a plurality of hint combinations from the plurality of hints; load, for each of the plurality of hint combinations, the webpage using the hint combination; determine, for each loading of the webpage, a timing for an event associated with the loading for the webpage; select a hint combination from the plurality of hint combinations based at least in part on the timings; and transmit the selected hint combination.

In some aspects, the techniques described herein relate to an apparatus including: at least one processor and at least one memory device. The at least one memory device stores computer-readable instructions that, when loaded into the at least one processor, causes the at least one processor to: interpret a set of resources for a webpage; select a first subset of resources from the set of resources; and transmit the set of resources to a webpage browser.

In such embodiments, the first subset of resources is transmitted to the webpage browser after a first delay; and the computer-readable instructions further cause the at least one processor to: monitor a first execution of the webpage browser that uses the set of resources to load the webpage; determine a first timing of an event during the first execution; determine, based at least in part on the first timing and the first delay, one or more blocking resources, in the set of resources, for the event; interpret hint data defining a plurality of hints structured to facilitate prefetching of the one or more blocking resources as part of loading of the webpage; generate a plurality of hint combinations from the plurality of hints; load, for each of the plurality of hint combinations, the webpage using the webpage browser and the hint combination; determine, for each loading of the webpage, a timing for an event associated with the loading for the webpage; generate, based at least in part on the timings, performance data for the plurality of hint combinations; select a hint combination from the plurality of hint combinations based at least in part on the timings; and transmit the selected hint combination.

In some aspects, the techniques described herein relate to a method including: interpreting a set of resources for a webpage; selecting a first subset of resources from the set of resources; and transmitting the set of resources to a webpage browser. In such embodiments, the first subset of resources is transmitted to the webpage browser after a first delay; and the method further includes monitoring a first execution of the webpage browser that uses the set of resources to load the webpage; determining, a first timing of an event during the first execution; determining, based at least in part on the first timing and the first delay, one or more blocking resources, in the set of resources, for the event; interpreting hint data defining a plurality of hints structured to facilitate prefetching of the one or more blocking resources as part of loading of the webpage; generating a plurality of hint combinations from the plurality of hints; loading, for each of the plurality of hint combinations, the webpage using the webpage browser and the hint combination; determining, for each loading of the webpage, a timing for an event associated with the loading for the webpage; generating, based at least in part on the timings, performance data for the plurality of hint combinations; selecting a hint combination from the plurality of hint combinations based at least in part on the timings; and transmitting the selected hint combination.

In some aspects, the techniques described herein relate to a non-transitory computer-readable medium storing instructions that, when loaded into at least one processor, causes the at least one processor to: interpret a set of resources for a webpage; select a first subset of resources from the set of resources; transmit the set of resources to a webpage browser, wherein the first subset of resources is transmitted to the webpage browser after a first delay; monitor a first execution of the webpage browser that uses the set of resources to load the webpage; determine a first timing of an event during the first execution; determine, based at least in part on the first timing and the first delay, one or more blocking resources, in the set of resources, for the event; interpret hint data defining a plurality of hints structured to facilitate prefetching of the one or more blocking resources as part of loading of the webpage; generate a plurality of hint combinations from the plurality of hints; load, for each of the plurality of hint combinations, the webpage using the webpage browser and the hint combination; determine, for each loading of the webpage, a timing for an event associated with the loading for the webpage; generate, based at least in part on the timings, performance data for the plurality of hint combinations; select a hint combination from the plurality of hint combinations based at least in part on the timings; and transmit the selected hint combination.

In some aspects, the techniques described herein relate to a system including: at least one processor and at least one memory device. The at least one memory device stores computer-readable instructions that, when loaded into the at least one processor, causes the at least one processor to: interpret a set of resources for a webpage and determine one or more blocking resources; interpret data defining a plurality of hints structured to facilitate prefetching of the one or more blocking resources as part of loading webpage; generate a recommended hint set for one or more of the plurality of hints; and transmit the recommended hint set.

In some aspects, the techniques described herein relate to a method including: interpreting a set of resources for a webpage; determining one or more blocking resources; interpreting data defining a plurality of hints structured to facilitate prefetching of the one or more blocking resources as part of loading webpage; generating a recommended hint set for one or more of the plurality of hints; and transmitting the recommended hint set.

In some aspects, the techniques described herein relate to a non-transitory computer-readable medium storing instructions that, when loaded into at least one processor, cause the at least one processor to: interpret a set of resources for a webpage and determine one or more blocking resources; interpret data defining a plurality of hints structured to facilitate prefetching of the one or more blocking resources as part of loading webpage; generate a recommended hint set for one or more of the plurality of hints; and transmit the recommended hint set.

In some aspects, the techniques described herein relate to a method including: visiting a webpage with a web browser; observing a first timing of a page event for the webpage; recording a superset of resources fetched as part of a rendering of the webpage occurring prior to the page event; visiting the webpage a second time with a web browser that introduces a delay prior to the fetching of one of the superset of resources, wherein the delay is of an amount that is greater than the timing of the page event; observing a second timing of the page event after the delay; and determining, based in part on the second timing and the amount of the delay, that the one of the superset of resources is blocking for the page event.

In some aspects, the techniques described herein relate to a method including: loading a first set of resources; selecting, from the first set of resources, a second set of resources and a third set of resources, wherein the second set of resources is a subset of the first set of resources, and the third set of resources is a different subset of the first set of resources; providing, at a first time, the second set of resources for an application; monitoring a first execution of the application with the second set of resources; providing, at a second time, the third set of resources for the application; monitoring a second execution of the application with the third set of resources; determining a timing of a content rectangle paint complete event during the first execution and the second execution; and determining, based on the first time, the second time, and the timing, that the third set of resources includes a resource required for the content rectangle paint complete event.

In some aspects, the techniques described herein relate to a method including: obtaining a set of resources; selecting from the set of resources, a first subset of resources; transmitting the set of resources to an application, wherein the first subset of resources is transmitted after a first delay; monitoring a first execution of the application; monitoring one or more paint events for one or more webpage content rectangles; determining a timing of the one or more paint events; determining, based on the timing and the first delay, that the first subset of resources includes one or more blocking resources for the one or more paint events; and transmitting a message including an indicator that identifies the one or more blocking resources.

In some aspects, the techniques described herein relate to an apparatus including: at least one processor; and at least one memory device storing an application that, when loaded into the at least one processor, causes the at least one processor to: obtain a set of resources; select, from the set of resources, a first subset of resources; transmit the set of resources to an application, wherein the first subset of resources is transmitted after a first delay; monitor a first execution of the application; monitor one or more paint events for one or more webpage content rectangles; determine a timeline of the one or more paint events; determine, based on the timeline and the first delay, that the first subset of resources includes one or more blocking resources for the one or more paint events; and transmit a message including an indicator that identifies the one or more blocking resources.

In some aspects, the techniques described herein relate to a method including: obtaining blocking resources for one or more paint events for one or more webpage content rectangles; generating a plurality of hint combinations from the plurality of blocking resources, wherein the plurality of hint combinations is structured to facilitate loading of the webpage; loading, for each of the plurality of hint combinations, the webpage using the hint combination; determining, for each loading of the webpage, a timing for a webpage content rectangle paint complete event associated with the loading for the webpage; generating, based at least in part on the timings, performance data for the plurality of hint combinations; and transmitting the performance data.

In some aspects, the techniques described herein relate to an apparatus including: at least one processor; and at least one memory device storing an application that, when loaded into the at least one processor, causes the at least one processor to: obtain blocking resources for one or more paint events for one or more webpage content rectangles; generate a plurality of hint combinations from the plurality blocking resources, wherein the plurality of hint combinations is structured to facilitate loading the webpage; load, for each of the plurality of hint combinations, the webpage using the hint combination; determine, for each loading of the webpage, a timing for a webpage content rectangle paint complete event associated with the loading for the webpage; generate, based at least in part on the timings, performance data for the plurality of hint combinations; and transmit the performance data.

In some aspects, the techniques described herein relate to a method including: initiating a first plurality of loadings of a webpage; receiving feedback for the first plurality of loadings of the webpage; identifying, based at least in part on the feedback, one or more content rectangles painted as part of the first plurality of loadings of the webpage; identifying, based at least in part on the feedback, one or more candidate resources of the one or more content rectangles; identifying, from among the one or more candidate resources, one or more blocking resources of the one or more content rectangles; and building, based at least in part on the one or more blocking resources and the one or more content rectangles, a model of the webpage.

In some aspects, the techniques described herein relate to an apparatus including: at least one processor; and at least one memory device storing an application that, when loaded into the at least one processor, causes the at least one processor to: initiate a first plurality of loadings of a webpage; receive feedback for the first plurality of loadings of the webpage; identify, based at least in part on the feedback, one or more content rectangles painted as part of the first plurality of loadings of the webpage; identify, based at least in part on the feedback, one or more candidate resources of the one or more content rectangles; identify, from among the one or more candidate resources, one or more blocking resources of the one or more content rectangles; and build, based at least in part on the one or more blocking resources and the one or more content rectangles, a model of the webpage.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts aspects of a system for identifying blocking resources and tuning web browser hints, in accordance with embodiments of the current disclosure.

FIG. 2 depicts an example of a logical data flow for elements of the system, in accordance with embodiments of the current disclosure.

FIG. 3 depicts an example time sequence diagram, in accordance with embodiments of the current disclosure.

FIG. 4 depicts aspects of an example hinting service, in accordance with embodiments of the current disclosure.

FIG. 5 depicts an example waterfall diagram, in accordance with embodiments of the current disclosure.

FIG. 6 depicts aspects of an apparatus for identifying blocking resources and/or tuning web browser hints, in accordance with embodiments of the current disclosure.

FIG. 7 depicts a method for identifying blocking resources, in accordance with embodiments of the current disclosure.

FIG. 8 depicts further aspects of the method of FIG. 7, in accordance with embodiments of the current disclosure.

FIG. 9 depicts another method for identifying blocking resources, in accordance with embodiments of the current disclosure.

FIG. 10 depicts another method for identifying blocking resources, in accordance with embodiments of the current disclosure.

FIG. 11 depicts another method for identifying blocking resources, in accordance with embodiments of the current disclosure.

FIG. 12 depicts a method for optimizing hints for loading a webpage, in accordance with embodiments of the current disclosure.

FIG. 13 depicts further aspects of the method of FIG. 12, in accordance with embodiments of the current disclosure.

FIG. 14 depicts further aspects of the method of FIG. 12, in accordance with embodiments of the current disclosure.

FIG. 15 depicts another method for optimizing hints for loading a webpage, in accordance with embodiments of the current disclosure.

FIG. 16 depicts a webpage having persistent and dynamic content rectangles, in accordance with embodiments of the current disclosure.

FIG. 17 depicts a resource determination subsystem, in accordance with embodiments of the current disclosure.

FIG. 18 depicts a hint optimization subsystem, in accordance with embodiments of the current disclosure.

FIG. 19 depicts a method for identifying blocking resources, in accordance with embodiments of the current disclosure.

FIG. 20 depicts further aspects of the method of FIG. 19, in accordance with embodiments of the current disclosure.

FIG. 21 depicts further aspects of the method of FIG. 19, in accordance with embodiments of the current disclosure.

FIG. 22 depicts further aspects of the method of FIG. 19, in accordance with embodiments of the current disclosure.

FIG. 23 depicts further aspects of the method of FIG. 19, in accordance with embodiments of the current disclosure.

FIG. 24 depicts further aspects of the method of FIG. 19, in accordance with embodiments of the current disclosure.

FIG. 25 depicts further aspects of the method of FIG. 19, in accordance with embodiments of the current disclosure.

FIG. 26 depicts further aspects of the method of FIG. 19, in accordance with embodiments of the current disclosure.

FIG. 27 depicts another method for identifying blocking resources, in accordance with embodiments of the current disclosure.

FIG. 28 depicts further aspects of the method of FIG. 27, in accordance with embodiments of the current disclosure.

FIG. 29 depicts further aspects of the method of FIG. 27, in accordance with embodiments of the current disclosure.

FIG. 30 depicts further aspects of the method of FIG. 27, in accordance with embodiments of the current disclosure.

FIG. 31 depicts further aspects of the method of FIG. 27, in accordance with embodiments of the current disclosure.

FIG. 32 depicts further aspects of the method of FIG. 27, in accordance with embodiments of the current disclosure.

FIG. 33 depicts further aspects of the method of FIG. 27, in accordance with embodiments of the current disclosure.

FIG. 34 depicts further aspects of the method of FIG. 27, in accordance with embodiments of the current disclosure.

FIG. 35 depicts further aspects of the method of FIG. 27, in accordance with embodiments of the current disclosure.

FIG. 36 depicts further aspects of the method of FIG. 27, in accordance with embodiments of the current disclosure.

FIG. 37 depicts another method for identifying blocking resources, in accordance with embodiments of the current disclosure.

FIG. 38 depicts further aspects of the method of FIG. 37, in accordance with embodiments of the current disclosure.

FIG. 39 depicts further aspects of the method of FIG. 37, in accordance with embodiments of the current disclosure.

FIG. 40 depicts another method for identifying blocking resources, in accordance with embodiments of the current disclosure.

FIG. 41 depicts further aspects of the method of FIG. 40, in accordance with embodiments of the current disclosure.

FIG. 42 depicts further aspects of the method of FIG. 40, in accordance with embodiments of the current disclosure.

FIG. 43 depicts further aspects of the method of FIG. 40, in accordance with embodiments of the current disclosure.

FIG. 44 depicts further aspects of the method of FIG. 40, in accordance with embodiments of the current disclosure.

FIG. 45 depicts further aspects of the method of FIG. 40, in accordance with embodiments of the current disclosure.

FIG. 46 depicts further aspects of the method of FIG. 40, in accordance with embodiments of the current disclosure.

FIG. 47 depicts further aspects of the method of FIG. 40, in accordance with embodiments of the current disclosure.

FIG. 48 depicts further aspects of the method of FIG. 40, in accordance with embodiments of the current disclosure.

FIG. 49 depicts further aspects of the method of FIG. 40, in accordance with embodiments of the current disclosure.

### DETAILED DESCRIPTION

Disclosed herein are embodiments and applications that optimize webpage performance by introducing novel techniques for identifying which resources are necessary for rendering significant event(s). The techniques address the inefficiencies that occur when browsers fetch and process resources that are not essential to the timely completion of critical events during rendering of a webpage. As will be understood, the terms rendering and/or loading may be used interchangeably within the current disclosure.

Determining essential resources for a webpage is challenging because of the complex interplay between various elements and the browser's rendering process. As disclosed herein, essential resources may include resources used by a webpage to display elements and/or to provide functionality that contribute to the purpose of the webpage, e.g., displaying a graphical picture of a good for purchase by a user and providing menu buttons to facilitate the purchase. As such, essential resources may include blocking resources, e.g., resources that other webpage resources depend on and/or otherwise impact the rendering/display of the other webpage resources. Essential resources may also include resources that, while not needed to make the page viewable, contribute to the webpage's purpose and/or user's overall experience viewing the webpage. Webpages are composed of numerous resources-such as images, CSS, JavaScript files, fonts, and multimedia each of which can impact how and when specific parts of a page are displayed. In many instances, resources may include complex dependency chains. For example, JavaScript may rely on CSS for styling elements, or an image might be part of a script-driven animation. These dependencies mean that removing or deprioritizing a seemingly non-critical resource can impact other elements or delay rendering altogether, leading to potential disruptions in how or when content appears. In many instances, webpages may include dynamic content loading. Many webpages rely on JavaScript to load additional resources dynamically, often based on user interactions. Resources loaded after the initial render, such as content loaded via AJAX or API calls, can still affect the page's layout and functionality. In many instances, significant event timing may depend on user-specific content. Resources deemed critical may vary depending on the user's device, screen size, or geographic location. For example, high-resolution images may be essential on a desktop but non-essential on mobile. This variability means that determining essential resources requires careful consideration.

Existing methods for identifying essential resources are often inadequate due to the complexity and variability of modern webpages. Approaches like manually selecting resources based on intuition, trial-and-error, or relying solely on standard metrics fail to account for the nuanced dependencies between resources and the specific needs of diverse user contexts. These methods may overlook hidden dependencies, such as JavaScript functions that rely on particular styles and/or images, leading to unintended side effects when non-essential resources are deprioritized or removed.

Additionally, existing approaches lack the precision needed to differentiate between resources that are critical for initial rendering and those that can be deferred. This lack of systematic identification often results in either over-fetching, where too many resources are loaded at once, causing unnecessary bandwidth use and slower load times, or under-fetching, where key resources are missed, leading to broken or incomplete page elements.

Accordingly, disclosed herein are systems and methods for improved identification of essential resources for significant events. Embodiments include a process where multiple instances of the webpage are rendered, with each instance selectively delaying the loading of one or more specific resources. By comparing the performance of these instances, the system can observe whether delaying a particular resource has any impact on the timing of the significant event (herein also referred to as a key event).

If the delay of a resource does not affect the timing of the significant event, it is inferred that the resource is not required for the rendering process, and the resource can be safely deprioritized. On the other hand, if the event is delayed as a result of postponing the resource, this indicates that the resource is needed and should be prioritized during the page load. This method provides a clear, data-driven approach to distinguish between essential and non-essential resources for different events associated with rendering a webpage.

The discovery technique described herein not only improves the accuracy of resource management but also significantly enhances overall webpage performance by optimizing the order in which resources are fetched. Essential resources can be prioritized for preloading or early fetching, e.g., prefetching, ensuring that the browser focuses on fetching the most impactful resources first. This approach reduces the likelihood of unnecessary delays and helps minimize the time to critical events, creating a more responsive and fluid user experience. Simultaneously, non-essential resources can be deprioritized and/or loaded asynchronously, freeing up bandwidth and processing power for more important tasks.

Embodiments described herein provide a system and methods to optimize webpage performance by preloading the essential resources and deprioritizing others that do not contribute directly to significant events. This technique can further be used to inform web developers about the impact of adding new resources, helping them make decisions that improve user experience by reducing loading times and enhancing the perceived responsiveness of webpages.

Additionally, embodiments described herein provide developers with deeper insight into resource dependencies, enabling them to be alerted when certain resources impact important rendering events. This functionality allows developers to make more informed and strategic decisions when adding new elements or features to a webpage. Instead of introducing elements that could unknowingly delay key rendering events or slow down the page, developers can assess the potential impact of these resources and adjust their design or loading strategies accordingly.

Moreover, by having access to a toolset that identifies necessary and unnecessary resources, developers can better prioritize preloading and caching strategies, giving critical resources priority while postponing or deferring less important assets. This intelligent resource management not only improves loading times but also helps to provide for the most visually or functionally significant parts of the page are rendered as quickly as possible, providing users with immediate feedback, and improving their overall engagement.

Once essential resources have been accurately identified, this information can be leveraged to generate targeted hints that guide the browser's loading priorities. These hints (e.g., preconnects, preloads, prioritizations, prefetches, lazy-load directives, and/or the like) can direct the browser to prioritize only the resources critical for specific events, ensuring that primary content loads promptly. In embodiments, hints may be defined by and/or based on a resource type, e.g., CSS, script, image, etc. Hints may indicate a preload, preconnect, and/or other type of action. A non-limiting example of a preconnect action include an indication that a connection should be established to a resource's/object's domain early but where the web browser may stop short of a preloading (or prefetching) of the resource itself. A non-limiting example of a preload action includes an indication that an entire resource/object should be downloaded early.

Disclosed herein are embodiments and applications that optimize webpage performance by introducing a novel technique for selecting and deploying hints. The techniques are designed to address the inefficiencies that occur when hints are deployed. In many instances, the deployment of hints may result in unexpected inefficiencies due to real-world limitations associated with bandwidth and/or compute resources.

In embodiments, different combinations of hints yield varying effects, with some combinations enhancing performance while others inadvertently delay the loading of critical content. Current methods often apply hints in a static manner, meaning the same hints are used regardless of user context, network conditions, or specific page requirements. This static approach fails to account for the nuanced performance differences across different devices, networks, or page configurations.

For instance, in high-bandwidth environments, hints that instruct the browser to preload large resources (like images or scripts) can enhance user experience by ensuring key content loads quickly. However, if bandwidth is limited, these same hints may inadvertently compete for network resources, potentially delaying the loading of other critical assets. In such cases, preloading or prioritizing too many resources can overwhelm the network, causing essential resources to load more slowly than intended.

Similarly, compute resources affect the ability of the browser to process multiple hints simultaneously. When a device has ample processing power, hints can direct the browser to load and render content efficiently. However, on lower-powered devices, too many high-priority resources may tax the processor, leading to bottlenecks and potentially degrading the user experience.

By considering bandwidth and compute limitations, embodiments described herein can dynamically adapt hint configurations, balancing resource demands with available capacity. This provides for hints to not only be tailored to the page's structure but also optimized for the specific environment in which they're deployed, thereby maintaining efficient page loads across diverse user scenarios.

Systems and methods disclosed herein employ a feedback-driven process to automatically experiment with different hint configurations, enabling the identification of the most effective hint combinations for each page. In one example, the system can selectively experiment with different hints for different resources (e.g., such as preconnect, preload, or priority hints) and determine which type of hint for different resources will deliver the most benefit (e.g., faster load times, more responsive page, etc.). By continuously learning from performance data, the system adapts to various scenarios, providing dynamic and optimized hint sets that align with real-time needs. This approach not only optimizes/improves page load performance but also adjusts seamlessly to diverse user environments, creating a responsive, adaptable hinting strategy that outperforms traditional methods.

The hint-tuning techniques described herein not only improves page load performance but also adjust seamlessly to diverse user environments, creating a responsive, adaptable hinting strategy. In some embodiments, hints can be tuned in real-time based on available bandwidth, compute resources, and user-specific conditions.

In one example, the hint-tuning techniques described herein enhance the consistency of user experience across devices and network conditions. Users on high-speed connections with powerful devices benefit from quick, efficient loading of primary and secondary resources, improving overall page responsiveness and perceived snappiness. Meanwhile, users on slower networks or lower-powered devices still receive a highly optimized experience, with critical resources prioritized to provide for essential content to load first, even under resource constraints.

In another example, the capability to optimize offers competitive advantages for businesses by increasing user engagement and retention. Pages that load quickly are less likely to suffer from user drop-offs, enhancing conversion rates and user satisfaction. This performance optimization approach not only improves end-user experience but also bolsters engagement, particularly in e-commerce, media, and other web-driven industries where seamless browsing is essential for retaining users.

As will be understood, embodiments of the current disclosure are not limited to the embodiments and applications disclosed herein or to the manner in which the embodiments and applications operate or are described herein.

As used herein, “substantially” means sufficient to work for the intended purpose. If used with respect to a numerical value or range, substantially means within ten percent. The term “ones” means more than one.

As used herein, “network resources” and “webpage resources” may refer to visual (e.g., text, image, video, or the like) objects, audio objects, collections of one or more instructions (e.g., a page encoded in hypertext, a style sheet such as a cascading style sheet (CSS) for displaying and/or playing a network resource, a script file such as a JavaScript file, or the like), and/or a network service made available and/or provided by one device on a network to other devices upon request by one of the other devices. “Network resources” and “webpage resources” may be referred to herein simply as a “resource.” In embodiments, “network resources” and “webpage resources” may include the parts that a webpage needs to function and display content. Resources can include any element or aspect of a webpage including HTML code, CSS code/files, scripts, images, fonts, multimedia, libraries, plugins, data files (e.g., JSON, XML), and the like. Resources may include parts that are requested and loaded by the browser when a user visits a webpage. Resources may also include parts that are executed on a client device and, in some cases, they may include parts that are executed remotely.

As used herein, a “parent” resource includes, among other elements, one or more instructions to fetch a “child” and/or “sub” resource from a specified device. Examples of a parent/sub resource include a webpage (e.g., written in a markup language such as hypertext markup language (HTML), extensible markup language (XML), or the like), a media manifest file or other file that references other media objects (e.g., a movie, a prerecorded television show), a service providing access to a streaming media object (e.g., a podcast, a live television broadcast, streaming music, or the like) that references other media objects, a service for transferring a specified data file that references other data objects, or the like.

Any of the foregoing can also be a child/sub resource. Additional examples of child/sub resources include images, audio files, video files, style files such as cascaded style sheets (CSS), executable scripts such as JavaScript, and the like. Child/sub resources may further include sub elements of resources. For example, a resource such as a script file may include a plurality of scripts, and each of the plurality of scripts may be a sub-resource of the script resources.

A “webpage element”, as used herein, may refer to blocks that define the structure, content, and/or functionality of a webpage. Webpage elements may be code definitions and/or may be associated with resources. Non-limiting examples of webpage elements include HTML tags, wherein each tag can be an element.

A “webpage event”, as disclosed herein, may refer to specific moments and/or actions that occur during the lifecycle of a webpage viewing by a user. Webpage events may occur from when a page starts loading to when the webpage is fully interactive, to after it has been displayed, to after it has been left by the user.

“Significant events”, “snappi-events”, and/or “blocking events”, as used herein, may refer to a specific webpage event and/or a set of webpage events that are designated as having and/or relating to a meaningful and/or impactful completion of the loading, rendering, and/or other similar process for a webpage, e.g., events that contribute to the “snappiness” of a webpage. Significant and/or blocking events may be attributed as significant by a user and/or by the system according to criteria and/or scoring methods. Significance may be attributed to various contexts, such as practical importance, snappiness of a page, percentage of load/render, time, etc. Examples of significant events include first paint (FP) (the first point at which anything is rendered on the screen), First Contentful Paint (FCP) (the first piece of content is painted on the screen), Largest Contentful Paint (LCP) (the largest visible element is rendered), First Meaningful Paint (the primary content of the page is rendered), Time to Interactive (TTI) (the page becomes interactive, meaning it has finished rendering content and is responsive to user inputs), DOMContentLoaded (DCL) (the initial HTML document is fully loaded and parsed, but before other resources like stylesheets, images, and scripts are fully loaded), First Input Delay (FID) (the browser to respond to the first user interaction), and the like. In embodiments, significant events may include custom events that include a custom combination of one or more of loading, rendering, or interactivity milestones.

A “delay”, as used herein with respect to resources, may refer to a period of time during which access by an application, e.g., a webpage browser, to resource(s) is withheld and/or restrained. A delay may be extra and/or an additional time period as compared to the normal and/or average time period for when resources are requested, loaded, and/or made available. A delay may be purposely added and/or may occur due to operational irregularity. A delay may be inserted at a browser, external data providers, and/or the like. A delay may be added via scripts, server-side delays, browser instructions, etc. A delay from an operational irregularity may originate from network congestion, memory bottlenecks, processing limitations, etc.

A “paint area”, as used herein, may refer to an area where the browser renders elements such as text, images, videos, and other multimedia content. A paint area may be a paint of the user viewport, and/or include different shapes such as rectangles, circles, or any other shape. In embodiments, a paint area may include disjoint areas.

“Deprioritize”, as used herein, may refer to reducing the importance of resources. For example, deprioritized resources may be removed as candidates for hints.

As used herein, a “universal resource locator” specifies the location of a network resource and is sometimes abbreviated URL. In some examples, a universal resource locator includes a “host identifier” and a “resource identifier.” The “host identifier” identifies a host server from which a network resource is to be fetched, and the “resource identifier” identifies the network resource. In some examples, the resource identifier is a path to the resource on the host server. As defined and used herein, universal resource locator includes within its meaning but is not limited to what is commonly referred to in Internet or world-wide-web applications as a universal resource locator or URL.

As used with reference to a URL (whether a static URL, a resolved dynamic URL, or a resolved random-value URL) “pre-fetching” or “fetching” means obtaining the resource from the host server identified by the static or resolved URL.

As used herein “loading” a webpage is to be understood broadly. In the context of webpages, “loading of a page” refers to one or more of fetching, rendering, placing in memory, or preparing all necessary resources so that the webpage is functional. This includes not only downloading resources like HTML, CSS, Javascript, images, and fonts but also rendering these resources within the browser to visually display the content, establish interactivity, and provide responsive behavior.

As used herein “transmitting” a webpage is to be understood broadly. In the context of webpages, “transmitting” refers to the process of delivering webpage content and resources to the client, either by sending them over a network or by providing them directly within a local server environment. When transmitting over a network, resources such as HTML, CSS, JavaScript, images, and multimedia files are sent from a remote server to the client's browser through network protocols like HTTP or HTTPS. Alternatively, in a local server environment, transmitting may involve making these resources available directly from within the server's storage, bypassing the need for external network transfer. Transmitting as used herein may also refer to passing and/or sharing data and/or values between two or more circuits and/or other devices.

Embodiments of the current disclosure may provide for improved “snappiness” which as used herein, may refer to a user's perceived responsiveness of a displayed page. For example, snappiness may refer to the responsiveness and speed with which a webpage loads and reacts to user interactions. Snappiness may also refer to and/or include a measure of one or more of parameters related to load time, interactivity (delay between user actions), smoothness (the fluidity of animations and transitions without stuttering or lag), and/or the like.

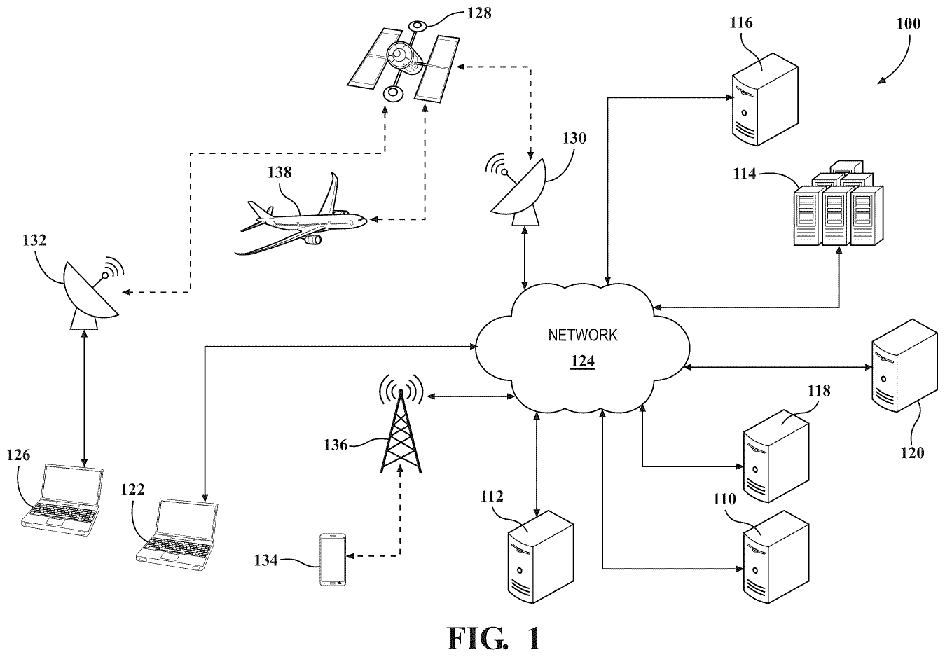

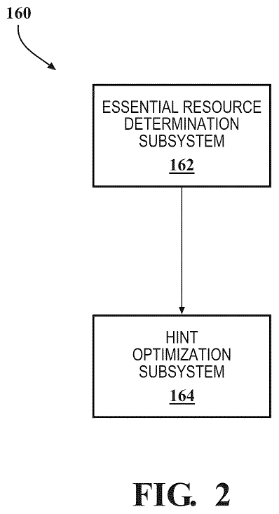

Referring now to FIG. 1, a system 100 for identifying blocking resources and tuning web browser hints may include one or more discovery servers 110 and/or one or more hint tuning servers 112. As disclosed in greater detail herein, in embodiments, the discovery servers 110 are structured to determine/detect/identify one or more blocking resources for an event associated with rendering of a webpage hosted by one or more webservers 114 that may utilize resources hosted by one or more resource servers 116 and 118. The identified significant events may be provided to the tuning server 112 that determines an optimized set of hints, hosted by one or more hint servers 120, for use by a web browser (210 in FIG. 2), also referred to herein as a webpage browser, in loading the webpage.

In embodiments, the web browser may be located on a computer 122 connected to a network 124, e.g., the Internet, via a landline, wherein the network 124 is further connected to the discovery servers 110, the hint tuning servers 112, webservers 114, resource servers 116 and 118, and/or the hint servers 120. Embodiments of the web browser may also be located on a computer 126 connected to the network via a satellite 128 with a corresponding uplink 130 and downlink 132, a computing device 134, e.g., a smart phone, connected to the network 124 via a wireless connection, e.g., WiFi and/or cellular (represented by antenna 136), and/or a mobile system 138, e.g., a vehicle such as an airplane equipped with a satellite 128 internet connection.

FIG. 2, depicts an example of a logical data flow for elements of the system. The system 160 may include a first subsystem 162 for identifying essential or blocking resources for events and a second subsystem 164 for optimizing hints. In one configuration, as shown in FIG. 2, the output of the first subsystem 162 may be the input to the second subsystem 164. In one example, elements of the first subsystem 162 may include discovery servers 110 and may be structured to determine one more blocking resources for different events. The first subsystem 162 may generate one or more lists of blocking resources for one or more significant events for a webpage. The lists of blocking resources may be used to generate hints for the page. The second subsystem 164 may be configured to optimize hints generated from the list of blocking resources. The second subsystem 164 may include one or more tuning servers 112 described in FIG. 1. The second subsystem 164 may generate an optimized set of hints (e.g., an ordered set of hints) that can be used to optimize the rendering of a webpage for a client.

The system's modules, as depicted in FIG. 2, can be used independently of one another. This modular setup provides the advantage of selectively deploying only the necessary subsystems, depending on the application requirements. For instance, in one configuration, the first subsystem 162, which identifies essential or blocking resources for significant events, may be used alone to generate hints for resource prioritization without requiring further optimization by the second subsystem 164. This configuration is particularly useful when rapid, preliminary hints are sufficient or when the overhead of additional optimization processes is not needed.

The second subsystem 164, responsible for refining and optimizing loading hints, may be deployed independently to enhance existing hints that might not have originated from the first subsystem 162. In this configuration, the second subsystem 164 could apply its optimization logic to hints derived from external sources, legacy systems, or manual inputs, making it versatile in enhancing any pre-existing hint strategies. This allows for further refinement of loading priorities, tuning hint sequences to improve resource loading efficiency, and enhancing overall page performance without dependency on the discovery output from the first subsystem.

The operations of the two subsystems 162 and 164 can be performed offline within a controlled test bench environment. Running these operations offline allows for extensive testing and tuning without impacting live user experiences or network conditions. In a test bench setting, the first subsystem can identify essential or blocking resources by determining the effects of delays for resources on different events. Similarly, the second subsystem's hint optimization can be executed offline, where generated hints are refined and sequenced for optimized/improved loading. The test bench environment allows for iterative testing of various hint configurations to see how they impact loading performance across a range of scenarios, such as different network speeds, device types, and resource loads.

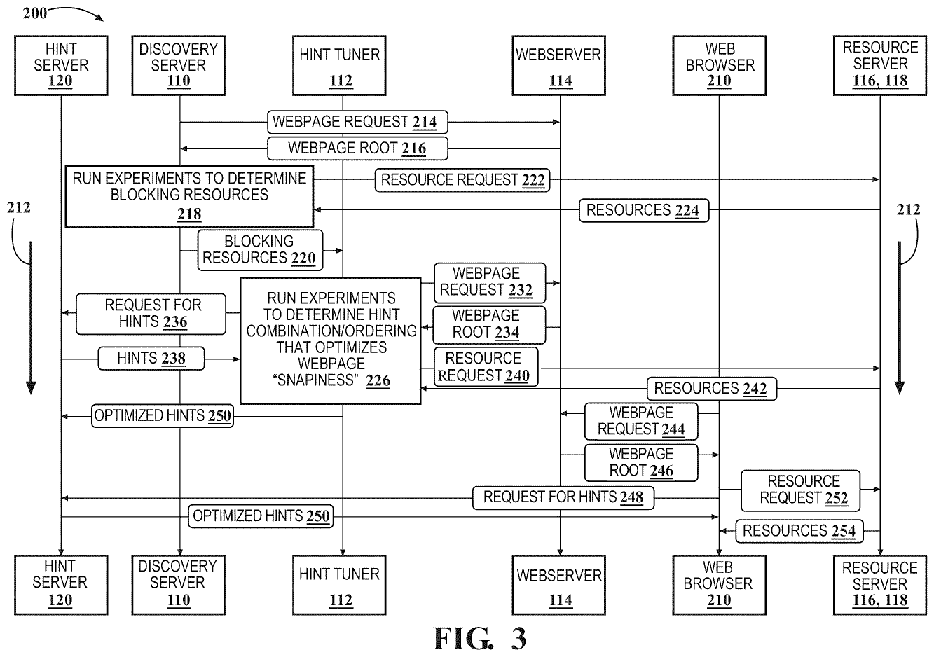

Referring to FIG. 3, time sequence diagram 200 depicts an approximation of the sequencing of processing events and messaging between the discovery servers 110, hint tuning servers 112, webservers 114, resource servers 116 and 118, hint servers 120, and web browser 210, in accordance with an embodiment of the current disclosure, wherein time flows in the direction of arrows 212. Accordingly, the discovery server 110 sends a webpage request 214 to the webserver 114 which responds back with a webpage root 216. The discovery server 110 then begins to run experiments 218 using the webpage root 216 to determine one or more essential resources 220. The experiments 218 may involve requesting 222 resources 224 from one or more resource servers 116 and 118.

In embodiments, the discovery process does not require a webserver and may be conducted locally. The discovery server 110 may be configured with the webpages such that a request from the discovery server 110 to the webserver for webpage resources may not be required.

In embodiments, the experiment 218 may include identifying essential resources for one or more significant events. In some cases, the discoverer may determine one or more blocking events by analyzing events during rendering. In embodiments, the discoverer may identify the significant resources by iteratively delaying one or more resources and monitoring the effects of the delay on the timing of the significant event(s). Based on the effects, the discoverer can determine which resources are essential for the event(s). Based on the results of the analysis, the discoverer may generate one or more lists of essential resources 220 for one or more significant events.

In embodiments, the list of resources 220 is then transmitted to the hint tuning server 112, which then runs experiments 226 to determine optimized hints 250, e.g., an ordered listing of hints structured to optimize the webpage's snappiness. In embodiments, the experiments 226 may involve loading the webpage multiple times with a browser, a modified browser, and/or an application structured to simulate the web browser 210, while timings for the significant events are measured. As such, the hint tuning server may make a webpage request 232 to get the webpage root 234, and also make a request for hints 236 to the hint server 120 to get un-modified hints 238. As part of the experiments 226, the hint tuning server 112 may then generate combinations from the hints 238 and, for each combination, simulate a loading of the webpage by requesting 240 and receiving 242 resources from the resource servers 116 and 118 in accordance with the combination.

Based on the experiments, the hint tuning server then determines/generates the optimized set of hints 250 which may then be transmitted to the hint server 120 for use in a future loading of the webpage by the web browser 210. For example, the web browser 210 may make a webpage request 244 receive the root 246, and make a hint request 248 where the hint server 120 sends back the optimized hints 250. The web browser 210 may then use the hints to prefetch resources via one or more resource requests 252 and corresponding resource retrievals 254, e.g., downloads.

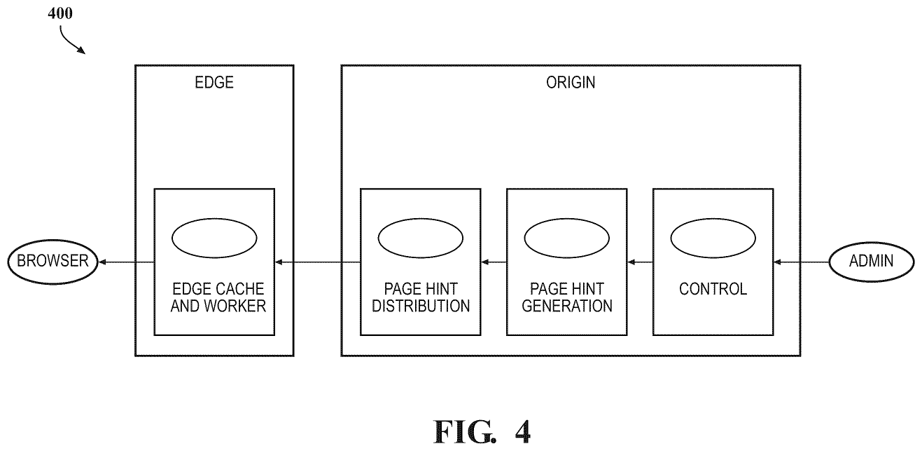

Hints generated by the system can be delivered using a hinting service. In embodiments any suitable hinting service may be used. FIG. 4 depicts some aspects of an example hinting service 400. The hinting service can be configured as a distributed system with multiple components operating across various cloud platforms. The hinting service may include origin components configured to generate, manage, and store hints. The hinting service may include edge components deployed as distributed worker servers. These edge components can deliver hints to user devices with minimal latency, accessing the nearest data center for each user's location. The edge components may be edge servers distributed geographically. By hosting edge components close to end users, the hinting service 400 can serve optimization hints in real time, adapting to specific conditions like network speed and device capabilities. This cloud-based, multi-layered architecture allows the hinting service to combine centralized hint generation with distributed, low-latency hint delivery, optimizing performance across diverse geographic and technical environments.

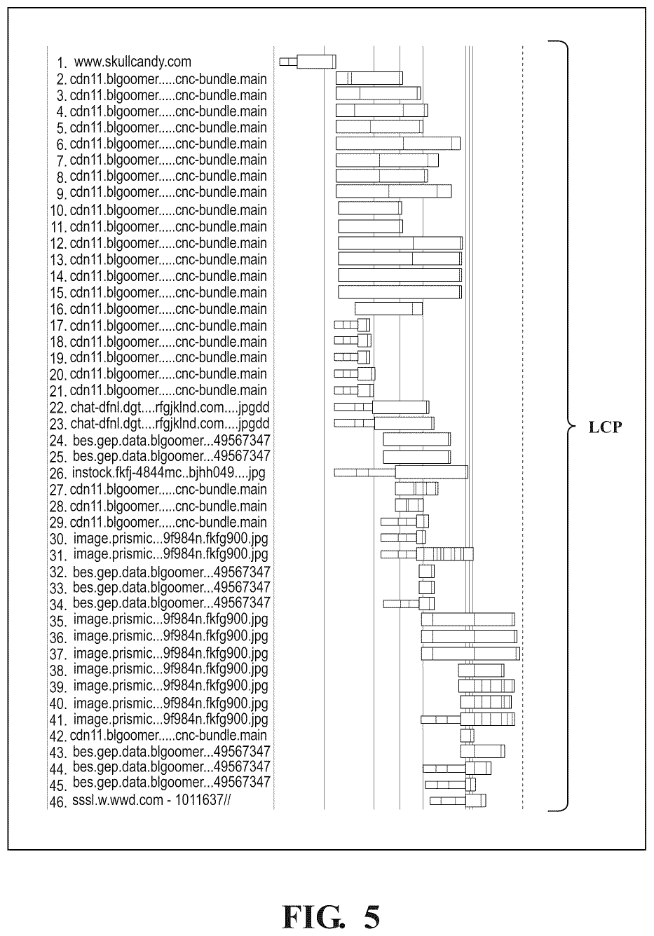

FIG. 5 depicts an example waterfall diagram that visually represents the sequence and timing of some resources loaded by a browser when rendering a webpage. The diagram includes a row for each resource (e.g., images, CSS files, JavaScript files, fonts, etc.) with a horizontal bar illustrating how long it takes to load each resource and when each phase of loading occurs. The diagram shows the sequence and duration of each resource's load time. The timeline progresses from left to right, with each resource's row divided into segments representing different loading stages that include content download, processing, rendering, and the like.

The example waterfall diagram further shows the timing of a significant event. The diagram shows the timing (depicted as a vertical dotted line) of an LCP event. The relative timing of the LCP event and the timing of the resources provide an indication of whether a resource is a necessary resource or a blocking resource for the event.

For example, if LCP occurs after a CSS file is fully loaded, this suggests the CSS was not required for the event. On the other hand, if the LCP occurs after CSS file is fully loaded, the CSS file is not necessarily essential/blocking for the LCP event.

To confirm if a resource is required for an event, a resource may be delayed, noting any impact on the event's timing due to the delay. If delaying a resource pushes the event to occur later, this confirms the resource's importance. Conversely, if delaying has no effect, it indicates that the resource is not required for the event. Repeating these observations across different resources can provide a list of the necessary resources for an event. Through a systematic analysis of the effects of delays on resources, the system can pinpoint which resources are essential for specific events, allowing for optimized loading strategies that improve page performance by prioritizing the necessary resources.

In embodiments, the system can determine essential resources for a specific event by systematically delaying individual resources and observing the effect on the timing of that event. In one example, the delay to the resources during testing may be an amount that is greater than the timing of the event under normal conditions, e.g., in the absence of the inserted delay. In embodiments, the delay set for a resource may be set to be at least nX greater than the timing of the page event, where n can be 2, 3, 4, 5, 6, 7, 8, 9, 10, or more.

For example, the timing of an event (e.g., LCP) during normal page rendering, e.g., in the absence of an inserted delay, can be measured to occur at 10 ms after rendering is initiated.

During testing, resources can be delayed by 20 ms, 30 ms, 40 ms, 50 ms, 60 ms, 70 ms, 80 ms, 90 ms, 100 ms, or more. If the delay of the resource also delays the significant event (e.g., by 10 ms or more), the delayed resource can be determined to be a blocking resource for the event.

In another example, testing if a resource is blocking may include visiting/loading a webpage with a web browser and observing the first timing of a page event (e.g., 10 ms) for the webpage. The superset of resources fetched as part of the rendering of the webpage that occurs prior to the page event can be recorded. As is to be understood, the superset of resources is the set of resources that may potentially be blocking for the event. To test which of the resources in the superset of resources is blocking, the webpage may be visited a second time with a web browser. The web browser may be configured to introduce a delay prior to the fetching of one or more of the superset of resources. The delay can be set to an amount that is greater than the timing of the page event (e.g., greater than 10 ms, such as 20 ms, 30 ms, or more). The timing of the page event after the delay can be monitored. Based in part on the second timing and the amount of the delay, the system can determine that one of the superset of resources is blocking for the page event (e.g., if the event is delayed, the resource is a blocking resource).

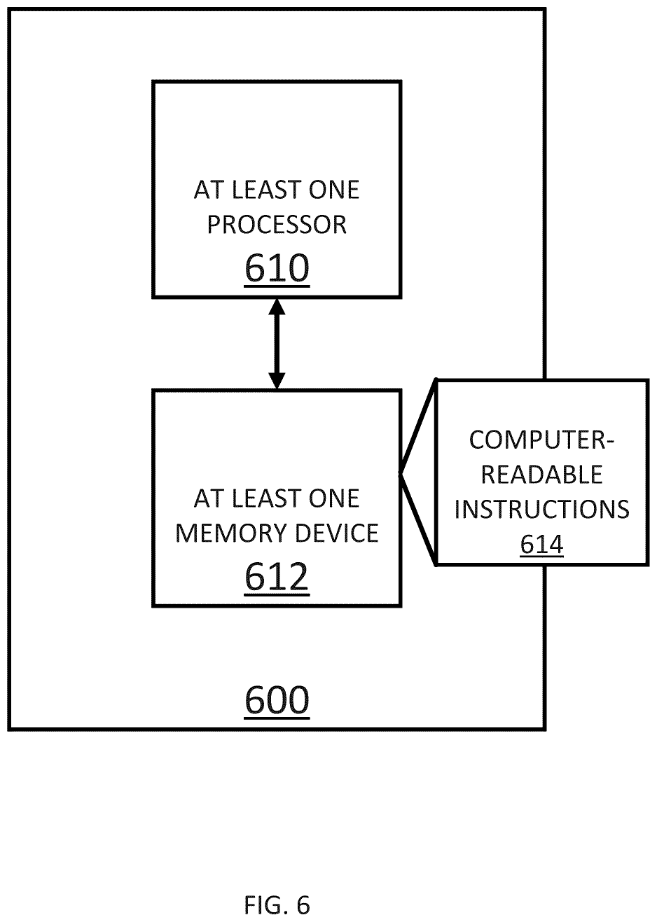

FIG. 6 depicts an example apparatus 600 which one or more of the methods for identifying blocking resources, optimizing hints, and/or any other method disclosed herein, may be performed on/by, in accordance with the current disclosure. Apparatus 600 may include at least one processor 610 and at least one memory device 612 and form part of the discovery servers 110 (FIG. 1), the hint tuning servers 112 (FIG. 1), the webservers 114 (FIG. 1), resource servers 116 and 118 (FIG. 1) and/or any other computing device disclosed herein. As described in greater detail herein, the at least one memory device 612 may store computer-readable instructions 614, e.g., a computer executable application, that, when loaded into the at least one processor 610, causes the at least one processor to interpret, process, and/or otherwise interact with associated resources, an associated delay, an associated timing, an associated event, an application, and/or a message having an indicator and blocking resource.

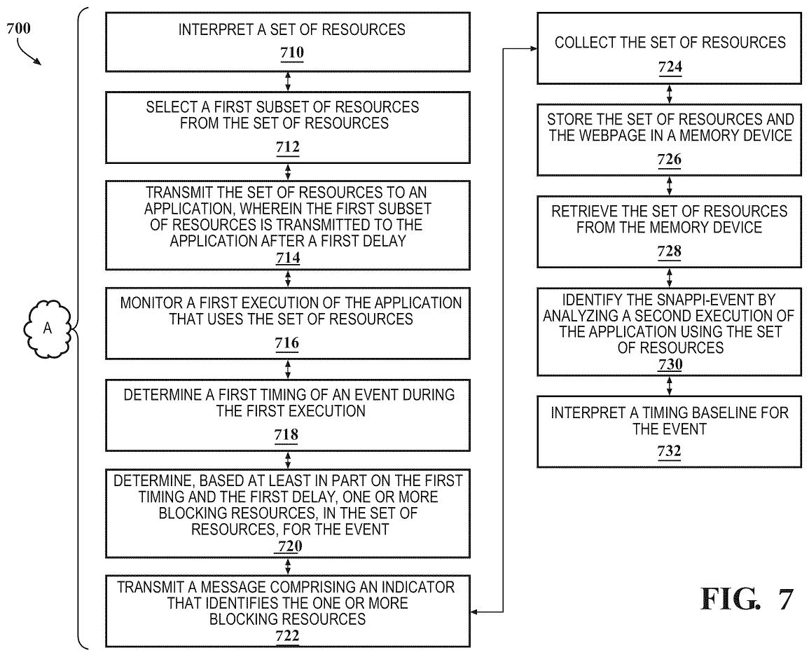

For example, referring to FIG. 7, in embodiments, the computer-readable instructions may cause the at least one processor to perform a method 700 for identifying blocking resources, in accordance with an embodiment of the current disclosure. The method 700 may be performed via apparatus 600 and/or any other computing device disclosed herein. The method 700 includes: interpreting a set of resources 710, and selecting a first subset of resources from the set of resources that may be selected 712. In embodiments, a set of resources may include one or more data objects, e.g., images, sound files, menu bars, text boxes, java applications, and/or any other type of digital asset used to load and/or render a webpage. In embodiments, the set of resources may be infinite, e.g., open. For example, embodiments of the current disclosure may discover and/or identify resources based on a pattern, where all resources associated with and/or having an element matching the pattern may be classified/identified as a blocking resource for a content rectangle, as disclosed herein. For example, the pattern may be a common URL, e.g., “https://www.example.com/{}/styles.css”, where ‘{}’ is a wild card. The set of resources may be transmitted to an application, wherein the first subset of resources is transmitted to the application after the first delay 714. A first execution of the application that uses the set of resources may be monitored 716; a first timing of an event during the first execution may be determined 718, the one or more blocking resources may be determined for the event based at least in part on the first timing and the first delay 720. A message having an indicator that identifies the one or more blocking resources may be transmitted 722.

In embodiments of the method 700, the application may be a webpage browser and the set of resources may be for a webpage. In such embodiments, the method 700 may further include the processes of collecting the set of resources 724, storing the set of resources and/or the webpage in a memory device 726, and retrieving the set of resources from the memory device 728.

In embodiments, the event may be a largest contentful paint, an all contentful paint, a first contentful object paint, a visual complete, an update layout tree, and/or a snappi-event. In embodiments where the event is a snappi-event, the method 700 may include identifying the snappi-event by analyzing a second execution of the application using the first set of resources 730. The one or more blocking resources may be required for the event to complete.

In embodiments, the method 700 may further include interpreting a timing baseline for the event 732. In such embodiments, determining the one or more blocking resources 720 may be further based at least in part on the timing baseline, e.g., the first timing may be longer than an expected timing for the event defined by the timing baseline. The timing baseline serves as a reference point, representing the expected timing (e.g., average, or longest reasonable time) within which the event should ideally occur. By establishing this baseline, the system may gain a benchmark against which the actual timing of events can be compared. In such cases, the process of identifying one or more blocking resources 720 is influenced by this baseline. For example, if the observed timing of an event exceeds the expected timing defined by the baseline, this discrepancy may indicate the presence of blocking resources delaying the event.

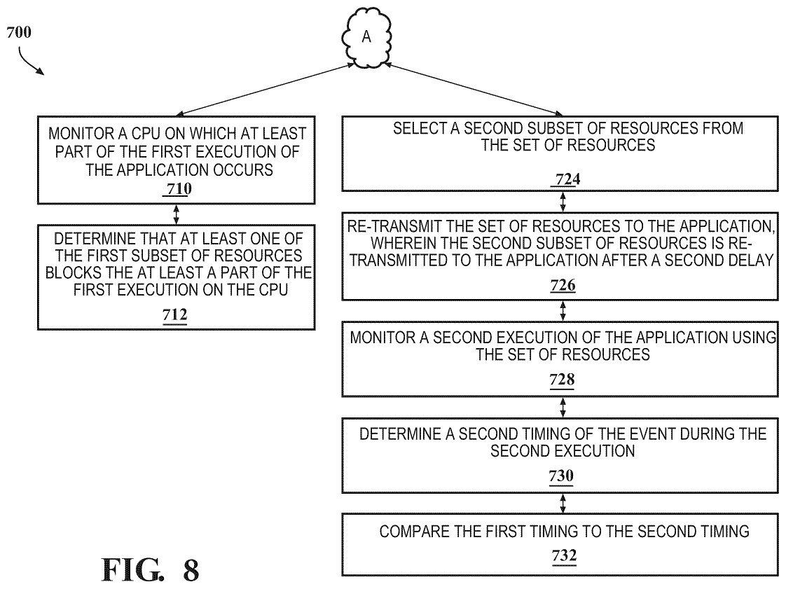

Referring now to FIG. 8, the method 700 may further include monitoring a CPU on which at least part of the first execution of the application occurs 710. The method 700 may further include determining that the one or more blocking resources may be based at least in part on the determination that the at least one of the first subset of resources blocks the at least a part of the first execution on the CPU 712.

As further shown in FIG. 8, the method 700 may include selecting a second subset of resources from the set of resources 724. In such embodiments, the set of resources may be re-transmitted to the application with the second subset of resources being re-transmitted to the application after a second delay 726. The method 700 may further include monitoring a second execution of the application using the set of resources 728, and determining a second timing of the event during the second execution 730. In such embodiments, determining the one or more blocking resources 720 (FIG. 8) may be further based at least in part on the second timing and the second delay. In such embodiments, the one or more blocking resources may include resources in the first subset of resources and the second subset of resources.

The method 700 may further include comparing the first timing to the second timing 732, where the one or more blocking resources may include resources in the first subset of resources when the first timing is longer than the second timing, and the one or more blocking resources may include resources in the second subset of resources when the second timing is longer than the first timing.

Turning now to FIG. 9, another method 900 for identifying blocking resources is shown. The method 900 may be performed via computer-readable instructions stored in the one or more memory devices 612 via the one or more processors 610 of apparatus 600, and/or via any other computing device disclosed herein. The method 900 includes: loading a first set of resources for consumption by a first application 910; providing the first set of resources to the first application 912, and monitoring a first execution of the first application with the first set of resources 914. The method 900 further includes determining a first timing of an event during the first execution 916, and loading a second set of resources and a third set of resources for consumption by the first application 918, where the second set of resources is a subset of the first set of resources and the third set of resources is a different subset of the first set of resources.

The method 900 further includes providing the second set of resources to the first application at a first time 920, and monitoring a second execution of the first application with the second set of resources 922. The method 900 further includes providing the third set of resources to the first application at a second time 924, and monitoring a third execution of the first application with the third set of resources 926. The method 900 further includes determining a second timing of the event during the second execution and third execution 928, and determining, from the second timing, that the third set of resources includes resources that are required for the event 930.

In embodiments, the application may be a webpage browser, and the event may be a largest contentful paint, an all contentful paint, a first contentful object paint, a visual complete, an update layout tree, and/or a snappi-event.

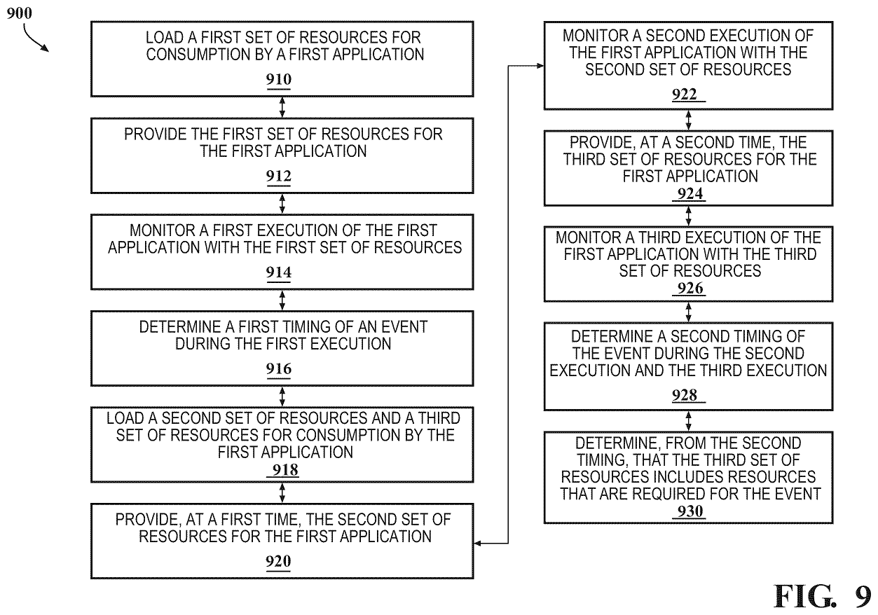

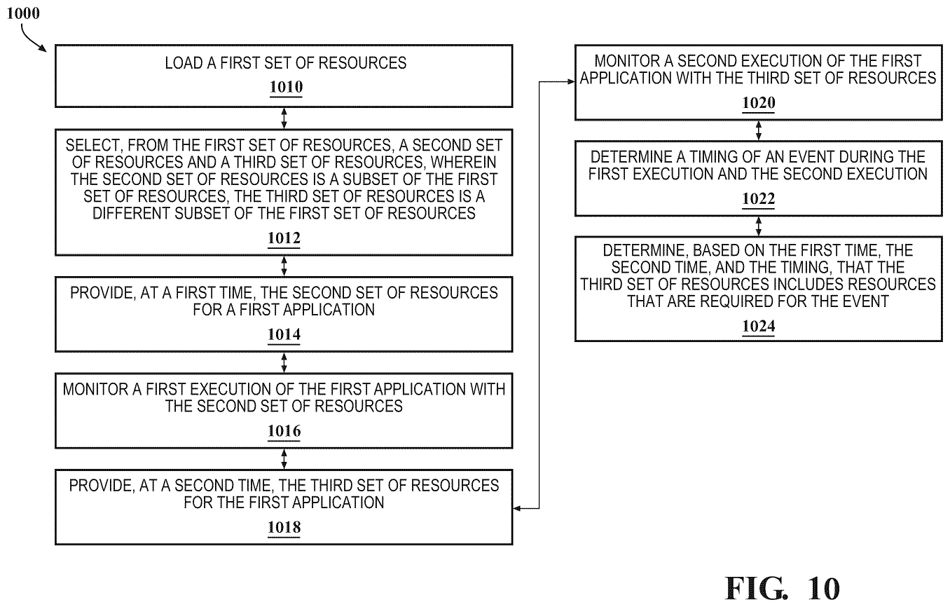

Turning now to FIG. 10, another method 1000 for identifying blocking resources is shown. The method 1000 may be performed via computer-readable instructions stored in the at least one memory device 612 in combination with the at least one processor 610 of apparatus 600, and/or via any other computing device disclosed herein. The method 1000 includes: loading a first set of resources 1010; and selecting from the first set of resources, a second set of resources and a third set of resources 1012. The second set of resources may be a subset of the first set of resources and the third set of resources may be a different subset of the first set of resources than the second. The method 1000 further includes: providing, at a first time, the second set of resources for a first application 1014; and monitoring a first execution of the first application with the second set of resources 1016. The method 1000 further includes providing the third set of resources for the first application at a second time 1018, and monitoring execution of the first application with the third set of resources 1020.

The method 1000 further includes determining a timing of an event during the first execution and the second execution 1022, and determining, based on the first time, the second time, and the timing, that the third set of resources includes resources that are required for the event 1024.

In embodiments, the application may be a webpage browser, and the event may be a largest contentful paint, an all contentful paint, a first contentful object paint, a visual complete, an update layout tree, and/or a snappi-event.

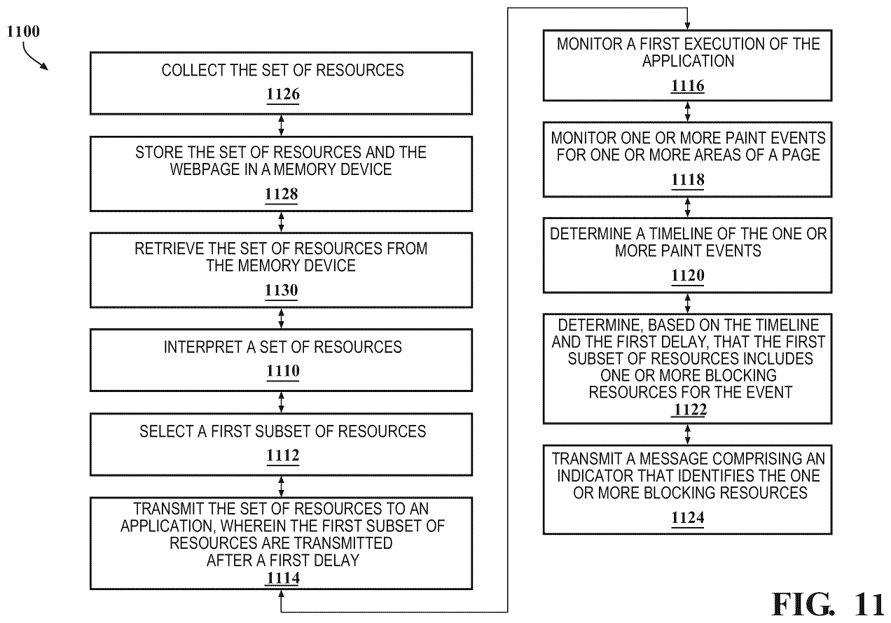

FIG. 11 depicts another method 1100 for identifying blocking resources, in accordance with embodiments of the current disclosure. The method 1100 may be performed via the computer-readable instructions in the at least one memory device 612 via the at least one processor 610 of apparatus 600 and/or any other computing device disclosed herein. The method 1100 includes: interpreting a set of resources 1110; selecting a first subset of resources from the set of resources 1112; and transmitting the set of resources to an application 1114, where the first subset of resources are transmitted after a first delay. The method 1100 further includes: monitoring a first execution of the application 1116; and monitoring one or more paint events for one or more areas of a page 1118. The method 1100 further includes determining a timeline of the one or more paint events 1120; and determining, based on the timeline and the first delay, that the first subset of resources includes one or more blocking resources for the event 1122. The method 1100 further includes transmitting a message having an indicator that identifies the one or more blocking resources 1124.

In embodiments, the application may be a webpage browser, and the set of resources may be for a webpage. In such embodiments, the method 1100 further includes: collecting the set of resources 1126; storing the set of resources and the webpage in a memory device 1128; and retrieving the set of resources from the memory device 1130.

As webpages evolve, their structure and resource dependencies often change, requiring periodic sanity checks to verify the validity of previously identified critical resources. New content, features, scripts, or third-party integrations introduced to a page can alter the loading dynamics and dependencies, potentially impacting which resources are essential for events. For instance, a script once deemed non-critical might become integral to the page's interactivity due to new functionalities, or new image assets might be required for primary content, changing their prioritization.

In embodiments, a sanity check involves the delay of non-critical resources. A sanity check is a validation procedure used to confirm which resources are genuinely non-essential for key page events and to confirm that the lists of essential resources are correct. By delaying all or a subset of identified non-blocking elements and observing whether this affects the timing of significant events, the system can verify if the resources labeled as “non-critical” truly do not impact the associated events.

In embodiments, sanity checks include delaying the loading of the identified non-blocking elements for an event to observe if the timing of the significant event is affected. If there's no delay in the event, the assumption that these elements are non-critical is validated which also means that the identified critical resources are also valid. If the sanity check fails (i.e., reveals that delaying the non-blocking elements affects event timing), a rerun of the resource analysis may be triggered.

In some embodiments, a targeted approach can be used during the sanity check by selecting only a specific subset of non-critical elements for testing. This selection may be strategically determined to improve the effectiveness of the sanity check while reducing unnecessary processing. The subset of elements chosen for delay testing can be based on various criteria, including the type of resource, its file size, its position within the overall loading sequence, and the like. For example, resources such as large images or complicated JavaScript files may be prioritized for sanity checks, as these larger assets can often contribute to unintended delays if they influence the timing of critical events more than anticipated. Additionally, resources that load early in the sequence may be selected, as they are more likely to interact with and potentially block certain rendering milestones.

In embodiments re-evaluation can be based on either the “freshness” of new resource data or the failure of the sanity checks, indicating that adjustments to resource categorization may be necessary.

In certain embodiments, the system's re-evaluation of resources may be triggered by either the “freshness” of new resource data or the failure of previous sanity checks, each serving as an indicator that adjustments to resource categorization (e.g., essential or non-essential for a given event) might be needed. When the system identifies new resource data that has not yet been incorporated into the existing resource categorization, it may prompt a re-evaluation to provide for the latest elements and dependencies to be accounted for in performance optimization strategies. Additionally, the failure of a sanity check indicates that the current categorization may inaccurately represent some resources as non-essential for an event. This failure signals the need for a re-evaluation.

While the examples described herein focus on the loading of visual resources, it is important to note that compute resources may also block page events and impact overall page performance. Compute resources (e.g., such as JavaScript execution, layout recalculations, data parsing, etc.) consume significant CPU time and can delay significant events (e.g., FCP, TTI). Unlike static loading resources, compute tasks are dynamic and may be triggered by user interactions or conditional content loading. When these compute tasks occupy CPU resources, they can prevent other essential processes from executing efficiently, thereby blocking or delaying significant events.

In embodiments, identifying blocking compute tasks may include analyzing specific operations requiring CPU power, such as JavaScript-heavy interactions, DOM updates, style recalculations, and other tasks triggered during user interactions or content loading. These CPU-intensive tasks can create noticeable delays, especially on resource-constrained devices, as they prevent the browser from responding to user inputs or efficiently loading of other essential resources. In many webpages, compute tasks are often dynamic, initiated by scripts, user actions, or conditional content loading.

For example, a JavaScript file may be essential for a compute task that updates content dynamically, while certain fonts or styles might trigger layout recalculations that consume CPU time and delay the initiation of key events.

Disclosed herein are embodiments and applications that optimize webpage performance by introducing novel techniques for selecting and deploying browser hints. Disclosed techniques address the common inefficiencies that can arise when hints (e.g., preconnect, preload, and priority hints) are used without adapting to real-world conditions. In current systems, hints are often applied uniformly, regardless of the environment in which they operate. This lack of adaptability can lead to inefficiencies, as hints may not be suitable for the specific network conditions or device capabilities, resulting in slower load times and a suboptimal user experience.

In one example, preloading or preconnecting resources without considering available bandwidth can overwhelm limited network resources. For instance, in low-bandwidth environments, preloading multiple large resources may slow down critical asset delivery, delaying the visible content users need to engage with the page. Additionally, some devices may lack the compute resources required to process all preloaded or prioritized assets efficiently, leading to browser strain and, ultimately, degraded page performance. The disclosed techniques allow for a more responsive hint deployment strategy that is adapted to available bandwidth and/or compute power, preventing such bottlenecks.

The disclosed techniques leverage a feedback-driven approach to fine-tune hint configurations accordingly. By analyzing metrics from past page loads, this method identifies which hints are beneficial in varying scenarios, effectively balancing resource-intensive preloads with selective preconnects. This enables the system to avoid unnecessary resource consumption and prioritize only those hints that meaningfully enhance load times.

Furthermore, the system optimizes the timing of hint deployment, choosing the best moment to apply each hint. In one example, hints can be provided during two different phases. The first phase occurs before the root HTML document arrives, where the browser can begin loading essential resources early using an Early Hint (HTTP 103) or an Optimization Guide Service (OGS) hint in Chromium browsers. These early hints allow the browser to preconnect to necessary domains, preload critical assets, or assign priority to key resources before receiving the main HTML document. Early hints are particularly effective for reducing latency since they enable the browser to initiate connections and resource loading while awaiting the full page content, resulting in faster initial render times.

The second phase of occurs with the root HTML document's arrival, where hints can be delivered as part of a response. In one example second phase may occur with HTTP 200 response headers or embedded directly within the HTML of the root object itself. For example, a webpage's HTTP 200 response might include headers that tell the browser to preload a CSS file or preconnect to an external image CDN.

A process for determining which resources should receive different types of hints (e.g., preconnect, preload, prefetch, etc.) and/or the timing of the hints (e.g., early HTTP 103 and/or HTTP 200) can include processes of initial data collection, and feedback driven refinement. In one example, the process may begin with collecting data on resource loading behavior during page loads, both in simulated environments and real-world scenarios. This data includes information about resource types (e.g., images, CSS, JavaScript), file sizes, loading times, and network requests. Additionally, event data (e.g., Largest Contentful Paint (LCP), paint event, etc.) and the respective blocking resources may be determined using the techniques described herein. With the resources identified, the system may assign appropriate hint types to the blocking resources.

In embodiments, the process may change the hint types associated with the blocking resources and monitor webpage metrics (e.g., load times, snappiness, etc.) to determine which assignment results in the best performance (e.g., lowest load times, quickest response time, etc.).

In one embodiment, the process may systematically experiment with combinations of different hint type assignments for the resources. This experimentation may involve testing various permutations of preconnect, preload, prefetch, and priority hints and/or the timing of the hints across the full set of page resources (e.g., CSS files, JavaScript, images, and external fonts, etc.) to determine which combinations yield the best performance. The systematic experimentation can begin by isolating each resource and applying individual hint types, then progressively testing multiple hints in combination. For instance, an initial test might assign a preconnect hint to a CSS file, while a preload hint is assigned to a primary image required for initial rendering. As tests proceed, the system evaluates metrics like page render time, timing of paint events, overall network latency, and/or the like to gauge the effectiveness of each hint configuration. The experimentation process can include various timing options for each hint type, such as deploying hints early (e.g., using HTTP 103 Early Hints) or waiting to include them in the main HTML (e.g., using HTTP 200 response).

In one embodiment, the process may utilize heuristics to experiment with different combinations of hint-type assignments for each resource, aiming to identify the optimal, e.g., an improved, configuration for specific page load scenarios. This heuristic-driven approach intelligently narrows down the number of hint configurations to test, focusing on combinations that are more likely to improve load performance based on prior knowledge, best practices, and contextual information about the page and its resources. Rather than exhaustively testing every possible combination, heuristics allow the process to concentrate on promising configurations, making the experimentation phase more efficient and less resource intensive. The heuristics may consider factors such as resource criticality, dependency chains, and loading sequence. For example, the system may prioritize applying preload hints to render-blocking resources like CSS files or images in the viewport, while preconnect hints could be applied to external domains that host essential scripts or media files. Additionally, the heuristics might assign lower priority to hints for non-critical resources, such as those that only load once the user begins to scroll.

In one embodiment, the process may utilize trained machine learning models to intelligently experiment with different combinations of hint-type assignments for each resource, adapting to the specific needs of each page load scenario. By leveraging models trained on historical data and previous page load performance, the system can predict which hint combinations are likely to yield efficient loading times (including, in some embodiments, the fastest loading times), allowing it to selectively experiment with promising configurations. This approach reduces the computational expense of exhaustive testing by focusing on combinations that align with established performance patterns and resource priorities.

Testing of hints can be conducted in either a real system environment or a simulated environment. In a real system environment, hint configurations can be tested under true user conditions, providing insights into how hints perform with actual device hardware, network variability, and user behavior. The real-world testing allows for accurate assessment of hint effectiveness in live scenarios, revealing how well the hints improve load times and user experience across a range of unpredictable conditions. Testing in a real environment can also help detect edge cases or unexpected interactions that might not surface in controlled conditions.

Testing of hints can be conducted in a simulated environment. A simulated environment offers control over a wide range of variables, such as device specifications, network characteristics, and cache states, enabling systematic experimentation with hint configurations. In a controlled setting, testing can be performed across a variety of defined scenarios, including high-latency networks, limited bandwidth, and low-power devices, without the interference of random external factors. Simulated testing is particularly advantageous during the tuning phase, as it allows the system to fine-tune hint combinations to determine the optimal configurations for different conditions before deploying them broadly. By adjusting specific parameters (e.g., browser version, operating system, cache state, and network conditions) the simulated environment provides insights into how hints affect load times and performance consistency across diverse configurations and/or tailor hints for specific configurations.

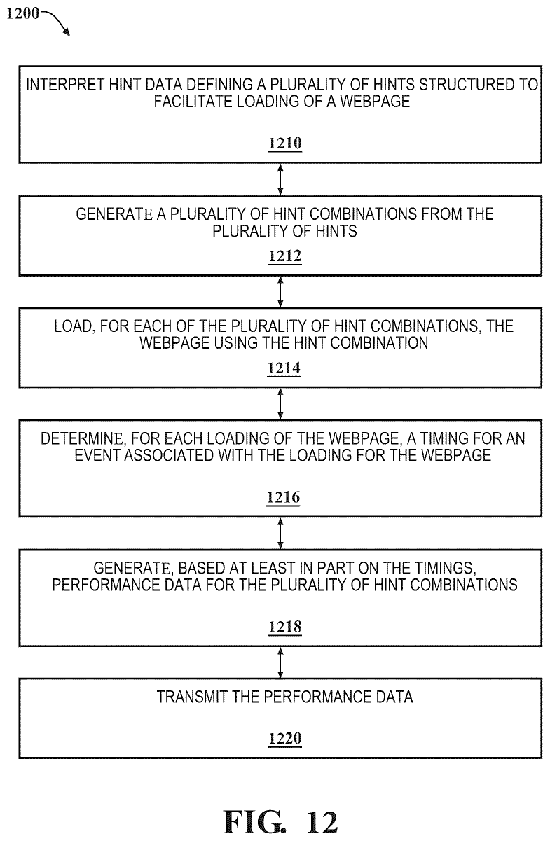

FIG. 12 is an example method 1200 that may be performed via the computer-readable instructions stored in the at least one memory device 612 in combination with the at least one processor 610 of apparatus 600, and/or any other computing device disclosed herein. The method 1200 includes interpreting hint data to define a plurality of hints structured to facilitate loading of a webpage 1210. Further, the method generates a plurality of hint combinations from the plurality of hints 1212, and loading, for each of the plurality of hint combinations, the webpage using the hint combination 1214.

The method 1200 also includes determining, for each loading of the webpage, a timing for an event associated with the loading for the webpage 1216, and generating, based at least in part on the timings, performance data for the plurality of hint combinations 1218. Lastly, the method includes transmitting the performance data 1220.

In example embodiment, the plurality of hints includes information for locating one or more resources used to load the webpage. In example embodiments, the plurality of hints includes one or more child universal resource locators (URLs). In example embodiments, the resources are elements rendered on the webpage. In example embodiments, these elements include graphics. In embodiments, the plurality of hints may include indications to preload a resource or to preconnect to the resource's location/domain.

In example embodiments, the event in FIG. 12 is a largest contentful paint. In other example embodiments, the event is an all contentful paint. In example embodiments, the event is a first contentful object paint. In example embodiment, the event is a visual complete. In example embodiments, the event is update layout tree.

In some example embodiments of method 1200, generating the plurality of hint combinations 1212 is based at least in part on the event. In example embodiments, the event is a snappi-event.

Further, in some example embodiments of the method 1200, the performance data includes one or more of the timings. In example embodiment, the performance data further includes one or more of the plurality of hint combinations. In some example embodiments, the performance data associates each of the one or more timings to one of the plurality of hint combinations.

Referring to FIG. 12 and the method 1200, in some example embodiments, at least one of the hint combinations includes an ordered set of hints of at least some the plurality of hints. And in some example embodiments, the ordered set of hints is based at least in part on a prefetching priority. In some example embodiments, the ordered set of hints is based at least in part on a network resource. In example embodiments, the ordered set of hints is based at least in part on an expected bandwidth of at least one network connection. In other example embodiments, the ordered set of hints is based at least in part on a compute resource. In example embodiments, the ordered set of hints is based at least in part on an available memory.

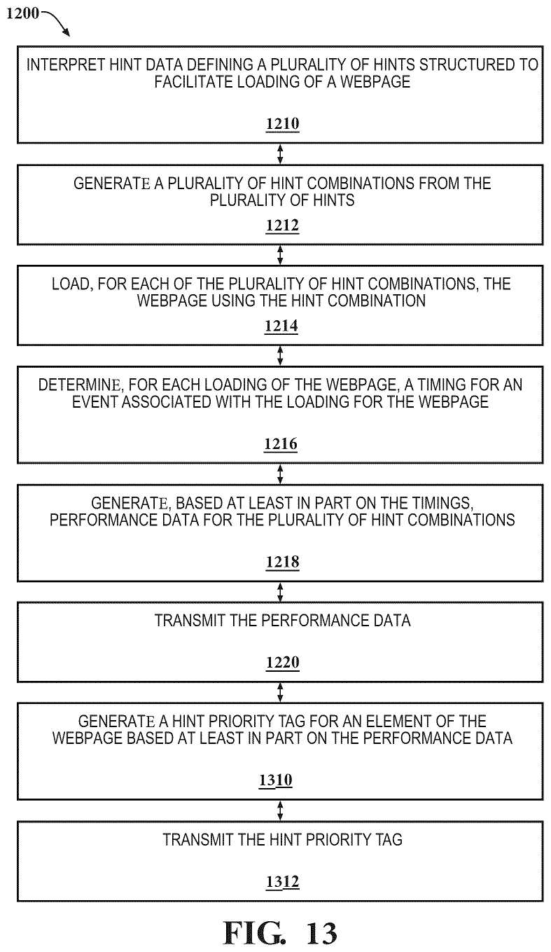

Referring now to FIG. 13, in example embodiments, the method 1200 further includes generating a hint priority tag for an element of the webpage based at least in part on the performance data 1310. Further, the method 1200 may further include transmitting the hint priority tag 1312.

Referring to FIG. 14, in example embodiments, the method 1200 further includes injecting the priority tag into a HyperText Markup Language (HTML) data file for the webpage 1410.

Example embodiments are for a non-transitory computer-readable medium storing instructions that, when loaded into at least one processor, cause the at least one processor to interpret hint data defining a plurality of hints structured to facilitate loading of a webpage. The non-transitory computer-readable medium may generate a plurality of hint combinations from the plurality of hints and load, for each of the plurality of hint combinations, the webpage using the hint combination. Further, the medium may determine, for each loading of the webpage, a timing for an event associated with the loading for the webpage, and generate, based at least in part on the timings, performance data for the plurality of hint combinations. Lastly, the medium may transmit the performance data.

In example embodiments of the non-transitory computer-readable medium, the plurality of hints includes information for locating one or more resources used to load the webpage. Further, in some example embodiments of the medium, the plurality of hints includes one or more child universal resource locators (URLs). In example embodiments of the medium, the one or more resources are elements rendered on the webpage. In some embodiments, the elements are graphics.

In example embodiments of the non-transitory computer-readable medium the event is a largest contentful paint. In some examples, the event is an all contentful paint. In some examples, the event is a first contentful object paint. In some examples, the event is a visual complete. While in some examples, the event is update layout tree.

In example embodiments of the non-transitory computer-readable medium, the stored instructions further cause the at least one processor to generate the plurality of hint combinations based at least in part on the event. In examples, the event is a snappi-event.

In some examples of the non-transitory computer-readable medium the performance data includes one or more of the timings. In some examples of the medium, the performance data further includes one or more of the plurality of hint combinations. In examples, the performance data associates each of the one or more timings to one of the plurality of hint combinations.

In example embodiments of the non-transitory computer-readable medium, at least one of the hint combinations includes an ordered set of hints of at least some the plurality of hints. In some example embodiments, the ordered set of hints is based at least in part on a prefetching priority. In some examples, the ordered set of hints is based at least in part on a network resource. In some examples, the ordered set of hints is based at least in part on an expected bandwidth of at least one network connection. In some embodiments of the medium, the ordered set of hints is based at least in part on a compute resource, and in some examples, the ordered set of hints is based at least in part on an available memory.

In example embodiments of the non-transitory computer-readable medium, the stored instructions further cause the at least one processor to generate a hint priority tag for an element of the webpage based at least in part on the performance data and transmit the hint priority tag.

In example embodiments of the medium, the stored in instructions further cause at least one processor to inject the priority tag into the webpage. In some examples, the stored instructions further cause at least one processor to inject the priority tag into a HyperText Markup Language (HTML) data file for the webpage.

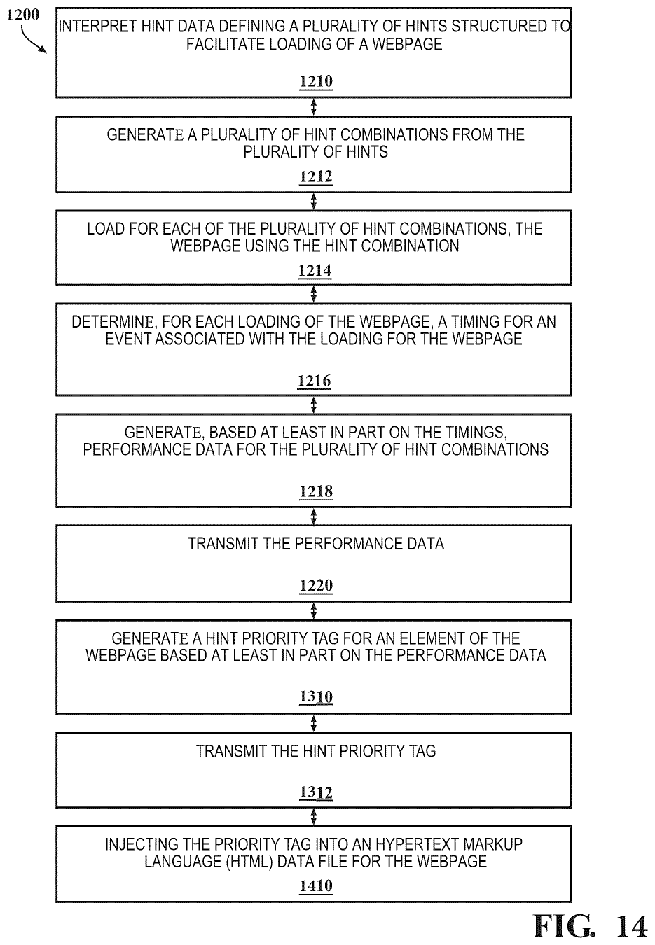

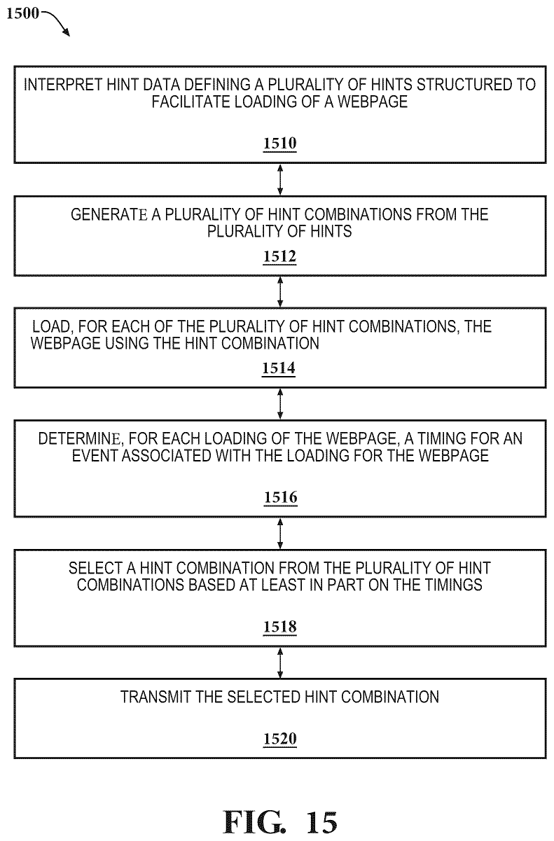

FIG. 15 is an example embodiment of a method 1500 that may be performed via the computer-readable instructions stored in the at least one memory device 612 in combination with the at least one processor 610 of the apparatus 600, and/or any other computing device disclosed herein. The method 1500 includes interpreting hint data defining a plurality of hints structured to facilitate loading of a webpage 1510. The method 1500 may further include generating a plurality of hint combinations from the plurality of hints 1512, and loading, for each of the plurality of hint combinations, the webpage using the hint combination 1514. The method 1500 may also include determining, for each loading of the webpage, a timing for an event associated with the loading for the webpage 1516, and selecting a hint combination from the plurality of hint combinations based at least in part on the timings 1518. The method 1500 may also include transmitting the selected hint combination 1520.

In example embodiments, the method 1500 may generate the plurality of hint combinations based at least in part on an expected network resource associated with the plurality of hints. In example embodiments, the expected network resource may be based at least in part on at least one of a bandwidth, a latency, or a cost.

In example embodiments, generating the plurality of hint combinations 1512 may be based at least in part on an expected compute resource associated with the plurality of hints. In example embodiments, the expected compute resource in may be based at least in part on at least one of a cache or a processing capability.

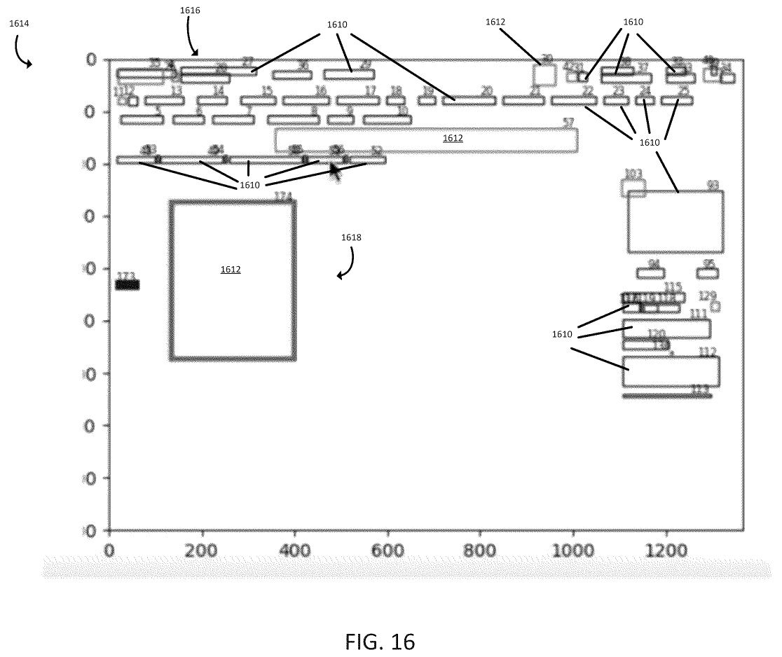

Referring now to FIG. 16, embodiments of the current disclosure may utilize events corresponding to content rectangles 1610 and 1612, for a webpage 1614, that are associated with the loading of a webpage, to generate hints that optimize the loading of the webpage 1614. The content rectangles may include persistent 1610 and/or dynamic 1612 content rectangles. Non-limiting examples of persistent content rectangles 1610 include content-areas, e.g., images, forms, web apps, banners, menus, etc., that are the same across multiple webpages, whereas non-limiting examples of dynamic 1612 content rectangles include content-areas, e.g., images, forms, web apps, banners, menus, use of resources having templated urls, A/B and A/none patterns, etc., that are not the same across multiple webpages. For example, an ecommerce web site may have a common webpage template for presenting products to a user, where an example of a persistent content rectangle 1610 may be a top menu 1616 that the same options across multiple instances of the webpage template for different products, where an example of an dynamic content rectangle 1612 may be a main product picture 1618 that is unique for each product page. While embodiments of the current disclosure are discussed herein with respect to content “rectangles”, it is to be understood that other types of 2D shapes are contemplated, e.g., triangles, circles, ovals, rhombuses; and/or, in the case of augmented and/or virtual reality, 3D shapes, e.g., spheres, cubes, and/or the like. In embodiments, the content rectangles may include non-painted objects.

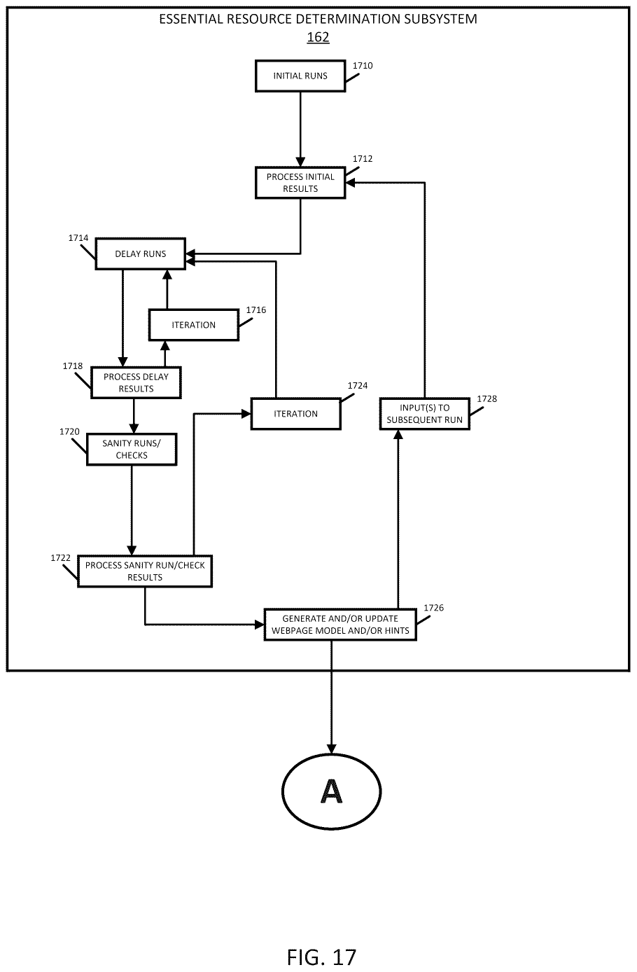

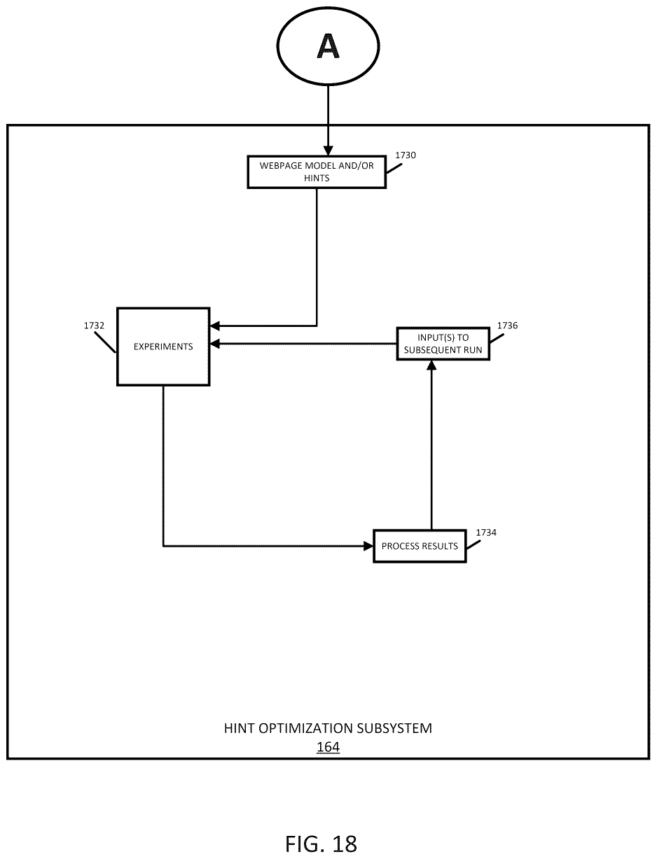

FIGS. 17 and 18 depict additional details of the essential resource determination subsystem 162 (also shown in FIG. 2) and the hint optimization subsystem 164 (also shown in FIG. 2). The essential resource determination subsystem 162 may be structured to identify content rectangles 1610 and 1612 (FIG. 16) for a webpage and/or corresponding blocking resources for the content rectangles 1610 and 1612. For example, the subsystem 1612 may include an initial runs component 1710 that loads a webpage multiple times to gather feedback regarding the loading of the webpage. The feedback may include identified content rectangles, locations of resources needed by the content rectangles, initial loading times for the content rectangles and/or retrieval times for the corresponding resources, and/or the like. The initial runs 1710 may be performed in series or in parallel. In embodiments, the initial runs component 1710 may programmatically visit the webpage many times, e.g., five (5), ten (10), twenty (20), etc., to collect the feedback data. For example, in embodiments, the initial runs component 1710 may visit a webpage nine (9) times.

The subsystem 162 may include a process initial results component 1712 structured to analyze the feedback gathered by the initial runs component 1710. For example, in embodiments, component 1712 may be structured to discover persistent content rectangles, derive visual importance values with respect to particular nodes, e.g., content rectangles, discover potential blocking resources, and/or incorporate dynamic blockers from previous page models. In embodiments, the process initial results component 1712 may determine the existence of content rectangles and/or whether a particular content rectangle is persistent 1610 or dynamic 1612. Non-limiting examples of process feedback results by component 1712 include waterfall diagrams/charts, lists of paint events, lists of network events, etc. In embodiments, component 1712 may identify nodes, e.g., content rectangles, and whether they are persistent 1610 or dynamic 1612, and/or the resources that may precede the nodes. Component 1712 may identify the nodes for every visit by the initial runs component 1710 and the sub-resource URLs that are downloaded prior to painting each of the nodes, e.g., content rectangles. In embodiments, component 1712 may derive an ID scheme, based on XYWH (cascading style sheets), content, xpath, etc., for persistent nodes 1610, such that the persistent nodes 1610 may be identified on subsequent webpage visits by looking at waterfall data. Component 1712 may also identify the persistent node 1712 with the largest painted area and its corresponding time to paint, e.g., component 1712 may identify the largestContentfulPaint event.

The subsystem 162 may include a delay runs component 1714 that repeatedly visits, e.g., loads, the webpage but where different resources are delayed during a given loading.

The delayed runs may be performed serially or in parallel, as represented by the iteration component 1716. In embodiments, the delay for a resource may be significantly longer than the slowest node, e.g., content rectangle, paint time. In embodiments, the delay may be on the order of microseconds, seconds, or minutes. For example, in one non-limiting example, the delay may be about ten (10 seconds.

The results of the delayed runs 1714 may be analyzed by a process delay results component 1718. In embodiments, the process delay results component 1718 may determine blocking resources from candidate resources by analyzing how long and/or delayed it took for a content rectangle (or a set of content rectangles) took to load and/or paint when a particular candidate resource was delayed during the delayed runs 1714. For example, embodiments of component 1718 may be able to infer the required resources for a given content rectangle if the content rectangle finished painting after the delay. Non-limiting examples of candidate resources, with respect to an event for the loading of a webpage, include resources that have the ability to impact the event, e.g., the painting of a content rectangle, as disclosed herein. Non-limiting examples of non-candidate resources, with respect to an event for the loading of a webpage, include resources that are used after an event has occurred.

Embodiments of the subsystem 162 may include a sanity runs/checks component 1720 and a process sanity runs/check results component 1722 structured to: check that the blocking resources identified by the process delay results component 1718 are indeed blocking resources; and/or determine the existence of additional blocking resources that may have been missed by the delayed runs 1714 and/or process delay results 1718 components. For example, the sanity runs/check component 1720 may load the webpage multiple times, where candidate resources that were not identified as blocking resources by the process delay results component 1718 are delayed while the identified blocking resources are allowed to load normally. In other words, embodiments of component 1720 may attempt to confirm that all blocking resources were discovered by visiting/loading the webpage and delaying the resources believed to not be required for loading and/or painting a content rectangle while not delaying the resources believed to be required for loading and/or painting a content rectangle. In embodiments, component 1722 may evaluate the results of component 1720 to determine if a missing blocking resource is due to a dynamic content rectangle. In embodiments, component 1722 may check the resources of visually important content rectangles.

The multiple loadings of the webpage as part of the sanity runs/check component 1720 may be performed serially or in parallel. The results of the sanity runs/check component 1720 are then analyzed by the process sanity run/check results component 1722. Assuming that the process delay results component 1718 correctly identified all the blocking resources, the content rectangles should have loading time(s) (during the sanity runs/check component 1720 webpage loadings) comparable to the loading times (during the initial runs component 1710) as determined by the process initial runs component 1712. Loading time(s) (during the sanity runs/check component 1720 webpage loadings) longer than expected in the sanity runs/check component 1720, as compared to the loading times (during the initial runs component 1710) as determined by the process initial runs component 1712, may be indicative that the process delay results component 1718 miss identified and/or missed a blocking resource. In other words, component 1722 may infer all blocking resources have been discovered if all the content rectangles on a webpage load and/or paint before the end of the delay.

In the event it appears the process delay results component 1718 misidentified and/or missed a blocking resource, the delay runs component 1714 may perform additional loadings of the webpage where different candidate resources (and/or combinations thereof) are delayed as represented by the iteration component 1724. In embodiments, the loop formed by the delay runs 1714, iteration 1716, process delay results 1718, sanity runs/check 1720, process sanity runs/check results 1722, and iteration 1724 components may be performed serially or in parallel.

As further shown in FIG. 17, the subsystem 162 may include a generate and/or update webpage model and/or hints component 1726 structured to generate and/or update a model of the webpage and/or a set of hints for optimizing loading of the webpage. In embodiments, the page model and/or hints may identify the consistent and/or dynamic nodes, e.g., content rectangles, how to create IDs for the nodes based on feedback data, e.g., browser feedback data, and the resources required to load and/or paint a particular node, e.g., content rectangle.

Embodiments of the subsystem 162 may include an input(s) to subsequent run component 1728 structured to perform additional loadings of the webpage as part of detecting any changes in the content rectangles and/or blocking resources.

Referring now to FIG. 18, the hint optimization subsystem 164 may be structured to optimize a webpage model and/or a set of hints for the webpage with respect to loading of the webpage. For example, the subsystem 164 may include a webpage model and/or hints component 1730 that receives and/or otherwise obtains a webpage model and/or a set of hints for loading the webpage. The webpage model and/or set of hints received/obtained may have been generated by the essential resource determination subsystem 162 (FIG. 17) as shown by the linking of FIGS. 17 and 18 via the connector ‘A’.

The subsystem 164 may include an experiments component 1732 structured to conduct experiments on the webpage to determine adjustments to the webpage model and/or set of hints to optimize the loading of the webpage. For example, the experiments component 1732 may use artificial intelligence to determine an order in which to utilize a hint in a given set of hints for each of a series of experiments, e.g., loadings of the webpage with a given hint ordering. The results of the experiments may be analyzed by a process results component 1734. In embodiments, component 1732 may visit/load the webpage, e.g., run an experiment, five (5) times, ten (10) times, fifteen (15) times, twenty (20) times, etc., with different variants of the webpage model and/or hint set. For example, in one non-limiting embodiment, component 1732 may visit/load the webpage, e.g., run an experiment, nine (9) times with differing variants of the webpage model and/or hint set. In embodiments, component 1732 may collect webpage level snappiness metrics, e.g., feedback, during each experiment. Non-limiting examples of webpage level snappiness metrics include first contentful paint (FCP), last contentful paint (LCP), speed index (SI), etc.

In embodiments, component 1732 may identify, based at least in part on the webpage model and/or set of hints, the content rectangles that have the biggest impact on the webpage's snappiness, e.g., page responsiveness as perceived by a user of a web browser. For instance, some webpages may have a single dominant image which may result in the largest painted content rectangle having the biggest impact on the perception of snappiness. For other webpages, the biggest impact on snappiness may result from a set of medium sized painted content rectangles, etc. As will be understood, in many scenarios, the first painted content rectangle (e.g., the one a user sees first on a webpage) is generally important with respect to perceived snappiness of the webpage.

In embodiments, component 1732 may craft/generate experiments, e.g., hint set variants, in a from-least-aggressive-to-most-aggressive order. In embodiments, aggressiveness may be based on when resources are specified to be preloaded, preconnected, and/or when to inject hints, e.g., early or with the webpage root. A non-limiting example of an aggressive hint set may be to preload all required resources early (HTTP 103), whereas a non-limiting example of a less aggressive hint set might be to preconnect to required resources late (HTTP 200). A non-limiting example of a hint set falling in between the previous two (with respect to aggressiveness) may be to preload required image resources early (HTTP 103) and preload non-image resources late (HTTP 200), etc. In embodiments, component 1732 may vary the experiments by adjusting whether rotating images and/or dynamic content rectangles are preconnected or overfetched.

In embodiments, component 1732 may perform one or more baseline visits/loadings of the webpage to generate a baseline snappiness value, e.g., how long does it take to load the content rectangles. In embodiments, the baseline visits may be performed with the webpage model and/or hint set as obtained by component 1730, e.g., the baseline snappiness value may be generated using the webpage model and/or hint sent before being optimized/adjusted. In embodiments, the baseline snappiness value may be generated without the use of the webpage model and/or hint set.

The process results component 1734 may evaluate the results of the experiments to determine the optimized adjustment to the webpage model and/or set of hints, e.g., which variant of the model and/or hint set is the optimal for improving webpage snappiness. In embodiments, the optimized adjustment may be the adjustment from the experiment (performed by the experiments component 1732) that results in the fastest time for an event to complete and/or other types of webpage level metrics (as disclosed herein). In embodiments, the event may be the loading and/or paint-complete event for one or more content rectangles 1610 and/or 1612 (FIG. 16). In embodiments, component 1734 generates a cumulative distribution function for each model and/or hint set variant that may provide for visual and/or programmatical comparison of the differing variants. In embodiments, the optimized webpage model and/or hint set may be determined by identifying a first-level winning variant for each of a plurality of webpage level snappiness metrics and then selecting an overall winner, from among the first-level winning variants, as the optimized variant based on a weighted sum. In embodiments, the weights of the weighted sum may be based on what particular features of the webpage matter to the webpage owner and/or customer(s).

In embodiments, the optimized webpage model and/or hint set may be deployed/transmitted to a CDN, and/or any other computing device disclosed herein, for injection into real visits to the webpage.

Subsystem 164 may also include an input to subsequent run component 1736 that takes in results from additional loadings of the webpage as part of an update to the optimized webpage model and/or set of hints.

Thus, as will be appreciated, in embodiments, the essential resource determination subsystem 162 determines the blocking resources for a particular event for the webpage, e.g., loading and/or paint-complete for content rectangles, and generates a webpage model and/or hints to improve loading of the webpage based on the knowledge of what the blocking resources are; and, the hint optimization subsystem 164 determines the optimized adjustment/format for the webpage model and/or set of hints.

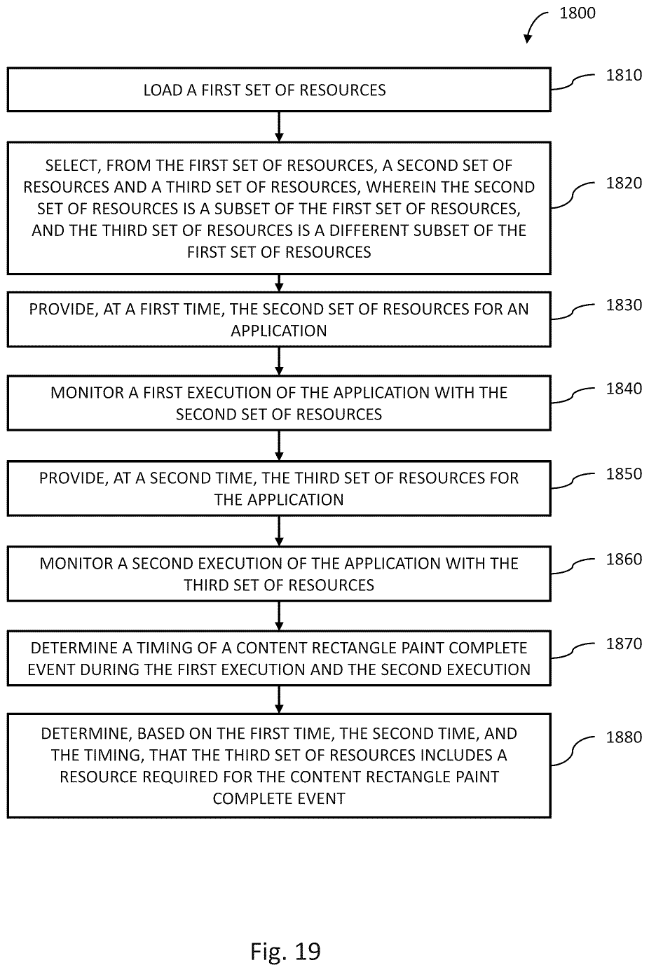

Referring to FIG. 19, a method 1800 for identifying blocking resources for loading a webpage is provided. The method 1800 may be performed via apparatus 600 (FIG. 6) using the at least one processor 610 and computer-readable instructions 614 stored in the at least one memory device 612, and/or by any other computing device disclosed herein. The method 1800 may also be performed as part of the essential resource determination subsystem 162 (FIG. 17).

Accordingly, the method 1800 may include loading a first set of resources 1810, e.g., for a webpage; and selecting, from the first set of resources, a second set of resources and a third set of resources 1820. In such embodiments, the second set of resources may be a subset of the first set of resources, and the third set of resources may be a different subset of the first set of resources. For example, in embodiments, the first set of resources may be known resources for the webpage (or for a set of content rectangles for the webpage), where the second set of resources are resources that are not to be delayed (as part of identifying blocking resources), and the third set of resources are those resources that are to be delayed (as part of identifying blocking resources). In embodiments, the second and/or third set of resources may include a single resource or multiple resources. In embodiments, the third set of resources may comprise a series of delays, e.g., a sequence of delays, where different resources within the third set are released/allowed to load at different times. For example, the delays may be on a per-resource basis, e.g., each resource in the third set gets its own delay. In embodiments, groups of resources may share a delay. In embodiments, the different times for the delays and/or groupings of resources may be based on known relationships between the resources, e.g., a first resources in the third set may be delayed based on a dependency on a second resource in the third set. Embodiments of the current disclosure may also base the delaying of resources on a brute force approach, e.g., the full (or nearly full) set of resource groupings and delay combinations may be tried. Embodiments of the current disclosure may observe random delays, e.g., non-injected delays, also referred to herein as “natural” delays. For example, embodiments of the current disclosure may observe a plurality of page visits (which may be real user monitoring (RUM) data), where blocking resources can be inferred based on detected delays in content-rectangle paint-events. In embodiments, natural delays generated by different user devices, e.g., smart phones, laptops, and/or other types of devices that display webpages, may be analyzed, e.g., compared, to detect blocking resources. For example, an older laptop, e.g., a five (5) year old laptop, may be slower in painting certain content rectangles as compared to a newer, e.g., less than 2 year old smartphone, and, as such, generate delays that can be used to detect blocking resources.

As will be understood, the delay(s), e.g., the execution of the delay(s), as disclosed herein, of the resources may be injected/caused/implemented/generated in one or more different ways. For example, in embodiments, the delay(s) may be caused within a web browser, at a proxy server, at an origin server, at a CDN server, at a hint service server (also referred to herein as a hint server), and/or at any other computing device disclosed herein. Delay(s) within the web browser may be generated by delaying, for the corresponding resource(s), one or more of the retrieval, rendering, and/or other processes performed via the web browser for displaying the resource(s) on the webpage. Delay(s) within the web browser may be generated by injecting instructions via a command line interface and/or by modifying the web browser itself. In embodiments, a script may be injected into the web browser to generate delays. In embodiments, delays generated by the web browser may be implemented by delaying a resource request and/or processing of a received resource.

As will be appreciated, the web browser may be limited in the number of external connections it can maintain at any given time, thus, embodiments of the current disclosure may modify the web browser to support additional external connections and/or perform processes that simulate an increased number of external connections with respect to any limits the web browser may have. Embodiments of the current disclosure may also detect false-positive blocking resources due to a web browser's limitations. For example, a web browser may be limited to having six (6) external connections to domain X, where embodiments of the current disclosure may be able to determine that a resource, located at domain X, that appears to be blocked by another resource is being blocked because there are no more available external connections to domain X for the web browser, as opposed to the resource being dependent on the another resource.

The method 1800 further includes providing, at a first time, the second set of resources for an application 1830, and monitoring a first execution of the application with the second set of resources 1840. The method 1800 further includes providing, at a second time, e.g., after a delay with respect to the first time, the third set of resources for the application 1850; monitoring a second execution of the application with the third set of resources 1860; and determining a timing of a content rectangle paint complete event during the first execution and the second execution 1870. The content rectangle complete-event may be for when a single content rectangle completes painting or for when a set of content rectangles have, collectively, finished painting. The method 1800 further includes determining, based on the first time, the second time, and the timing, that the third set of resources includes a resource required for the content rectangle paint complete event 1880. For example, where one or more content rectangles do not complete until after the third set of resources have been provided to the application, it may be inferred that the third set of resources includes blocking resources. Embodiments of the current disclosure may determine the timing of the content rectangle complete-event with respect to all of the content rectangles (collectively) after each delay. Embodiments of the current disclosure may determine one or more timings for one or more content rectangle complete-events corresponding to one or more content rectangles (and/or groups of content rectangles) after each delay. In other words, embodiments of the current disclosure may check to see which content rectangles were painted after a delay and at which time they completed painting. In embodiments, each delay (and associated resource(s)), or groups of delays (and associated resources), may be performed during different loading of the webpage. As will be understood, however, embodiments of the current disclosure may perform multiple delays during a single loading of the webpage. Embodiments of the current disclosure may test the full set (or a subset set) of combinations of delays and resources for the third set of resources, e.g., a brute force approach, to determine/detect/identify blocking relationships between the resources in the first set. As such, embodiments of the current disclosure provide for the ability to determine if any one delayed resource (or group of resources) results in the delay in the painting of any other resource.

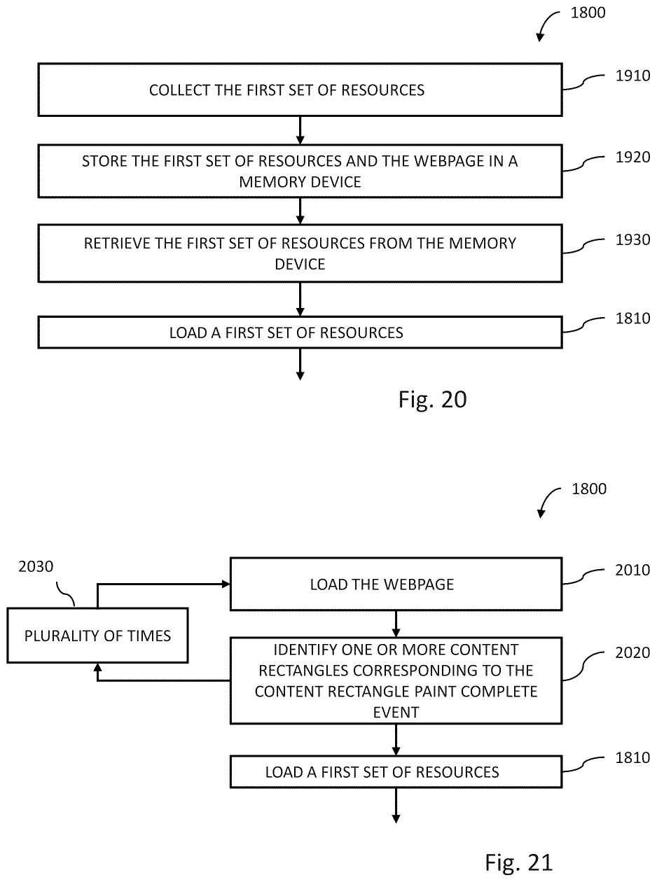

Referring to FIG. 20, certain further aspects of the method 1800 are described following, any one or more of which may be present in certain embodiments. For example, in embodiments, the application may be a webpage browser. In such embodiments, the first set of resources may be for a webpage, and the method 1800 may further include collecting the first set of resources 1910; storing the first set of resources and the webpage in a memory device 1920, e.g., the at least one memory device 612 (FIG. 6); and retrieving the first set of resources from the memory device 1930.

As shown in FIG. 21, in embodiments where the first set of resources may be for a webpage, the method 1800 may further include loading the webpage 2010; and in response to loading the webpage, identifying one or more content rectangles corresponding to the content rectangle paint complete event 2020. The method 1800 may further include loading the webpage for a plurality of times, as represented by box 2030; and in response to the plurality of loadings of the webpage, identifying one or more content rectangles, corresponding to the content rectangle paint complete event, as persistent, e.g., 1610 (FIG. 16), across the plurality of loadings.

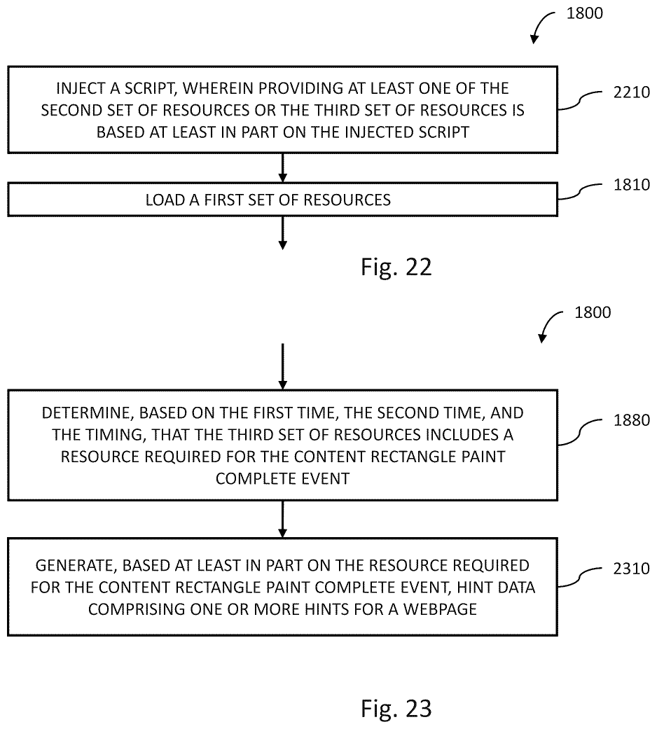

As illustrated in FIG. 22, the method 1800 may further include injecting a script 2210. The script may be injected into a client device, e.g., a user's computer, cell phone, and/or any other device that supports a web browser. In such embodiments, providing at least one of the second set of resources or the third set of resources may be based at least in part on the injected script. In embodiments, the injected script may generate the delay via inserting one or more commands via a command line interface.

As illustrated in FIG. 23, the method 1800 may further include generating, based at least in part on a resource required for a content rectangle paint complete event, hint data comprising one or more hints for a webpage 2310. As disclosed herein, non-limiting examples of hints include identifying resources as preconnect, preload, and/or URLs and/or addresses for obtaining the resources.

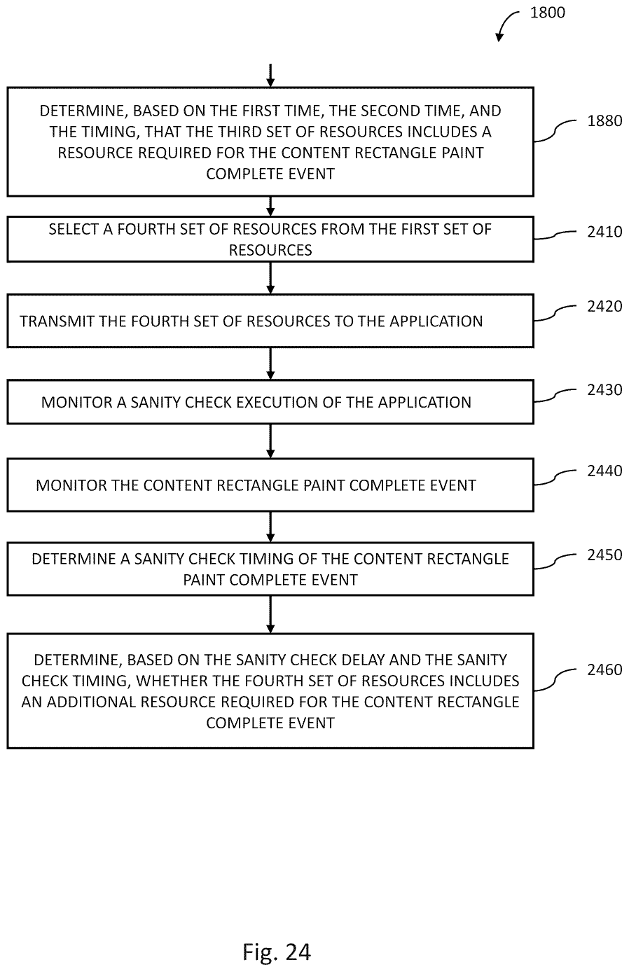

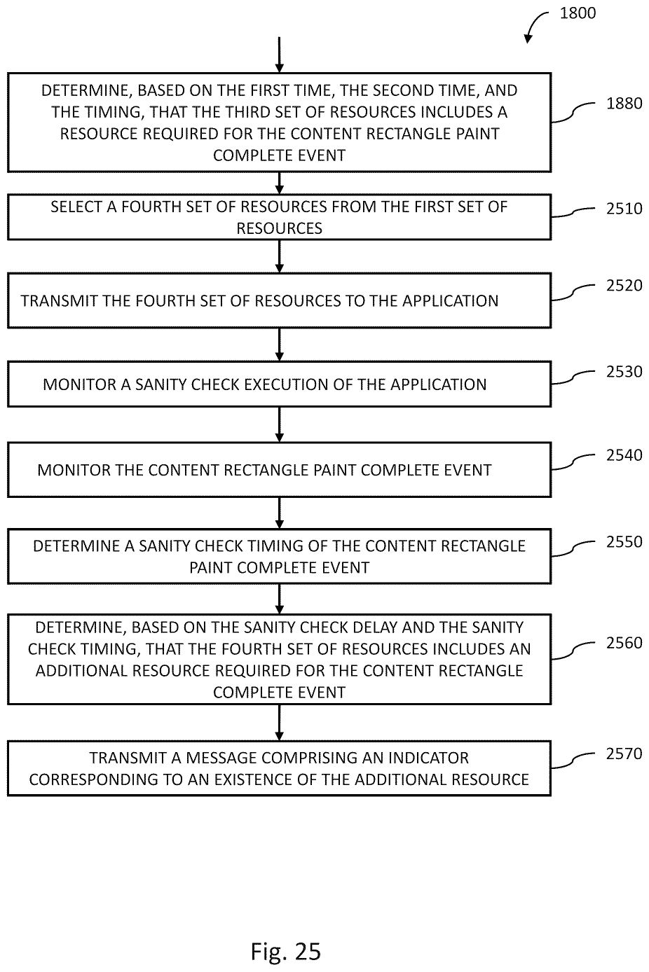

As illustrated in FIGS. 24 and 25, the method 1800 may further include aspects for performing sanity checks, e.g., components 1720 and 1722 (FIG. 17). As such, and as shown in FIG. 24, the method 1800 may include selecting a fourth set of resources from the first set of resources 2410, where the fourth set of resources may be distinct from the third set of resources, e.g., the fourth set of resources may be resources not-identified as blocking resources. In such embodiments, the method 1800 may include transmitting the fourth set of resources to the application 2420. In embodiments, the fourth set of resources may be transmitted after a sanity check delay, as disclosed herein, and the method 1800 may further include monitoring a sanity check execution of the application 2430; monitoring the content rectangle paint complete event 2440; determining a sanity check timing of the content rectangle paint complete event 2450; and determining, based on the sanity check delay and the sanity check timing, whether the fourth set of resources includes an additional resource required for the content rectangle complete event 2460. As discussed herein, the sanity check may pass if the content rectangles load within the expected timeframe when delaying the set of resources believed to not be blocking resources. In embodiments, the fourth set of resources may include grouped resources and/or the sanity check may include one or more delays, as disclosed herein. For example, in embodiments, the resources in the fourth set may be delayed one at a time. In embodiments, the resources in the fourth set may be delayed in one or more groupings, where each grouping is released at a different time, as disclosed herein.

As shown in FIG. 25, the method 1800 may further include selecting a fourth set of resources from the first set of resources 2510, wherein the fourth set of resources may be distinct from the third set of resources; and transmitting the fourth set of resources to the application 2520. In such embodiments, the fourth set of resources may be transmitted after a sanity check delay (as disclosed herein), and the method 1800 may further include monitoring a sanity check execution of the application 2530; monitoring the content rectangle paint complete event 2540; and determining a sanity check timing of the content rectangle paint complete event 2550. The method 1800 may include determining, based on the sanity check delay and the sanity check timing, that the fourth set of resources may include an additional resource required for the content rectangle complete event 2560; and transmitting a message including an indicator corresponding to an existence of the additional resource 2570. As discussed herein, the sanity check may fail if the content rectangles do not load within the expected timeframe when delaying the set of resources believed to not be blocking resources.

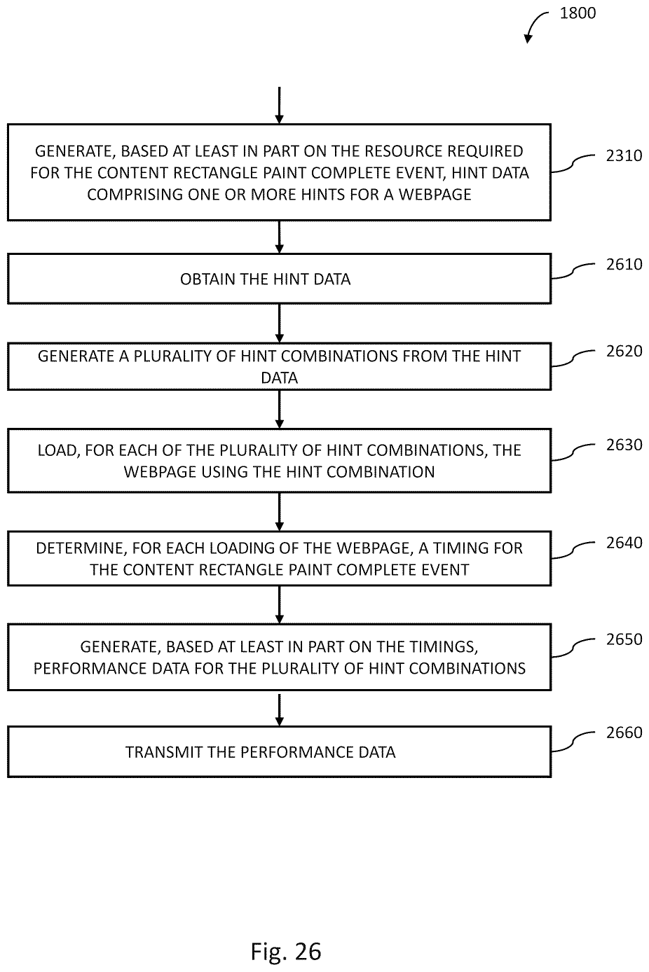

As shown in FIG. 26, the method 1800 may include aspects performed by the hint optimization subsystem 164 (FIG. 18). As such, the method 1800 may further include obtaining the hint data 2610; generating a plurality of hint combinations from the hint data 2620; loading, for each of the plurality of hint combinations, the webpage using the hint combination 2630; and determining, for each loading of the webpage, a timing for the content rectangle paint complete event 2640. The method 1800 may further include generating, based at least in part on the timings 2650, performance data for the plurality of hint combinations; and transmitting the performance data 2660. In other words, embodiments of the method 1800 may run a series of experiments on a hint set or webpage model, as disclosed herein, to determine an optimized configuration from within a set of possible combinations/configurations.

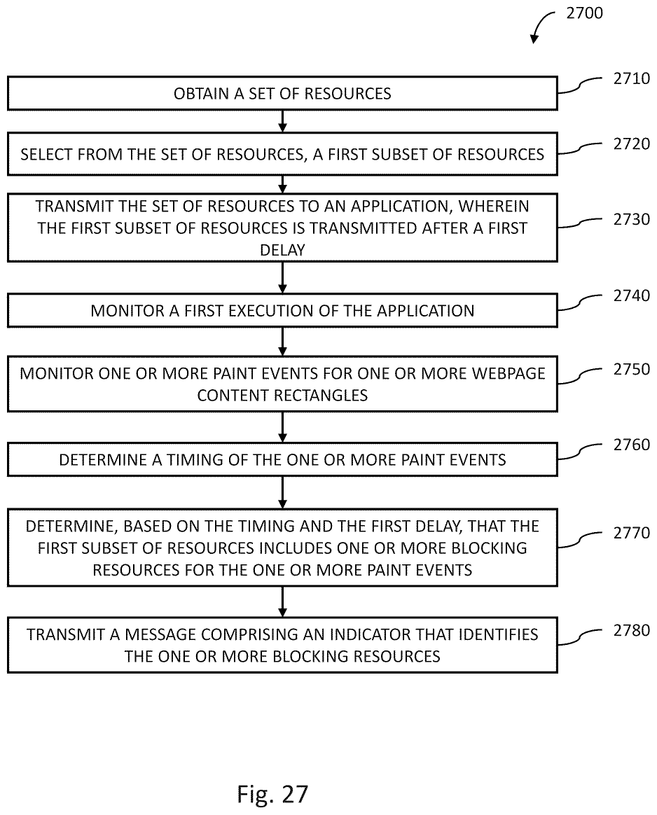

Referring to FIG. 27, a method 2700 for determining blocking resources is provided. The method 2700 may be performed by the at least one processor 612 via the computer-readable instructions stored in the at least one memory device 612 of apparatus 600 and/or by any other computing device disclosed herein. The method may include, obtaining a set of resources 2710; selecting from the set of resources, a first subset of resources 2720; and transmitting the set of resources to an application 2730. The first subset of resources may be transmitted after a first delay; and the method 2700 may include monitoring a first execution of the application 2740; monitoring one or more paint events for one or more webpage content rectangles 2750; and determining a timing of the one or more paint events 2760. The method 2700 may further include determining, based on the timing and the first delay, that the first subset of resources includes one or more blocking resources for the one or more paint events 2770; and transmitting a message including an indicator that identifies the one or more blocking resources 2780.

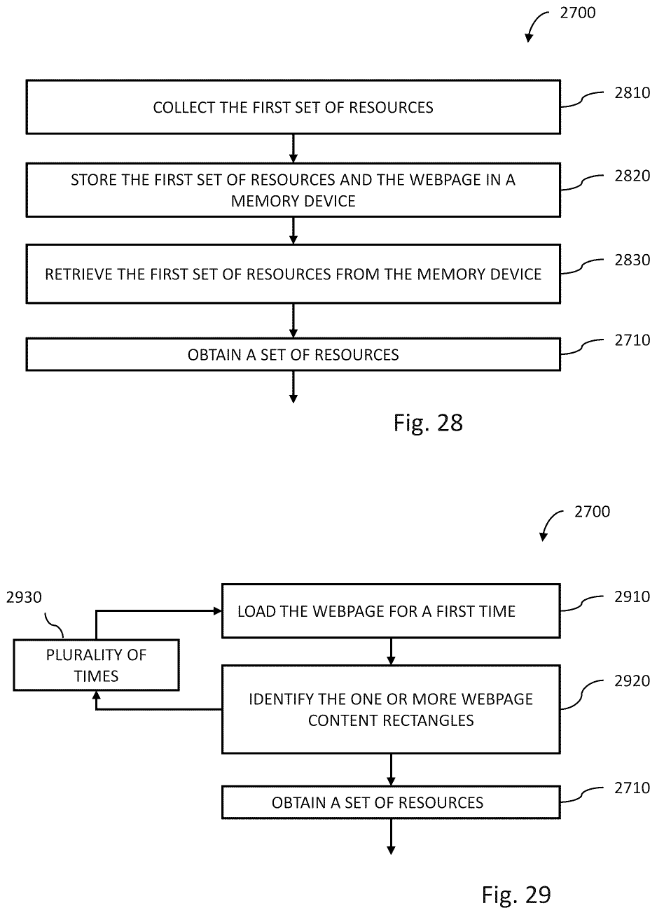

Certain further aspects of method 2700 are described following, any one or more of which may be present in certain embodiments. As shown in FIG. 28, the application may be a webpage browser and the set of resources may be for a webpage. In such embodiments, the method 2700 may further include collecting the set of resources 2810; storing the set of resources and the webpage in a memory device 2820; and retrieving the set of resources from the memory device 2830.

Referring to FIG. 29, the set of resources may be for a webpage; and the method 2700 may further include loading the webpage for a first time 2910; and in response to loading the webpage the first time, identifying the one or more webpage content rectangles 2920. In other words, embodiments of method 2700 may include processes for discovering what resources are associated with a webpage. The method 2700 may further include loading the webpage for a plurality of times, as represented by box 2930. The method 2700 may further include, in response to the plurality of loadings of the webpage, identifying the one or more webpage content rectangles as persistent across the plurality of loadings, e.g., box 2930. As will be understood, in embodiments, persistent content rectangles may be those content rectangles that are the same and/or similar across 75%, 80%, 85%, 90%, 95% or more, e.g., 100%, of the loadings of a webpage. Content rectangles may be considered similar when they share a large number of features, e.g., graphical content, but vary by dimensions, local/relative position, and/or absolute position within threshold amounts, e.g., one, two, three, four, five, . . . ten, . . . a hundred, etc., pixels. For example, content rectangles may be considered similar when they show the same general content but vary in dimensions, local/relative position, and/or absolute position due to viewport differences across differing devices. In embodiments, content rectangles may be identified as persistent or dynamic based at least in part on the corresponding document object model(s) (DOM(s)). In embodiments, content rectangles that share a relation, e.g., shared dependencies, may be grouped, where such groups may be treated as a single content rectangle.

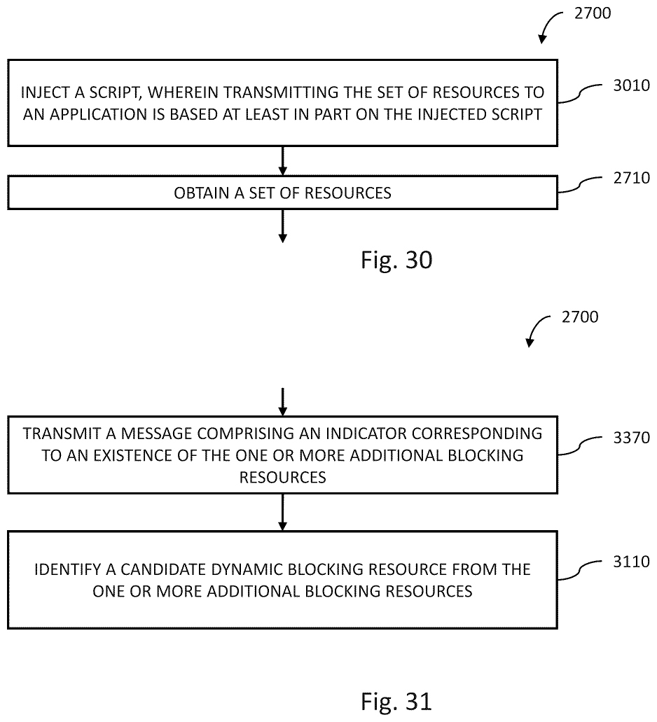

With reference to FIG. 30, the method 2700 may further include injecting a script 3010, e.g., into a user device, as disclosed herein. In such embodiments, transmitting the set of resources to an application may be based at least in part on the injected script.

As shown in FIG. 31, in embodiments, the method 2700 may further include identifying a candidate dynamic blocking resource from the one or more additional blocking resources 3110. The candidate dynamic blocking resource may be based at least in part on a templated universal resource locator; an A/B pattern; or an A/none pattern.

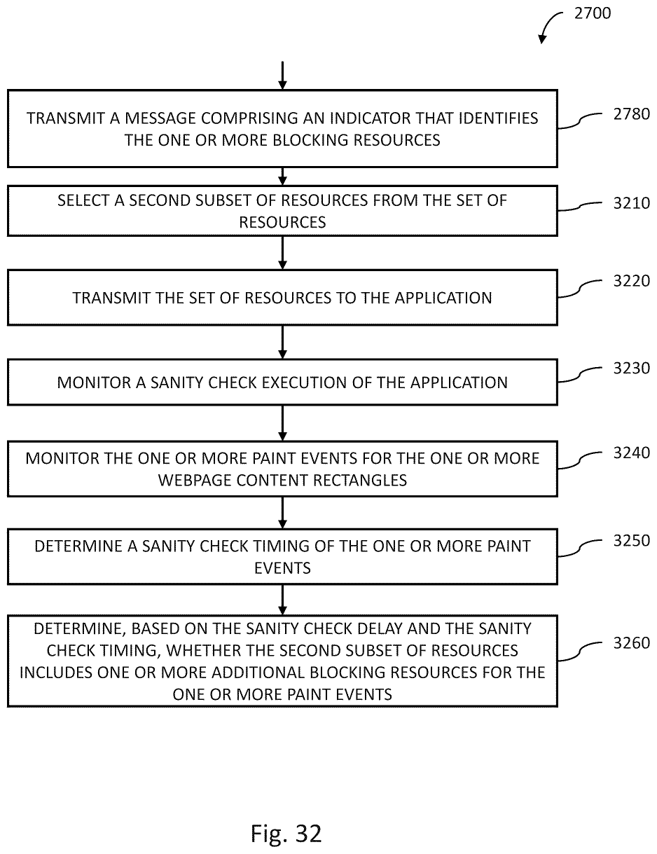

Referring to FIG. 32, the method 2700 may include aspects of components 1714, 1716, 1718, 1720, and/or 1722 (FIG. 17). For example, the method 2700 may further include selecting a second subset of resources from the set of resources 3210, wherein the second subset of resources may be distinct from the one or more blocking resources; transmitting the set of resources to the application 3220, wherein the second subset of resources may be transmitted after a sanity check delay; monitoring a sanity check execution of the application 3230; monitoring the one or more paint events for the one or more webpage content rectangles 3240; determining a sanity check timing of the one or more paint events 3250; and determining, based on the sanity check delay and the sanity check timing 3260, whether the second subset of resources may include one or more additional blocking resources for the one or more paint events.

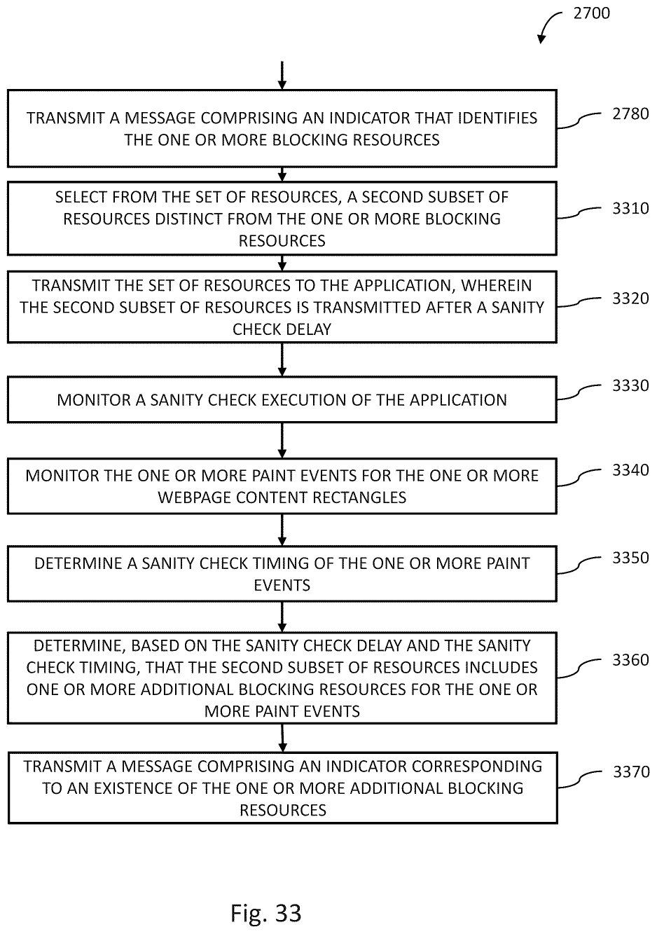

Referring to FIG. 33, the method 2700 may further include selecting from the set of resources, a second subset of resources distinct from the one or more blocking resources 3310; transmitting the set of resources to the application, wherein the second subset of resources may be transmitted after a sanity check delay 3320; monitoring a sanity check execution of the application 3330; monitoring the one or more paint events for the one or more webpage content rectangles 3340; determining a sanity check timing of the one or more paint events 3350; determining, based on the sanity check delay and the sanity check timing 3360, that the second subset of resources may include one or more additional blocking resources for the one or more paint events; and transmitting a message including an indicator corresponding to an existence of the one or more additional blocking resources 3370.

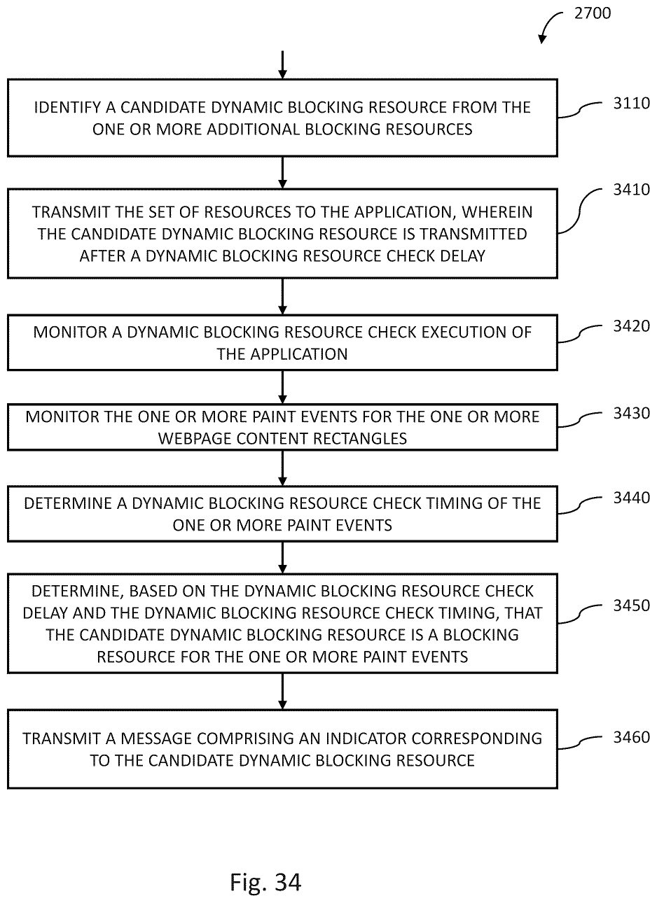

Referring to FIG. 34, the method 2700 may further include transmitting the set of resources to the application 3410, wherein the candidate dynamic blocking resource may be transmitted after a dynamic blocking resource check delay; monitoring a dynamic blocking resource check execution of the application 3420; monitoring the one or more paint events for the one or more webpage content rectangles 3430; determining a dynamic blocking resource check timing of the one or more paint events 3440; determining, based on the dynamic blocking resource check delay and the dynamic blocking resource check timing, that the candidate dynamic blocking resource may be a blocking resource for the one or more paint events 3450; and transmitting a message including an indicator corresponding to the candidate dynamic blocking resource 3460.

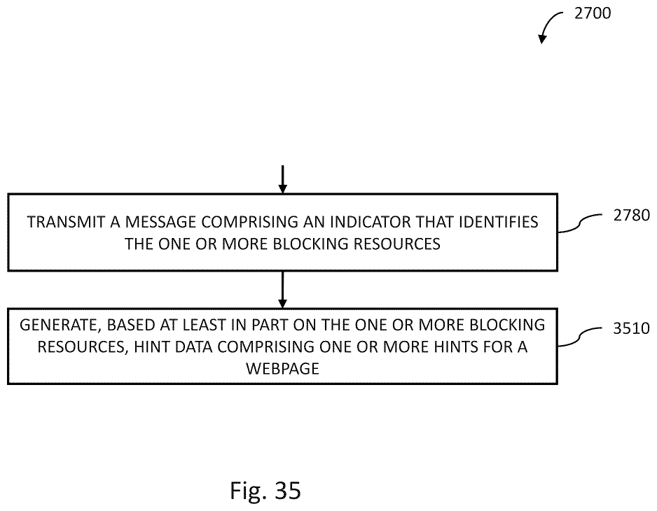

Referring to FIG. 35, the method 2700 may further include generating, based at least in part on the one or more blocking resources, hint data including one or more hints for a webpage 3510.

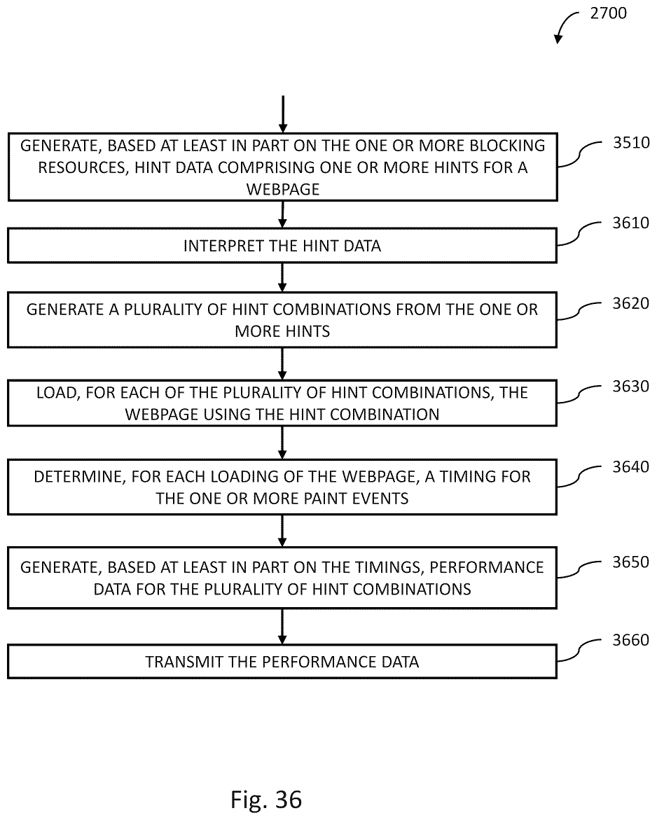

As shown in FIG. 36, the method 2700 may include aspects of components 1730, 1732, 1734, and/or 1736 (FIG. 18). For example, the method 2700 may further include interpreting the hint data 3610; generating a plurality of hint combinations from the one or more hints 3620; loading, for each of the plurality of hint combinations, the webpage using the hint combination 3630; determining, for each loading of the webpage, a timing for the one or more paint events 3640; generating, based at least in part on the timings, performance data for the plurality of hint combinations 3650; and transmitting the performance data 3660.

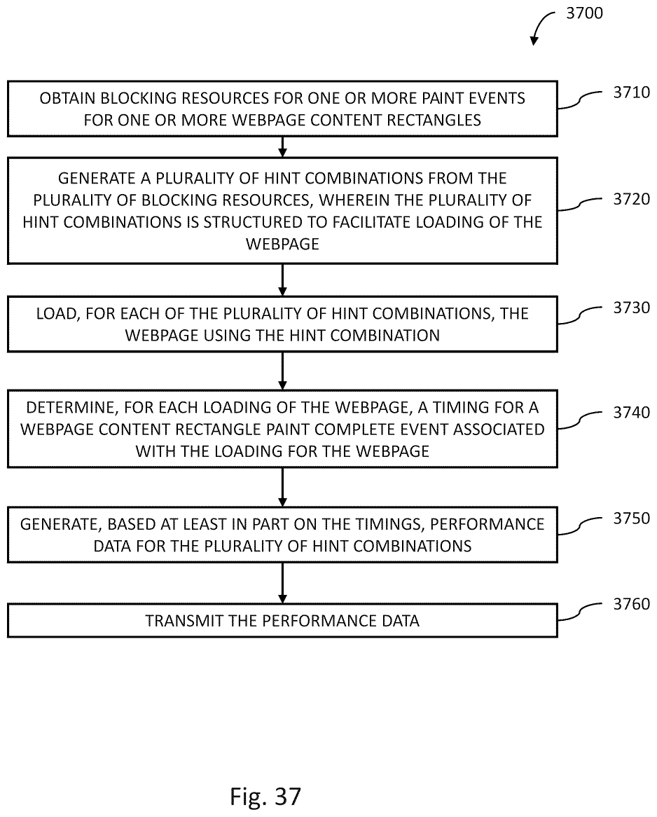

Referring to FIG. 37, a method 3700 for optimizing the loading of a webpage is provided. The method 3700 may be performed by the at least one processor 610 via the computer-readable instructions 614 stored in memory device 612 of apparatus 600 (FIG. 6), and/or by any other computing device disclosed herein. The method 3700 may include: obtaining blocking resources for one or more paint events for one or more webpage content rectangles 3710; generating a plurality of hint combinations from the plurality of blocking resources 3720, wherein the plurality of hint combinations is structured to facilitate loading of the webpage; loading, for each of the plurality of hint combinations, the webpage using the hint combination 3730; determining, for each loading of the webpage, a timing for a webpage content rectangle paint complete event associated with the loading for the webpage 3740; generating, based at least in part on the timings, performance data for the plurality of hint combinations 3750; and transmitting the performance data 3760.

Certain further aspects of method 3700 are described following, any one or more of which may be present in certain embodiments. For example, in embodiments, the plurality of hint combinations may include information for locating one or more resources used to load the webpage. In embodiments, the plurality of hint combinations may include one or more child universal resource locators (URLs). The one or more resources may be elements rendered on the webpage, e.g., graphics. In embodiments, the plurality of hint combinations may include at least one of a preconnnect hint; a preload hint; or a priority hint. The plurality of hint combinations may include at least one early hint. The plurality of hint combinations may include at least one late hint.

The performance data may include data associated with and/or descriptive of the loadings of the webpage. For example, in embodiments, the performance data may include one or more of the timings and/or one or more of the plurality of hint combinations. The performance data may associate each of the one or more timings to one of the plurality of hint combinations. At least one of the plurality of hint combinations may include an ordered set of hints, e.g., the order in which the hints are to be performed as part of loading the webpage by a client-computing device. The ordered set of hints may be based at least in part on a prefetching priority. The ordered set of hints may be based at least in part on a network resource. The ordered set of hints may be based at least in part on an expected bandwidth of at least one network connection. The ordered set of hints may be based at least in part on a compute resource. The ordered set of hints may be based at least in part on an available memory.

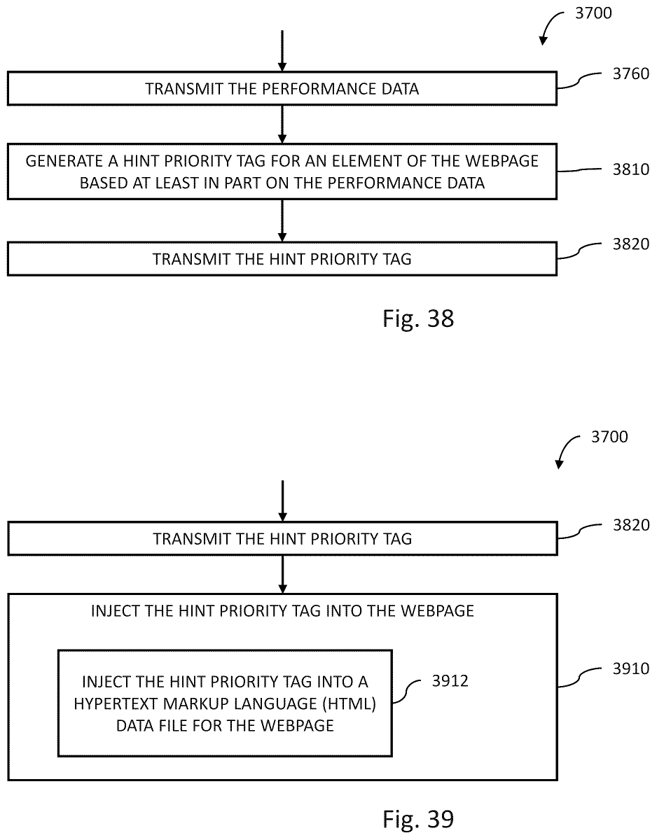

Referring to FIG. 38, the method 3700 may further include generating a hint priority tag for an element of the webpage based at least in part on the performance data 3810; and transmitting the hint priority tag 3820.

Referring to FIG. 39, the method 3700 may further include injecting the hint priority tag into the webpage 3910. In embodiments, injecting the hint priority tag may include injecting the hint priority tag into a HyperText Markup Language (HTML) data file for the webpage 3912.

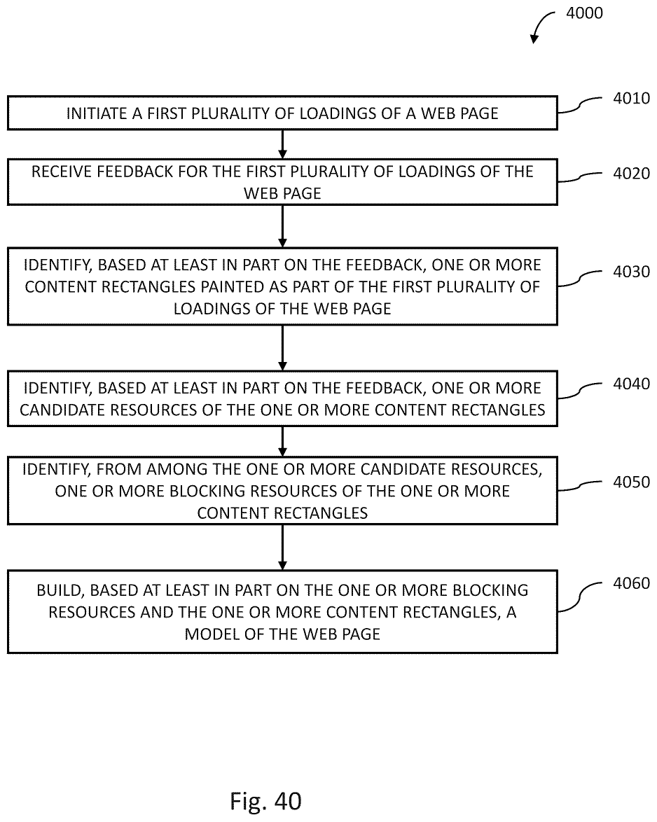

Referring to FIG. 40, a method 4000 of identifying blocking resources of a webpage may be provided. The method 4000 may be performed by the at least one processor 610 via the computer-readable instructions 614 stored in the at least one memory device 612 of apparatus 600 (FIG. 6), and/or by any other computing device disclosed herein. The method 4000 may include initiating a first plurality of loadings of a webpage 4010; receiving feedback for the first plurality of loadings of the webpage 4020; identifying, based at least in part on the feedback, one or more content rectangles painted as part of the first plurality of loadings of the webpage 4030; identifying, based at least in part on the feedback, one or more candidate resources of the one or more content rectangles 4040; identifying, from among the one or more candidate resources, one or more blocking resources of the one or more content rectangles 4050; and building, based at least in part on the one or more blocking resources and the one or more content rectangles, a model of the webpage 4060.

Certain further aspects of method 4000 are described following, any one or more of which may be present in certain embodiments. In embodiments, the feedback may include a first time-to-paint value for the painting of at least one of the one or more content rectangles.

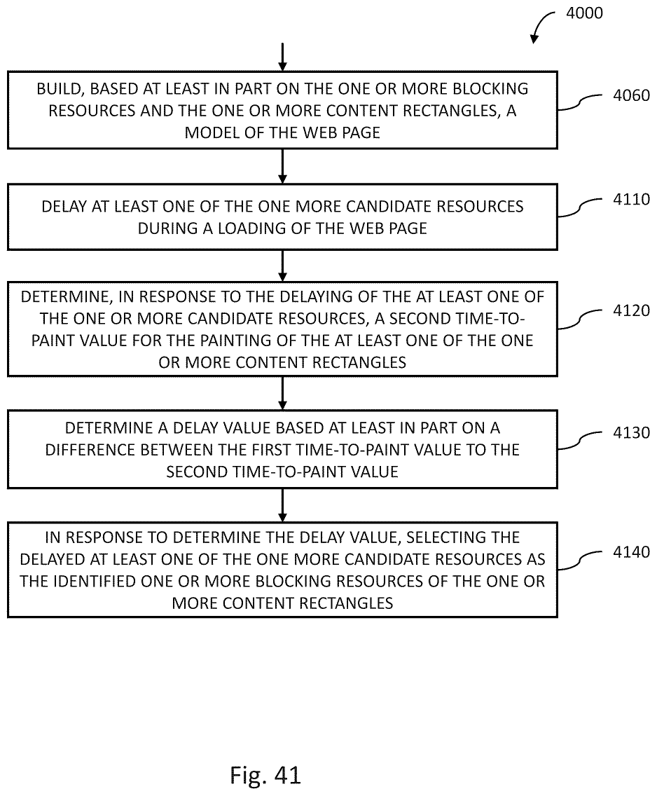

Referring to FIG. 41, identifying the one or more blocking resources of the one or more content rectangles may include delaying at least one of the one more candidate resources during a loading of the webpage 4110; determining, in response to the delaying of the at least one of the one or more candidate resources, a second time-to-paint value for the painting of the at least one of the one or more content rectangles 4120; determining a delay value based at least in part on a difference between the first time-to-paint value to the second time-to-paint value 4130; and in response to determining the delay value, selecting the delayed at least one of the one more candidate resources as the identified one or more blocking resources of the one or more content rectangles 4140.

Identifying, from among the one or more candidate resources, one or more blocking resources of the one or more content rectangles may be performed, in part, in at least one processor, e.g., 610 (FIG. 6) of a server, e.g., 110, 112, 114, 116, and/or 120 (FIG. 1) and/or any other computing device disclosed herein. Identifying, from among the one or more candidate resources, one or more blocking resources of the one or more content rectangles may be performed, in part, in at least one processor of a client device, e.g., 126, 122, and/or 134 (FIG. 1) and/or any other computing device disclosed herein. Identifying, from among the one or more candidate resources, one or more blocking resources of the one or more content rectangles may be performed, in part, by a web browser application executing on the at least one processor of the client device, e.g., 126, 122, and/or 134 (FIG. 1) and/or any other computing device disclosed herein. The one or more content rectangles identified based at least in part on the feedback may be persistent content rectangles painted in at least 75% of the first plurality of loadings of the webpage. The persistent content rectangles may be painted in all of the first plurality of loadings of the webpage.

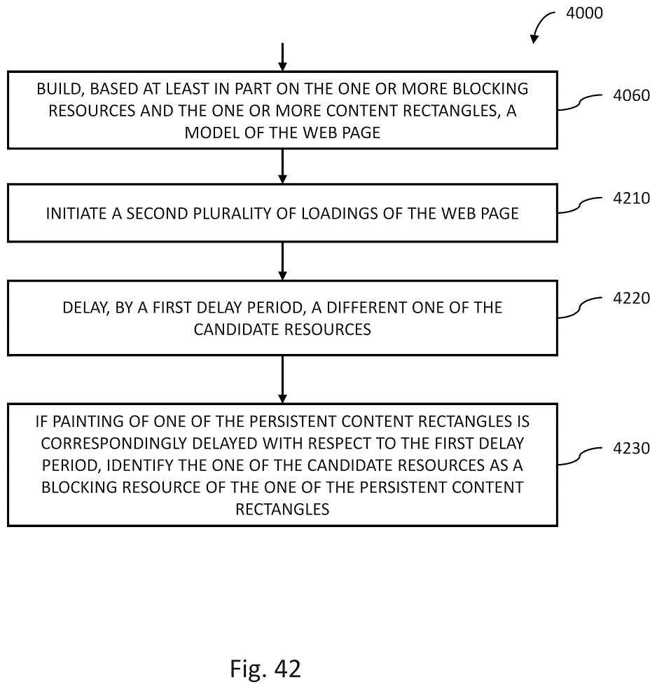

Referring to FIG. 42, identifying the blocking resources of the content rectangles may include initiating a second plurality of loadings of the webpage 4210; and for each time the webpage is loaded during the second plurality of loadings: delaying, by a first delay period, a different one of the candidate resources 4220; and if painting of one of the persistent content rectangles is correspondingly delayed with respect to the first delay period, identifying the one of the candidate resources as a blocking resource of the one of the persistent content rectangles 4230. The first delay period may be at least two times greater than a time to paint the one of the persistent content rectangles.

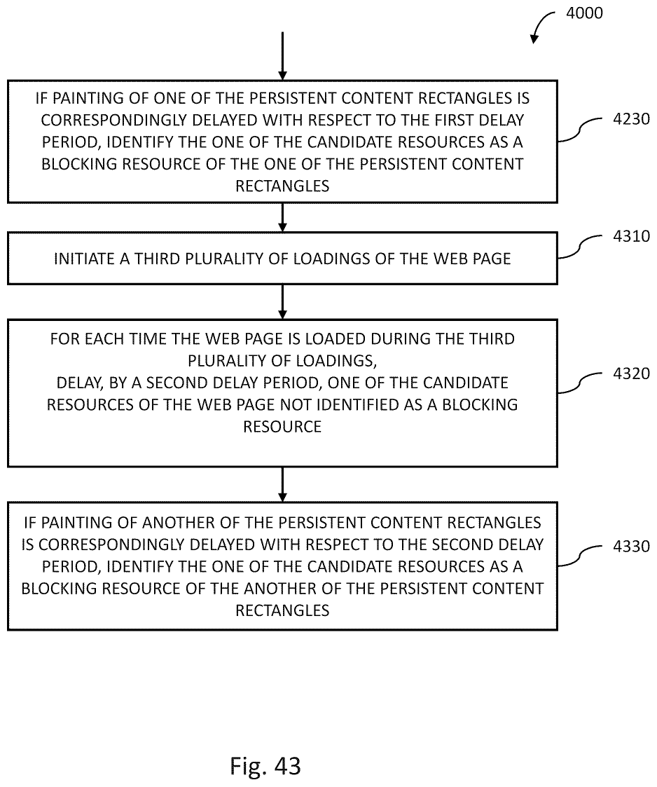

Referring to FIG. 43, the method 4000 may further include initiating a third plurality of loadings of the webpage 4310, and for each time the webpage is loaded during the third plurality of loadings: delaying, by a second delay period, one of the candidate resources of the webpage not identified as a blocking resource 4320, and if painting of another of the persistent content rectangles is correspondingly delayed with respect to the second delay period, identifying the one of the candidate resources as a blocking resource of the another of the persistent content rectangles 4330.

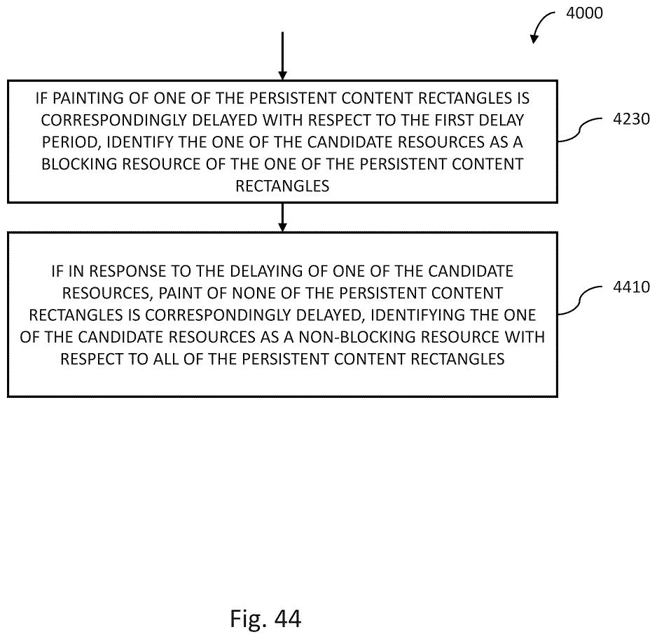

Referring to FIG. 44, embodiments of the current disclosure may perform an alternative form of a sanity check, e.g., identifying a delayed candidate resources as a non-blocking resource when delaying the candidate resource does not delay painting of the content rectangles. For example, the method 4000 may include, if in response to the delaying of one of the candidate resources, painting of none of the persistent content rectangles is correspondingly delayed, identifying the one of the candidate resources as a non-blocking resource with respect to all of the persistent content rectangles 4410. The one or more content rectangles may form part of a main content area of the webpage.

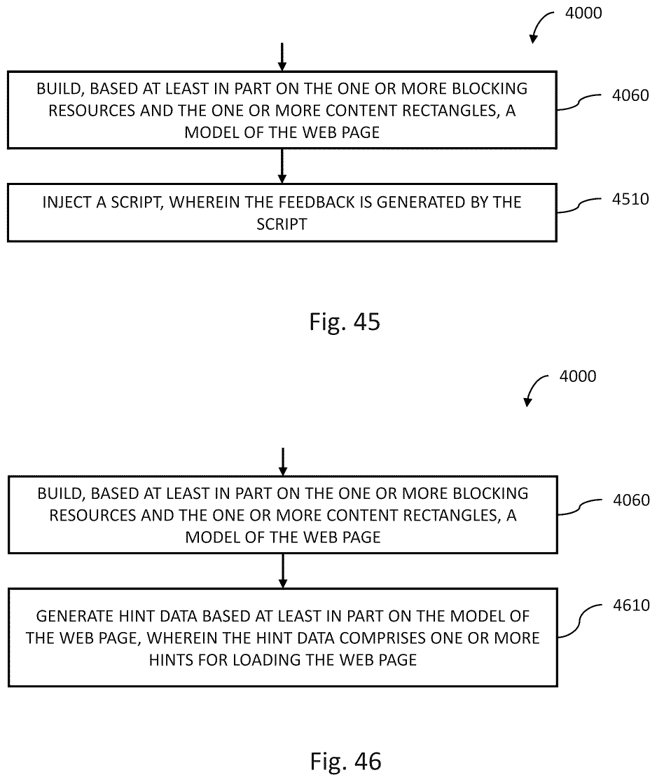

Referring to FIG. 45, the method 4000 may further include injecting a script, wherein the feedback is generated by the script 4510. The script may be injected into a web browser application executing on a client computing device.

Referring to FIG. 46, the method 4000 may further include generating hint data based at least in part on the model of the webpage, wherein the hint data includes one or more hints for loading the webpage 4610.

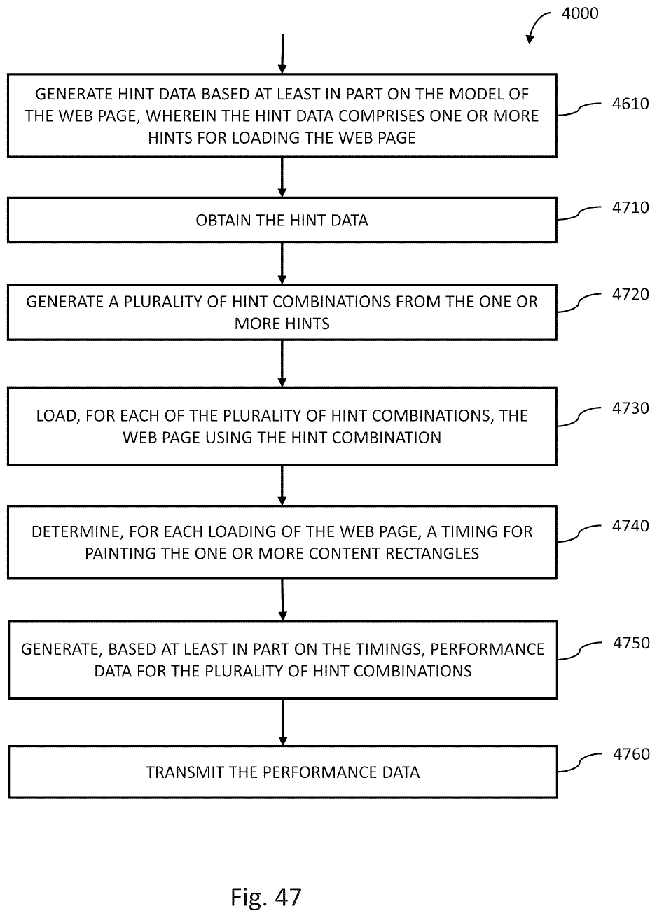

Referring to FIG. 47, the method 4000 may further include obtaining the hint data 4710; generating a plurality of hint combinations from the one or more hints 4720; loading, for each of the plurality of hint combinations, the webpage using the hint combination 4730; determining, for each loading of the webpage, a timing for painting the one or more content rectangles 4740; generating, based at least in part on the timings, performance data for the plurality of hint combinations 4750; and transmitting the performance data 4760.

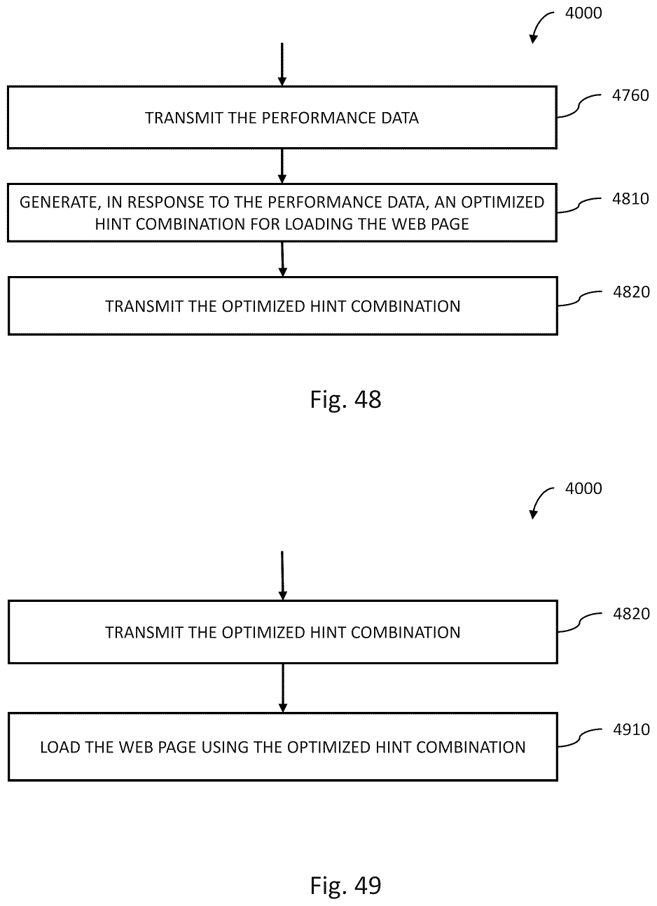

Referring to FIG. 48, the method 4000 may further include generating, in response to the performance data, an optimized hint combination for loading the webpage 4810; and transmitting the optimized hint combination 4820.

Referring to FIG. 49, the method 4000 may further include loading the webpage using the optimized hint combination 4910.

As disclosed herein, one or more embodiments of the current disclosure may be performed on and/or by computing devices, e.g., 600 (FIG. 6). Accordingly, an example embodiment includes a non-transitory computer-readable medium storing instructions that, when loaded into at least one processor, may cause at least one processor to: interpret hint data defining a plurality of hints structured to facilitate loading of a webpage. Further, the non-transitory computer-readable medium may generate a plurality of hint combinations from the plurality of hints and loads, for each of the plurality of hint combinations, the webpage using the hint combination. Also, the medium may determine, for each loading of the webpage, a timing for an event associated with the loading for the webpage and select a hint combination from the plurality of hint combinations based at least in part on the timings. Lastly, the medium may transmit the selected hint combination.

Further non-limiting example embodiments are provided herein. For example, in an example embodiment of the non-transitory computer-readable medium, the stored instructions may further cause at least one processor to generate the plurality of hint combinations based at least in part on an expected network resource associated with the plurality of hints.

In an example embodiment of the non-transitory computer-readable medium, the expected network resource may be based at least in part on at least one of a bandwidth, a latency, or a cost.

In an example embodiment of the non-transitory computer-readable medium, the stored instructions may be further structured to generate the plurality of hint combinations based at least in part on an expected compute resource associated with the plurality of hints.

In an example embodiment of the non-transitory computer-readable medium, the expected compute resource is based at least in part on at least one of a cache or a processing capability.

Embodiments disclosed herein further include systems and methods for mapping results from exhaustive hint testing into actionable rules. After testing various hint combinations in a simulated environment to identify those that optimize/improve page load performance, these optimized configurations are distilled into rules. These rules allow the browser or optimization system to apply only the most effective hints for each unique page type or URL. This simplification not only streamlines the decision-making process but also provides that optimized hints are applied in real-world scenarios without requiring extensive computational resources to re-evaluate all hint combinations.

To facilitate this process, a binary tree structure is utilized, which enables rapid determination of the optimized hint combination based on specific page characteristics, such as the page type or URL pattern. By organizing the hint selection process within a binary tree, the system can quickly navigate through potential hint configurations, selecting the most effective set for a given page structure or user scenario.

In some instances, a webpage may include hints that conflict with the optimized set of hints determined by the embodiments described herein. In some cases, developers may include hints in webpages with HTML tags, HTTP headers, and JavaScript to provide browsers with instructions on how to handle specific resources during page load. Developer-defined hints, while intended to accelerate page loading, can sometimes conflict with the system's optimized hint configurations. This conflict may result in redundant or suboptimal loading behaviors, as the developer-specified hints may not account for real-time conditions or specific page characteristics. By programmatically removing or modifying these developer hints, the system provides for the most effective, context-aware hints are active during a page load.

In embodiments, API calls can be used as a direct method to control the application of hints by communicating with the content delivery network (CDN) or server infrastructure. For example, API endpoints may enable the system to override hints that are already embedded in the server response. This allows the system to selectively deactivate certain hints that could otherwise slow down page loading or result in unnecessary resource consumption.

Modification of existing webpage hints may include injecting JavaScript into the page. JavaScript injections enable the system to dynamically modify or remove existing hints within the browser's document object model (DOM) and can be used when dealing with static HTML where the hints are hard-coded and cannot be altered by server-side configurations. By injecting scripts that control the application or priority of hints, the system can fine-tune resource loading at the browser level, ensuring that critical resources are prioritized according to the most current conditions and optimizations.

The system may also modify the HTML code directly, particularly for persistent hints embedded in the HTML headers or body. This method involves rewriting the HTML to remove, alter, or reprioritize certain hints before the page is fully rendered by the browser. By modifying the HTML structure, the system can remove unnecessary prefetch or preload links that might otherwise overload the network or delay other essential elements from loading.

Embodiments of the current disclosure may also include methods for identifying hints in pages, comparing the identified hints against a list of optimized hints, and generating instructions to modify the hints. The instructions can be sent to an intermediate server and/or system that facilitates loading of a webpage from a client user device by a client computing device, e.g., a CDN.

One or more certain further aspects of the example systems, apparatuses, and methods are described following, any one or more of which may be incorporated in certain embodiments.

Clause 1. A method including: loading a first set of resources; selecting, from the first set of resources, a second set of resources and a third set of resources, wherein the second set of resources is a subset of the first set of resources, and the third set of resources is a different subset of the first set of resources; providing, at a first time, the second set of resources for an application; monitoring a first execution of the application with the second set of resources; providing, at a second time, the third set of resources for the application; monitoring a second execution of the application with the third set of resources; determining a timing of a content rectangle paint complete event during the first execution and the second execution; and determining, based on the first time, the second time, and the timing, that the third set of resources includes a resource required for the content rectangle paint complete event.

Clause 2. The method of clause 1, wherein the application is a webpage browser. In such embodiments, providing, at a second time, the third set of resources for the application may include: delaying the third set of resources within the webpage browser. In such embodiments, providing, at a second time, the third set of resources for the application may include: delaying the third set of resources via at least one of: a content delivery network server; an origin server; a hint server, or a proxy server.

Clause 3. The method of clause 2, wherein: the first set of resources is for a webpage; and the method further includes: collecting the first set of resources; storing the first set of resources and the webpage in a memory device; and retrieving the first set of resources from the memory device.

Clause 4. The method of clause 2, wherein: the first set of resources is for a webpage; and the method further includes: loading the webpage; and in response to loading the webpage, identifying one or more content rectangles corresponding to the content rectangle paint complete event.

Clause 5. The method of clause 2, wherein the method further includes: loading the webpage for a plurality of times; and in response to the plurality of loadings of the webpage, identifying one or more content rectangles, corresponding to the content rectangle paint complete event, as persistent across the plurality of loadings.

Clause 6. The method of clause 1, further including: injecting a script, wherein providing at least one of the second set of resources or the third set of resources is based at least in part on the injected script.

Clause 7. The method of clause 1 further including: selecting a fourth set of resources from the first set of resources, wherein the fourth set of resources is distinct from the third set of resources; transmitting the fourth set of resources to the application, wherein the fourth set of resources is transmitted after a sanity check delay; monitoring a sanity check execution of the application; monitoring the content rectangle paint complete event; determining a sanity check timing of the content rectangle paint complete event; and determining, based on the sanity check delay and the sanity check timing, whether the fourth set of resources includes an additional resource required for the content rectangle complete event.

Clause 8. The method of clause 1 further including: selecting a fourth set of resources from the first set of resources, wherein the fourth set of resources is distinct from the third set of resources; transmitting the fourth set of resources to the application, wherein the fourth set of resources is transmitted after a sanity check delay; monitoring a sanity check execution of the application; monitoring the content rectangle paint complete event; determining a sanity check timing of the content rectangle paint complete event; determining, based on the sanity check delay and the sanity check timing, that the fourth set of resources includes an additional resource required for the content rectangle complete event; and transmitting a message including an indicator corresponding to an existence of the additional resource.

Clause 9. The method of clause 1, further including: generating, based at least in part on the resource required for the content rectangle paint complete event, hint data including one or more hints for a webpage.

Clause 10. The method of clause 9 further including: obtaining the hint data; generating a plurality of hint combinations from the hint data; loading, for each of the plurality of hint combinations, the webpage using the hint combination; determining, for each loading of the webpage, a timing for the content rectangle paint complete event; generating, based at least in part on the timings, performance data for the plurality of hint combinations; and transmitting the performance data.

Clause 11. A method including: obtaining a set of resources; selecting from the set of resources, a first subset of resources; transmitting the set of resources to an application, wherein the first subset of resources is transmitted after a first delay; monitoring a first execution of the application; monitoring one or more paint events for one or more webpage content rectangles; determining a timing of the one or more paint events; determining, based on the timing and the first delay, that the first subset of resources includes one or more blocking resources for the one or more paint events; and transmitting a message including an indicator that identifies the one or more blocking resources. In such embodiments, the first delay may be natural.

Clause 12. The method of clause 11, wherein the application is a webpage browser. In such embodiments, the method may include: generating the first delay via the webpage browser. In such embodiments, the method may include: generating the first delay via at least one of: a content delivery network server; an origin server; a hint server, or a proxy server.

Clause 13. The method of clause 12, wherein: the set of resources is for a webpage; and the method further includes: collecting the set of resources; storing the set of resources and the webpage in a memory device; and retrieving the set of resources from the memory device.

Clause 14. The method of clause 12, wherein: the set of resources is for a webpage; and the method further includes: loading the webpage for a first time; and in response to loading the webpage the first time, identifying the one or more webpage content rectangles.

Clause 15. The method of clause 14, wherein the method further includes: loading the webpage for a plurality of times; and in response to the plurality of loadings of the webpage, identifying the one or more webpage content rectangles as persistent across the plurality of loadings.

Clause 16. The method of clause 11 further including: injecting a script, wherein transmitting the set of resources to an application is based at least in part on the injected script.

Clause 17. The method of clause 11 further including: selecting a second subset of resources from the set of resources, wherein the second subset of resources is distinct from the one or more blocking resources; transmitting the set of resources to the application, wherein the second subset of resources is transmitted after a sanity check delay; monitoring a sanity check execution of the application; monitoring the one or more paint events for the one or more webpage content rectangles; determining a sanity check timing of the one or more paint events; and determining, based on the sanity check delay and the sanity check timing, whether the second subset of resources includes one or more additional blocking resources for the one or more paint events.

Clause 18. The method of clause 11 further including: selecting from the set of resources, a second subset of resources distinct from the one or more blocking resources; transmitting the set of resources to the application, wherein the second subset of resources is transmitted after a sanity check delay; monitoring a sanity check execution of the application; monitoring the one or more paint events for the one or more webpage content rectangles; determining a sanity check timing of the one or more paint events; determining, based on the sanity check delay and the sanity check timing, that the second subset of resources includes one or more additional blocking resources for the one or more paint events; and transmitting a message including an indicator corresponding to an existence of the one or more additional blocking resources.

Clause 19. The method of clause 18 further including: identifying a candidate dynamic blocking resource from the one or more additional blocking resources.

Clause 20. The method of clause 19, wherein the candidate dynamic blocking resource is based at least in part on: a templated universal resource locator; an A/B pattern; or an A/none pattern.

Clause 21. The method of clause 19 further including: transmitting the set of resources to the application, wherein the candidate dynamic blocking resource is transmitted after a dynamic blocking resource check delay; monitoring a dynamic blocking resource check execution of the application; monitoring the one or more paint events for the one or more webpage content rectangles; determining a dynamic blocking resource check timing of the one or more paint events; determining, based on the dynamic blocking resource check delay and the dynamic blocking resource check timing, that the candidate dynamic blocking resource is a blocking resource for the one or more paint events; and transmitting a message including an indicator corresponding to the candidate dynamic blocking resource.

Clause 22. The method of clause 11 further including: generating, based at least in part on the one or more blocking resources, hint data including one or more hints for a webpage.

Clause 23. The method of clause 22 further including: interpreting the hint data; generating a plurality of hint combinations from the one or more hints; loading, for each of the plurality of hint combinations, the webpage using the hint combination; determining, for each loading of the webpage, a timing for the one or more paint events; generating, based at least in part on the timings, performance data for the plurality of hint combinations; and transmitting the performance data.

Clause 24. An apparatus including: at least one processor; and at least one memory device storing an application that, when loaded into the at least one processor, causes the at least one processor to: obtain a set of resources; select, from the set of resources, a first subset of resources; transmit the set of resources to an application, wherein the first subset of resources is transmitted after a first delay; monitor a first execution of the application; monitor one or more paint events for one or more webpage content rectangles; determine a timeline of the one or more paint events; determine, based on the timeline and the first delay, that the first subset of resources includes one or more blocking resources for the one or more paint events; and transmit a message including an indicator that identifies the one or more blocking resources. In such embodiments, the first delay may be natural.

Clause 25. The apparatus of clause 24, wherein the application is a webpage browser. In such embodiments, the application may further cause the at least one processor to: generate the first delay via the webpage browser. In such embodiments, the application may further cause the at least one processor to: generate the first delay via at least one of: a content delivery network server; an origin server; a hint server, or a proxy server.

Clause 26. The apparatus of clause 25, wherein: the set of resources is for a webpage; and the application further causes the at least one processor to: collect the set of resources; store the set of resources and the webpage in a memory device; and retrieve the set of resources from the memory device.

Clause 27. The apparatus of clause 25, wherein: the set of resources is for a webpage; and the application further causes the at least one processor to: load the webpage for a first time; and in response to the loading of the webpage for the first time, identify the one or more webpage content rectangles.

Clause 28. The apparatus of clause 27, wherein the application further causes the at least one processor to: load the webpage for a plurality of times; and in response to the plurality of loadings of the webpage, identify the one or more webpage content rectangles as persistent across the plurality of loadings.

Clause 29. The apparatus of clause 24, wherein the application further causes the at least one processor to: inject a script, wherein transmission of the set of resources to the application is based at least in part on the injected script.

Clause 30. The apparatus of clause 24, wherein the application further causes the at least one processor to: select a second subset of resources from the set of resources, wherein the second subset of resources is distinct from the one or more blocking resources; transmit the set of resources to the application, wherein the second subset of resources is transmitted after a sanity check delay; monitor a sanity check execution of the application; monitor the one or more paint events for the one or more webpage content rectangles; determine a sanity check timing of the one or more paint events; and determine, based on the sanity check delay and the sanity check timing, whether the second subset of resources includes one or more additional blocking resources for the one or more paint events.

Clause 31. The apparatus of clause 24, wherein the application further causes the at least one processor to: select from the set of resources, a second subset of resources distinct from the one or more blocking resources; transmit the set of resources to the application, wherein the second subset of resources is transmitted after a sanity check delay; monitor a sanity check execution of the application; monitor the one or more paint events for the one or more webpage content rectangles; determine a sanity check timing of the one or more paint events; determine, based on the sanity check delay and the sanity check timing, that the second subset of resources includes one or more additional blocking resources for the one or more paint events; and transmit a message including an indicator corresponding to an existence of the one or more additional blocking resources.

Clause 32. The apparatus of clause 31, wherein the application further causes the at least one processor to: identify a candidate dynamic blocking resource from the one or more additional blocking resources.

Clause 33. The apparatus of clause 32, wherein the candidate dynamic blocking resource is based at least in part on: a templated universal resource locator; an A/B pattern; or an A/none pattern.

Clause 34. The apparatus of clause 32, wherein the application further causes the at least one processor to: transmit the set of resources to the application, wherein the candidate dynamic blocking resource is transmitted after a dynamic blocking resource check delay; monitor a dynamic blocking resource check execution of the application; monitor the one or more paint events for the one or more webpage content rectangles; determine a dynamic blocking resource check timing of the one or more paint events; determine, based on the dynamic blocking resource check delay and the dynamic blocking resource check timing, that the candidate dynamic blocking resource is a blocking resource for the one or more paint events; and transmit a message including an indicator corresponding to the candidate dynamic blocking resource.

Clause 35. The apparatus of clause 24, wherein the application further causes the at least one processor to: generate, based at least in part on the one or more blocking resources, hint data including one or more hints for a webpage.

Clause 36. The apparatus of clause 35, wherein the application further causes the at least one processor to: interpret the hint data; generate a plurality of hint combinations from the one or more hints; load, for each of the plurality of hint combinations, the webpage using the hint combination; determine, for each loading of the webpage, a timing for the one or more paint events; generate, based at least in part on the timings, performance data for the plurality of hint combinations; and transmit the performance data.

Clause 37. A method including: obtaining blocking resources for one or more paint events for one or more webpage content rectangles; generating a plurality of hint combinations from the plurality of blocking resources, wherein the plurality of hint combinations is structured to facilitate loading of the webpage; loading, for each of the plurality of hint combinations, the webpage using the hint combination; determining, for each loading of the webpage, a timing for a webpage content rectangle paint complete event associated with the loading for the webpage; generating, based at least in part on the timings, performance data for the plurality of hint combinations; and transmitting the performance data.

Clause 38. The method of clause 37, wherein the plurality of hint combinations includes information for locating one or more resources used to load the webpage.

Clause 39. The method of clause 38, wherein the plurality of hint combinations includes one or more child universal resource locators (URLs).

Clause 40. The method of clause 39, wherein the one or more resources are elements rendered on the webpage.

Clause 41. The method of clause 40, wherein the elements include graphics.

Clause 42. The method of clause 37, wherein the plurality of hint combinations includes at least one of: a preconnnect hint; a preload hint; or a priority hint.

Clause 43. The method of clause 37, wherein the plurality of hint combinations includes at least one early hint.

Clause 44. The method of clause 37, wherein the plurality of hint combinations includes at least one late hint.

Clause 45. The method of clause 37, wherein the performance data includes one or more of the timings.

Clause 46. The method of clause 45, wherein the performance data further includes one or more of the plurality of hint combinations.

Clause 47. The method of clause 46, wherein the performance data associates each of the one or more timings to one of the plurality of hint combinations.

Clause 48. The method of clause 47, wherein at least one of the plurality of hint combinations includes an ordered set of hints.

Clause 49. The method of clause 48, wherein the ordered set of hints is based at least in part on a prefetching priority.

Clause 50. The method of clause 48, wherein the ordered set of hints is based at least in part on a network resource.

Clause 51. The method of clause 48, wherein the ordered set of hints is based at least in part on an expected bandwidth of at least one network connection.

Clause 52. The method of clause 49, wherein the ordered set of hints is based at least in part on a compute resource.

Clause 53. The method of clause 48, wherein the ordered set of hints is based at least in part on an available memory.

Clause 54. The method of clause 37 further including: generating a hint priority tag for an element of the webpage based at least in part on the performance data; and transmitting the hint priority tag.

Clause 55. The method of clause 54 further including: injecting the hint priority tag into the webpage.

Clause 56. The method of clause 55 further including: injecting the hint priority tag into a HyperText Markup Language (HTML) data file for the webpage.

Clause 57. An apparatus including: at least one processor; and at least one memory device storing an application that, when loaded into the at least one processor, causes the at least one processor to: obtain blocking resources for one or more paint events for one or more webpage content rectangles; generate a plurality of hint combinations from the plurality blocking resources, wherein the plurality of hint combinations is structured to facilitate loading the webpage; load, for each of the plurality of hint combinations, the webpage using the hint combination; determine, for each loading of the webpage, a timing for a webpage content rectangle paint complete event associated with the loading for the webpage; generate, based at least in part on the timings, performance data for the plurality of hint combinations; and transmit the performance data.

Clause 58. The apparatus of clause 57, wherein the plurality of hint combinations includes information for locating one or more resources used to load the webpage.

Clause 59. The apparatus of clause 58, wherein the plurality of hint combinations includes one or more child universal resource locators (URLs).

Clause 60. The apparatus of clause 59, wherein the one or more resources are elements rendered on the webpage.

Clause 61. The apparatus of clause 60, wherein the elements include graphics.

Clause 62. The apparatus of clause 57, wherein the plurality of hint combinations includes at least one of: a preconnnect hint; a preload hint; or a priority hint.

Clause 63. The apparatus of clause 57, wherein the plurality of hint combinations includes at least one early hint.

Clause 64. The apparatus of clause 57, wherein the plurality of hint combinations includes at least one late hint.

Clause 65. The apparatus of clause 57, wherein the performance data includes one or more of the timings.

Clause 66. The apparatus of clause 65, wherein the performance data further includes one or more of the plurality of hint combinations.

Clause 67. The apparatus of clause 66, wherein the performance data associates each of the one or more timings to one of the plurality of hint combinations.

Clause 68. The apparatus of clause 67, wherein at least one of the plurality of hint combinations includes an ordered set of hints.

Clause 69. The apparatus of clause 68, wherein the ordered set of hints is based at least in part on a prefetching priority.

Clause 70. The apparatus of clause 68, wherein the ordered set of hints is based at least in part on a network resource.

Clause 71. The apparatus of clause 68, wherein the ordered set of hints is based at least in part on an expected bandwidth of at least one network connection.

Clause 72. The apparatus of clause 68, wherein the ordered set of hints is based at least in part on a compute resource.

Clause 73. The apparatus of clause 68, wherein the ordered set of hints is based at least in part on an available memory.

Clause 74. The apparatus of clause 57, wherein the application further causes the at least one processor to: generate a hint priority tag for an element of the webpage based at least in part on the performance data; and transmit the hint priority tag.

Clause 75. The apparatus of clause 74, wherein the application further causes the at least one processor to: inject the hint priority tag into the webpage.

Clause 76. The apparatus of clause 75, wherein the application further causes the at least one processor to: inject the hint priority tag into a HyperText Markup Language (HTML) data file for the webpage.

Clause 77. A method of identifying blocking resources of a webpage, the method including: initiating a first plurality of loadings of a webpage; receiving feedback for the first plurality of loadings of the webpage; identifying, based at least in part on the feedback, one or more content rectangles painted as part of the first plurality of loadings of the webpage; identifying, based at least in part on the feedback, one or more candidate resources of the one or more content rectangles; identifying, from among the one or more candidate resources, one or more blocking resources of the one or more content rectangles; and building, based at least in part on the one or more blocking resources and the one or more content rectangles, a model of the webpage.

Clause 78. The method of clause 77, wherein the feedback includes a first time-to-paint value for the painting of at least one of the one or more content rectangles.

Clause 79. The method of clause 78, wherein identifying the one or more blocking resources of the one or more content rectangles includes: delaying at least one of the one more candidate resources during a loading of the webpage; determining, in response to the delaying of the at least one of the one or more candidate resources, a second time-to-paint value for the painting of the at least one of the one or more content rectangles; determining a delay value based at least in part on a difference between the first time-to-paint value to the second time-to-paint value; and in response to determining the delay value, selecting the delayed at least one of the one more candidate resources as the identified one or more blocking resources of the one or more content rectangles. In such embodiments, delaying at least one of the one more candidate resources during a loading of the webpage may include: generating a delay via a webpage browser. In such embodiments, delaying at least one of the one or more candidate resources during a loading of the webpage may include: generating a delay via at least one of: a content delivery network server; an origin server; a hint server, or a proxy server.

Clause 80. The method of clause 77, wherein identifying, from among the one or more candidate resources, one or more blocking resources of the one or more content rectangles is performed, in part, in at least one processor of a server.

Clause 81. The method of clause 77, wherein identifying the one or more blocking resources of the one or more content rectangles is performed, in part, in at least one processor of a client device.

Clause 82. The method of clause 81, wherein identifying the one or more blocking resources of the one or more content rectangles is performed, in part, by a web browser application executing on the at least one processor of the client device.

Clause 83. The method of clause 77, wherein the one or more content rectangles identified based at least in part on the feedback are persistent content rectangles painted in at least 75% of the first plurality of loadings of the webpage.

Clause 84. The method of clause 83, wherein the persistent content rectangles are painted in all of the first plurality of loadings of the webpage.

Clause 85. The method of clause 83, wherein identifying the blocking resources of the content rectangles includes: initiating a second plurality of loadings of the webpage; and for each time the webpage is loaded during the second plurality of loadings: delaying, by a first delay period, a different one of the candidate resources; and if painting of one of the persistent content rectangles is correspondingly delayed with respect to the first delay period, identifying the one of the candidate resources as a blocking resource of the one of the persistent content rectangles.

Clause 86. The method of clause 85, wherein the first delay period is at least two times greater than a time to paint the one of the persistent content rectangles.

Clause 87. The method of clause 85 further including: initiating a third plurality of loadings of the webpage, and for each time the webpage is loaded during the third plurality of loadings: delaying, by a second delay period, one of the candidate resources of the webpage not identified as a blocking resource, and if painting of another of the persistent content rectangles is correspondingly delayed with respect to the second delay period, identifying the one of the candidate resources as a blocking resource of the another of the persistent content rectangles.

Clause 88. The method of clause 85, wherein if in response to the delaying of one of the candidate resources, painting of none of the persistent content rectangles is correspondingly delayed, identifying the one of the candidate resources as a non-blocking resource with respect to all of the persistent content rectangles.

Clause 89. The method of clause 77, wherein the one or more content rectangles form part of a main content area of the webpage.

Clause 90. The method of clause 77 further including: injecting a script, wherein the feedback is generated by the script.

Clause 91. The method of clause 90, wherein the script is injected into a web browser application executing on a client computing device.

Clause 92. The method of clause 77 further including: generating hint data based at least in part on the model of the webpage, wherein the hint data includes one or more hints for loading the webpage.

Clause 93. The method of clause 92 further including: obtaining the hint data; generating a plurality of hint combinations from the one or more hints; loading, for each of the plurality of hint combinations, the webpage using the hint combination; determining, for each loading of the webpage, a timing for painting the one or more content rectangles; generating, based at least in part on the timings, performance data for the plurality of hint combinations; and transmitting the performance data.

Clause 94. The method of clause 93 further including: generating, in response to the performance data, an optimized hint combination for loading the webpage; and transmitting the optimized hint combination.

Clause 95. The method of clause 94 further including: loading the webpage using the optimized hint combination.

Clause 96. An apparatus including: at least one processor; and at least one memory device storing an application that, when loaded into the at least one processor, causes the at least one processor to: initiate a first plurality of loadings of a webpage; receive feedback for the first plurality of loadings of the webpage; identify, based at least in part on the feedback, one or more content rectangles painted as part of the first plurality of loadings of the webpage; identify, based at least in part on the feedback, one or more candidate resources of the one or more content rectangles; identify, from among the one or more candidate resources, one or more blocking resources of the one or more content rectangles; and build, based at least in part on the one or more blocking resources and the one or more content rectangles, a model of the webpage.

Clause 97. The apparatus of clause 96, wherein the feedback includes a first time-to-paint value for the painting of at least one of the one or more content rectangles.

Clause 98. The apparatus of clause 97, wherein the application further causes the at least one processor to: delay at least one of the one more candidate resources during a loading of the webpage; determine, in response to the delaying of the at least one of the one or more candidate resources, a second time-to-paint value for the painting of the at least one of the one or more content rectangles; determine a delay value based at least in part on a difference between the first time-to-paint value to the second time-to-paint value; and in response to determining the delay value, select the delayed at least one of the one more candidate resources as the identified one or more blocking resources of the one or more content rectangles. In such embodiments, the application may cause the at least one processor to: generate the delay via a webpage browser. In such embodiments, the application may cause the at least one processor to: generate the delay via at least one of: a content delivery network server; an origin server; a hint server, or a proxy server.

Clause 99. The apparatus of clause 96, wherein the at least one processor forms part of a server.

Clause 100. The apparatus of clause 96, wherein the at least one processor forms part of a client device.

Clause 101. The apparatus of clause 100, wherein the application forms part of a web browser application executing on the at least one processor of the client device.

Clause 102. The apparatus of clause 96, wherein the one or more content rectangles identified based at least in part on the feedback are persistent content rectangles painted in at least 75% of the first plurality of loadings of the webpage.

Clause 103. The apparatus of clause 102, wherein the persistent content rectangles are painted in all of the first plurality of loadings of the webpage.

Clause 104. The apparatus of clause 102, wherein the application further causes the at least one processor to: initiate a second plurality of loadings of the webpage; and for each time the webpage is loaded during the second plurality of loadings: delay, by a first delay period, a different one of the candidate resources; and if painting of one of the persistent content rectangles is correspondingly delayed with respect to the first delay period, identify the one of the candidate resources as a blocking resource of the one of the persistent content rectangles.

Clause 105. The apparatus of clause 104, wherein the first delay period is at least two times greater than a time to paint the one of the persistent content rectangles.

Clause 106. The apparatus of clause 104, wherein the application further causes the at least one processor to: initiate a third plurality of loadings of the webpage, and for each time the webpage is loaded during the third plurality of loadings: delay, by a second delay period, one of the candidate resources of the webpage not identified as a blocking resource, and if painting of another of the persistent content rectangles is correspondingly delayed with respect to the second delay period, identify the one of the candidate resources as a blocking resource of the another of the persistent content rectangles.

Clause 107. The apparatus of clause 102, wherein the application further causes the at least one processor to: if in response to the delay of one of the candidate resources, painting of none of the persistent content rectangles is correspondingly delayed, identify the one of the candidate resources as a non-blocking resource with respect to all of the persistent content rectangles.

Clause 108. The apparatus of clause 96, wherein the one or more content rectangles form part of a main content area of the webpage.

Clause 109. The apparatus of clause 96, wherein the application further causes the at least one processor to: inject a script, wherein the feedback is generated by the script.

Clause 110. The apparatus of clause 109, wherein the script is injected into a web browser application executing on a client computing device.

Clause 111. The apparatus of clause 96, wherein the application further causes the at least one processor to: generate hint data based at least in part on the model of the webpage, wherein the hint data includes one or more hints for loading the webpage

Clause 112. The apparatus of clause 111, wherein the at least one processor further causes the at least one processor to: obtain the hint data; generate a plurality of hint combinations from the one or more hints; load, for each of the plurality of hint combinations, the webpage using the hint combination; determine, for each loading of the webpage, a timing for painting the one or more content rectangles; generate, based at least in part on the timings, performance data for the plurality of hint combinations; and transmit the performance data.

Clause 113. The apparatus of clause 112, wherein the application further causes the at least one processor to: generate, in response to the performance data, an optimized hint combination for loading the webpage; and transmit the optimized hint combination.

Clause 114. The apparatus of clause 113, wherein the application further causes the at least one processor to: load the webpage using the optimized hint combination.

The methods, e.g., 700, 1000, 1200, 1500, 1800, 2700, 3700, and/or 4000 and systems, e.g., 100, described herein may be deployed in part or in whole through a machine, e.g., apparatus 600, having a computer, computing device, processor, e.g., 610, circuit, and/or server that executes computer readable instructions, e.g., 614, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions, e.g., 614, themselves include a computer, computing device, processor, circuit, and/or server. Additionally or alternatively, a computer, computing device, e.g., apparatus 600, processor, e.g., 610, circuit, and/or server, e.g., 110, 112, 116, 118, and/or 120, may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network, e.g., 124, and/or communication resources include, without limitation, local area network, wide area network, wireless, internet, or any other known communication resources and protocols. Example and non-limiting hardware, computers, computing devices, processors, circuits, and/or servers include, without limitation, a general-purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, e.g., apparatus 600, processor, e.g., 610, circuit, and/or server, e.g., 110, 112, 116, 118, and/or 120, may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device including a part of a first computer, computing device, processor, circuit, and/or server, and some aspects of the hardware device including a part of a second computer, computing device, processor, circuit, and/or server.

A computer, computing device, e.g., apparatus 600, processor, e.g., 610, circuit, and/or server, e.g., 110, 112, 116, 118, and/or 120, may be part of a server, client, network infrastructure, mobile computing platform, stationary computing platform, or other computing platform. A processor, e.g., 610, may be any kind of computational or processing device capable of executing program instructions, codes, binary instructions and the like.

The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor, e.g., 600, may include one or more cores that may enhance speed and performance of a multiprocessor. In embodiments, the process may be a dual core processor, quad core processors, other chip-level multiprocessor and the like that combine two or more independent cores (called a die).

The methods, e.g., 700, 1000, 1200, 1500, 1800, 2700, 3700, and/or 4000 and systems, e.g., 100, and systems, e.g., 100, described herein may be deployed in part or in whole through a machine that executes computer-readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server, e.g., 110, 112, 116, 118, and/or 1120, may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client, e.g., 126, 122, 134, may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, e.g., 700, 1000, 1200, 1500, 1800, 2700, 3700, and/or 4000 and systems, e.g., 100, and systems, e.g., 100, described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like.

These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure.

Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational procedure, the determining of the value may be required before that operational procedure in certain contexts (e.g., where the time delay of data for an operation to achieve a certain effect is important), but may not be required before that operation procedure in other contexts (e.g., where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods, e.g., 700, 1000, 1200, 1500, 1800, 2700, 3700, and/or 4000 and systems, e.g., 100, and systems, e.g., 100, described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various procedures identified and described above may be varied, and that the order of procedures may be adapted to particular applications of the techniques disclosed herein. Additionally, any procedures or operations may be divided and/or combined in any manner providing similar functionality to the described operations. All such variations and modifications are contemplated in the present disclosure. The methods and/or processes described above, and procedures thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer-readable/executable code, e.g., 614, may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the procedures thereof. In another aspect, the methods may be embodied in systems that perform the procedures thereof, and may be distributed across devices in a number of ways, or all of the functionality may be integrated into a dedicated, standalone device or other hardware. In another aspect, the means for performing the procedures associated with the processes described above may include any of the hardware and/or computer-readable instructions described above. All such permutations and combinations are contemplated in embodiments of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

1. A method comprising:
interpreting a set of resources;
selecting a first subset of resources from the set of resources;
transmitting the set of resources to an application, wherein the first subset of resources is transmitted to the application after a first delay;
monitoring a first execution of the application that uses the set of resources;
determining a first timing of an event during the first execution;
determining, based at least in part on the first timing and the first delay, one or more blocking resources, in the set of resources, for the event; and
transmitting a message comprising an indicator that identifies the one or more blocking resources.

2. The method of claim 1, wherein the application is a webpage browser.

3. The method of claim 2, wherein:
the set of resources are for a webpage; and
the method further comprises:
collecting the set of resources for the webpage;
storing the set of resources and the webpage in a memory device; and
retrieving the set of resources from the memory device.

4. The method of claim 1, wherein the event is a snappi-event.

5. The method of claim 4 further comprising:
identifying the snappi-event by analyzing a second execution of the application using the set of resources.

6. The method of claim 1, wherein the one or more blocking resources are required for the event to complete.

7. The method of claim 1 further comprising:
interpreting a timing baseline for the event;
wherein, determining the one or more blocking resources is further based at least in part on the timing baseline.

8. The method of claim 7, wherein determining the one or more blocking resources is further based at least in part on the first timing being longer than an expected timing for the event defined by the timing baseline.

9. The method of claim 1 further comprising:
monitoring a CPU on which at least part of the first execution of the application occurs; and
determining that at least one of the first subset of resources blocks the at least a part of the first execution on the CPU;
wherein determining the one or more blocking resources is based at least in part on the determination that the at least one of the first subset of resources blocks at least a part of the first execution on the CPU.

10. The method of claim 1 further comprising:
selecting a second subset of resources from the set of resources;
re-transmitting the set of resources to the application, wherein the second subset of resources is re-transmitted to the application after a second delay;
monitoring a second execution of the application using the set of resources; and
determining a second timing of the event during the second execution;
wherein determining the one or more blocking resources is further based at least in part on the second timing and the second delay.

11. The method of claim 10, wherein the one or more blocking resources includes resources in the first subset of resources and the second subset of resources.

12. The method of claim 10 further comprising:
comparing the first timing to the second timing, wherein:
the one or more blocking resources includes resources in the first subset of resources when the first timing is longer than the second timing; and
the one or more blocking resources includes resources in the second subset of resources when the second timing is longer than the first timing.

13. The method of claim 1, wherein the monitoring the first execution of the application comprises receiving information regarding the first execution from the application.

14. The method of claim 1 further comprising generating a plurality of hints for the one or more blocking resources.

15. The method of claim 14, further comprising:
generating a plurality of hint combinations from the plurality of hints;
loading, for each of the plurality of hint combinations, the application using the hint combination;
determining, for each loading of the application, a third timing for the event;
generating, based at least in part on the third timings, performance data for the plurality of hint combinations; and
transmitting the performance data.

16. The method of claim 15, further comprising generating a second plurality of hints based on the performance data.

17. An apparatus comprising:
at least one processor; and
at least one memory device storing an application that, when loaded into the at least one processor, causes the at least one processor to:
interpret a set of resources;
select a first subset of resources from the set of resources;
transmit the set of resources to the application, wherein the first subset of resources is transmitted to the application after a first delay;
monitor a first execution of the application that uses the set of resources;
determine a first timing of an event during the first execution;
determine, based at least in part on the first timing and the first delay, one or more blocking resources, in the set of resources, for the event; and
transmit a message comprising an indicator that identifies the one or more blocking resources.

18. The apparatus of claim 17, wherein the application is a webpage browser.

19. The apparatus of claim 18, wherein:
the set of resources are for a webpage; and
wherein the application that, when loaded into the at least one processor, further causes the at least one processor to:
collect the set of resources for the webpage;
store the set of resources and the webpage in a memory device; and
retrieve the set of resources from the memory device.

20. The apparatus of claim 17, wherein the event is a snappi-event.

21. The apparatus of claim 20, wherein the application that, when loaded into the at least one processor, further causes the at least one processor to:
identify the snappi-event by analyzing a second execution of the application using the set of resources.

22. The apparatus of claim 17, wherein the one or more blocking resources are required for the event to complete.

23. The apparatus of claim 17, wherein the application that, when loaded into the at least one processor, further causes the at least one processor to:
interpret a timing baseline for the event;
wherein, determining the one or more blocking resources is further based at least in part on the timing baseline.

24. The apparatus of claim 23, wherein determining the one or more blocking resources is further based at least in part on the first timing being longer than an expected timing for the event defined by the timing baseline.

25. The apparatus of claim 17, wherein the application that, when loaded into the at least one processor, further causes the at least one processor to:
monitor a CPU on which at least part of the first execution of the application occurs; and
determine that at least one of the first subset of resources blocks the at least a part of the first execution on the CPU;
wherein determining the one or more blocking resources is based at least in part on the determination that the at least one of the first subset of resources blocks at least a part of the first execution on the CPU.

26. The apparatus of claim 17, wherein the application that, when loaded into the at least one processor, further causes the at least one processor to:
select a second subset of resources from the set of resources;
re-transmit the set of resources to the application, wherein the second subset of resources is re-transmitted to the application after a second delay;
monitor a second execution of the application using the set of resources; and
determine a second timing of the event during the second execution;
wherein determining the one or more blocking resources is further based at least in part on the second timing and the second delay.

27. The apparatus of claim 26, wherein the one or more blocking resources includes resources in the first subset of resources and the second subset of resources.

28. The apparatus of claim 26, wherein the application that, when loaded into the at least one processor, further causes the at least one processor to:
compare the first timing to the second timing, wherein:
the one or more blocking resources includes resources in the first subset of resources when the first timing is longer than the second timing; and
the one or more blocking resources includes resources in the second subset of resources when the second timing is longer than the first timing.

29. The apparatus of claim 17, wherein the monitoring the first execution of the application comprises receiving information regarding the first execution from the application.

30. The apparatus of claim 17, wherein the application that, when loaded into the at least one processor, further causes the at least one processor to:
generate a plurality of hints for the one or more blocking resources;
generate a plurality of hint combinations from the plurality of hints;
load, for each of the plurality of hint combinations, the application using the hint combination;
determine, for each loading of the application, a third timing for the event;
generate, based at least in part on the third timings, performance data for the plurality of hint combinations; and
generate a second plurality of hints based on the performance data.
